(19) United States
(12) Patent Application Publication
(10) Pub. No.: US 2025/0050907 A1
(43) Pub. Date: Feb. 13, 2025

(54) Hierarchical Fuzzy Controllers with Reduced Rule-Base

(71) Applicant: The Board of Trustees of the University of Illinois, Urbana, IL (US)

(72) Inventors: William Robert Norris, Champaign, IL (US); Samuel Ryan Dekhterman, Buffalo Grove, IL (US); Marius F.R. Juston, Marietta, GA (US)

(21) Appl. No.: 18/790,681

(22) Filed: Jul. 31, 2024

Related U.S. Application Data
(60) Provisional application No. 63/529,994, filed on Jul. 31, 2023.
(60) Provisional application No. 63/529,967, filed on Jul. 31, 2023.

(51) Int. Cl. B60W 60/00; G06N 7/04

(52) U.S. Cl. CPC B60W 60/001; G06N 7/046

(57) ABSTRACT

A waypoint, navigation controller and corresponding controlling methods are described, where the controller functions as a multiple input-multiple output, e.g., nonlinear angular velocity and linear speed controller for a land vessel such as a skid-steer vehicle. The controller and the controlling methods may be based on a fuzzy logic controller (alternatively referred to as “fuzzy controller”). The membership functions of the fuzzy controller may employ a trapezoidal structure with a symmetric rule-base. In addition, a Hierarchical Rule-Base Reduction (HRBR) is incorporated into the controller so as to select only the rules most influential on state errors by selecting inputs/outputs, determining the most globally influential inputs, and generating a hierarchy relating inputs via a Fuzzy Relations Control Strategy (FRCS). This disclosure is further directed to a fuzzy logic controller with Hierarchical Rule-Base Reduction (HRBR) and implemented as neural network and training of such a fuzzy logic controller via reinforcement learning based on an ANFIS actor.

### CROSS REFERENCE

This application is based on and claims the benefit of priority to U.S. Provisional Patent Application Nos. 63/529,994, entitled “Training of Adaptive Neuro-Fuzzy Inference Systems with Hierarchical Rule-Base Reduction by Reinforcement Learning”, and 63/529,967, entitled “Hierarchical Fuzzy Controller with Multiple Control Output”, both filed on Jul. 31, 2023, which are incorporated herein by reference in their entireties.

### FIELD OF THE INVENTION

This disclosure is generally directed to hierarchical fuzzy controller with reduced rule-base, and is particularly directed to (1) an Adaptive Neuro-Fuzzy Inference System (ANFIS) and particularly directed to a fuzzy logic controller with Hierarchical Rule-Base Reduction (HRBR) and symmetric trapezoidal membership functions, and implemented as neural network trained via reinforcement learning using an ANFIS actor, (2) a multi-output fuzzy control method and system with trapezoid membership functions, symmetric rule-base, and with hierarchically reduced rule-base that prioritizes minimizing a waypoint distance error, and (3) a combination thereof.

### BACKGROUND OF THE INVENTION

Fuzzy logic techniques may be employed in various control functions in on-the-road or off-the-road autonomous vehicles/machines. Fuzzy logic decision in these controllers may depend on the types and functions of the vehicles and may vary from vehicle to vehicle. At the core of a fuzzy logic controller lies the design of inputs and their linguistic variables, the member functions thereof, control outputs and their linguistic variables, the member functions thereof, and the fuzzy rule-base between the input linguistic variable and the output linguistic variables. As the numbers of input and output variables of a fuzzy logic controller increase, the rule-base grows exponentially. It is thus helpful to reduce the rule-base to the most essential and effective components even in the presence of a large number of input and output variables. A fuzzy logic thus may include a rule-base and various control parameters. All possible rules within the rule-base may be prioritized to obtain a reduced ruleset for a more efficient Fuzzy logic. A fuzzy logic may be embodied as a neural network, referred to as a Neuro-Fussy Inference System (ANFIS), with the fuzzy logic parameters being determined via training of the ANFIS.

### SUMMARY OF THE INVENTION

This disclosure is generally directed to hierarchical fuzzy controller with reduced rule-base, and is particularly directed to (1) an Adaptive Neuro-Fuzzy Inference System (ANFIS) and particularly directed to a fuzzy logic controller with Hierarchical Rule-Base Reduction (HRBR) and symmetric trapezoidal membership functions, and implemented as neural network trained via reinforcement learning using an ANFIS actor, (2) a multi-output fuzzy control method and system with trapezoid membership functions, symmetric rule-base, and with hierarchically reduced rule-base that prioritizes minimizing a waypoint distance error, and (3) a combination thereof.

For example, in one aspect, this disclosure particular describes a multi-output fuzzy control method and system with trapezoid membership functions and hierarchically reduced symmetric rule-base.

For example, a waypoint navigation controller and corresponding controlling methods are described, where the controller functions as a multiple input-multiple output, e.g., nonlinear angular velocity and linear speed controller for a land vessel such as a skid-steer vehicle. The controller and the controlling methods may be based on a fuzzy logic controller (alternatively referred to as “fuzzy controller”). The membership functions of the fuzzy controller may employ a trapezoidal structure with a symmetric rule-base. In addition, a Hierarchical Rule-Base Reduction (HRBR) is incorporated into the controller so as to select only the rules most influential on state errors by selecting inputs/outputs, determining the most globally influential inputs, and generating a hierarchy relating inputs via a Fuzzy Relations Control Strategy (FRCS). The resulting fuzzy controller covers an entire operating environment of the vehicle, but a rule for every possible combination of variables, states, and outputs is no longer necessary. As a result, the described fuzzy controller can increase both the number of inputs and their associated fidelity without its rule-base dramatically increasing.

In an example implementation, a fuzzy controlling method for automatically controlling a vehicle is disclosed. The method may include determining current states of a plurality of control metrics relative to a planned path based on measurements from sensors installed on the vehicle; generating at least two control commands using a fuzzy logic controller with a hierarchically reduced rule-base; and converting the at least two control commands into one or more control signals for actuating one or more path-control actuators of the vehicle.

In the example method above, each of the plurality of control metrics is associated with a plurality of input member linguistic variables relating to the corresponding control metrics by input fuzzy membership functions.

In any one of the example methods above, generating the at least two control commands using the fuzzy logic controller may include automatically converting the current state of each of the plurality of control metrics into input linguistic values of the plurality of input member linguistic variables based on the input fuzzy membership functions; automatically mapping the input member linguistic variables to linguistic control variables associated with at least two path-control actions of the vehicle based on the hierarchically reduced rule-base in the fuzzy logic controller; generating output linguistic values of the linguistic control variables for each of the at least two path-control actions based on the mapping and output fuzzy membership functions associated with the linguistic control variables; and defuzzificating the output linguistic values corresponding to the at least two path-control actions to generate the at least two control commands.

In any one of the example methods above, each of the input fuzzy membership functions specifies a trapezoidal relationship between a corresponding input member linguistic variable and corresponding control metrics.

In any one of the example methods above, the hierarchically reduced rule-base of the fuzzy logic controller is left-right symmetric.

In any one of the example methods above, the hierarchically reduced rule-base comprises a set of if-then rules linking the plurality of input, member linguistic variables to the linguistic control variables covering fewer than all possible combinations of the input member linguistic variables and the linguistic control variables.

In any one of the example methods above, the planned path comprises at least a current path segment and a next path segment joint by a target point; and the plurality of control metrics comprise a waypoint line distance from the vehicle to a waypoint between the target point and a projection point of the vehicle on the current path segment.

In any one of the example methods above, the plurality of control metrics may further include a target distance from the vehicle to the target point; a waypoint heading angle between a current heading direction of the vehicle relative to a line from the vehicle to the waypoint; a current path-alignment angle between the current heading direction of the vehicle and the current path segment; and a lookahead path-alignment angle between the current heading direction of the vehicle and the next path segment.

In any one of the example methods above, the hierarchically reduced rule-base may include s rule branches and sub-branches based on hierarchically prioritizing within the control metrics according to the input member linguistic variables.

In any one of the example methods above, the control metrics of the target distance may include a first input linguistic variable representing whether the vehicle is near the target point and a second input linguistic variable representing whether the vehicle is far from the target point; and top branches of the hierarchically reduced rule-base may include a first sub-rule-set and a second sub-rule-set corresponding to the first and second input linguistic variables of the target distance, respectively.

In any one of the example methods above, the first sub-rule-set is reduced from addressing all possible combinations of the input member linguistic variables of the waypoint line distance, the waypoint heading angle, the current path-alignment angle, and the lookahead path-alignment angle by ignoring at least one of the waypoint line distance, the waypoint heading angle, and the current path-alignment angle.

In any one of the example methods above, the second sub-rule-set is configured to ignore at least the lookahead path-alignment angle.

In any one of the example methods above, at least one of sub-branches of the second sub-rule-set further ignores the waypoint heading angle.

In any one of the example methods above, at least one other of the subbranches of the second sub-rule-set further ignores the current path-alignment angle.

In any one of the example methods above, the waypoint is determined by achieving a quickest approach to the planned path assuming a constant speed.

In any one of the example methods above, the at least two path-control actions may include an angular steering control and a linear speed control, and wherein the linguistic control variables corresponding to the angular steering control represent a plurality of angular steering levels and the linguistic control variables corresponding to the linear speed control represent a plurality of linear speed levels.

In any one of the example methods above, defuzzificating the output linguistic values is based on a center-of-mass methodology.

In any one of the example methods above, each of the output fuzzy membership functions associated with the linguistic control variables is a triangular function.

In any one of the example methods above, the vehicle comprises a skid-steer vehicle.

In another aspect, this disclosure further describes an Adaptive Neuro-Fuzzy Inference System (ANFIS) and is particularly directed to a fuzzy logic controller with Hierarchical Rule-Base Reduction (HRBR) and symmetric trapezoidal membership functions, and implemented as neural network trained via reinforcement learning using an ANFIS actor.

In particular, example approaches for designing and optimizing an ANFIS for symmetric linguistic values are disclosed. The ANFIS may correspond to a fussy logic with HRBR. Linguistic joint membership functions that underlie the fussy logic of the ANFIS are defined. Symmetrical properties with respect to inputs/outputs of the ANFIS are utilized in joint optimization of the member functions to reduce a number of training parameters. Further optimizations for the ANFIS are derived based on other design considerations, including but not limited to training the membership functions on closed or single-sided domains. The optimal output membership weights based on mean square error optimization may also be symbolically obtained. An example online training of the input/output membership functions of the ANFIS is performed using reinforcement training algorithms. Such reinforcement training may utilize an ANFIS actor.

In one example implementation, a method for generating a neuro-fuzzy logic controller is disclosed. The neuro-fuzzy logic controller is configured to generate at least one control output signal from a set of input signals, The method may include determining one or more input linguistic values and one or more output linguistic values for a fuzzy logic underlying the neuro-fuzzy logic controller; determining a rule-base linking the one or more input linguistic values and the one or more output linguistic values; performing a hierarchical rule-base reduction (HRBR) procedure to generate a modified fuzzy logic with a reduced rule-base; initializing the neuro-fuzzy logic controller to embed the modified fuzzy logic including initial input membership functions associated with the one or more input linguistic values and the set of input signals, and initial output membership functions associated with the one or more output linguistic values and the at least one control output signal; tuning the membership functions via reinforcement training of the neuro-fuzzy logic controller to generate a trained neuro-fuzzy logic controller; and controlling an actuator based on the at least one control output signal generated by the trained neuro-fuzzy logic controller front the set of input signals.

In the example implementation above, the input membership functions comprise trapezoid relations between numerical values of the one or more input linguistic values and the set of input signals.

In any one of the example implementations above, the output membership functions comprise triangular relations between numerical values of the one or more output linguistic values and the at least one control output signal.

In any one of the example implementations above, the input membership functions comprise a combination of double sided and single sided trapezoids.

In any one of the example implementations above, wherein the input membership functions are symmetric with respect to an input domain associated with each of the set of input signals.

In any one of the example implementations above, a shape of each double sided trapezoid of the input membership functions and the output membership functions is represented by four parameters in a corresponding domain.

In any one of the example implementations above, a shape of each single sided trapezoid of the input membership functions and the output membership functions is represented by two parameters in the corresponding domain.

In any one of the example implementations above, neighboring trapezoids of the input membership functions of a domain are constrained to have two joint parameters representing a slope region of the domain for the neighboring trapezoids.

In any one of the example implementations above, the hierarchically reduced rule-base comprises a set of if-then rules linking the one or more input linguistic values to the one or more output linguistic values that cover fewer than all possible if-then linking combinations of the one or more input linguistic values and the one or more output linguistic values.

In any one of the example implementations above, the hierarchically reduced rule-base comprises rule branches and sub-branches based on hierarchically prioritizing within a set of control metrics according to the one or more input linguistic values.

In any one of the example implementations above, the neuro-fuzzy logic controller comprises five neurological layers.

In any one of the example implementations above, the five neurological layers comprises a premise layer, a weighting layer, a normalization layer, a consequence layer, and an output layer.

In any one of the example implementations above, parameters of the input membership functions are tuned in the premise layer.

In any one of the example implementations above, the reinforcement training of the neuro-fuzzy logic controller is based on using the neural-fuzzy logic controller as an actor.

In any one of the example implementations above, the reinforcement training of the neuro-fuzzy logic controller is based on back-propagation of errors representing expected senor signal and actual sensor signal as a result of the actuator being actuated by the neuro-fuzzy logic controller.

In any one of the example implementations above, the reinforcement training is based on a Deep Deterministic Policy Gradient (DDPG) model.

In any one of the example implementations above, wherein the euro-fuzzy logic controller is installed in a skid-steer vehicle for navigational control of the skid-steer vehicle.

In some other examples, a control circuitry comprising the neuro-fuzzy logic controller of any one of example implementations above and configured to perform a method of any one of the example implementations above.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. For a more complete understanding of the invention, reference is made to the following description and accompanying drawings, in which:

FIG. 1 illustrates an example vehicle path-controlled by a fuzzy logic controller;

FIG. 2 illustrates an example data and logic flow of an example fuzzy logic controller for controlling a path of a vehicle;

FIG. 3 illustrates an example geometrical model for navigating a vehicle according to a planed path;

FIG. 4 illustrates a constant-speed fuzzy system approaching behavior of a vehicle;

FIG. 5 A-FIG. 5 E illustrate example trapezoidal membership functions of various input linguistic variables in the fuzzy logic controller of FIG. 1;

FIGS. 6 A and 6 B illustrate example triangular membership functions of various output linguistic variables in the fuzzy logic controller of FIG. 1;

FIG. 7 illustrates an example physical model for a skid-steer vehicle;

FIG. 8 A-FIG. 8 D illustrate various example path controllers alternative to the fuzzy logic controller of FIG. 1;

FIG. 9 illustrates an example geometry used by pure pursuit to determine vehicle trajectory;

FIG. 10 A illustrates pure pursuit trajectories for multiple lookahead distances on 5 m squire target trajectory. FIG. 10B illustrates pure pursuit control actions for multiple lookahead distances on 5 m square target trajectory;

FIG. 11 A-FIG. 11 C illustrate vehicle trajectory, controller angular velocity setpoits, and controller linear speed setpoints for a first test course, respectively;

FIG. 12 A-FIG. 12 C illustrate vehicle trajectory, controller angular velocity setpoits, and controller linear speed setpoints for a second test course, respectively:

FIG. 13 A-FIG. 13 C illustrate vehicle trajectory, controller angular velocity setpoits, and controller linear speed setpoints for a third test course, respectively;

FIG. 14 A-FIG. 14 C illustrate vehicle trajectory, controller angular velocity setpoits, and controller linear speed setpoints for a fourth test course, respectively;

FIG. 15 illustrates functional blocks of an example fuzzy logic controller;

FIG. 16 illustrates example membership functions of a fuzzy logic in an example domain;

FIG. 17 illustrates an example basic adaptive neuro-fuzzy inference system;

FIG. 18 illustrates an example more complex adaptive neuro-fuzzy inference system;

FIG. 19 illustrates an example trapezoidal membership function;

FIG. 20 illustrates a three-member trapezoid membership functions containing a two-sided trapezoid membership function and two one-sided trapezoid membership functions;

FIG. 21 illustrates a five-member trapezoid membership functions containing three two-sided trapezoid membership functions and two one-sided trapezoid membership functions;

FIG. 22 illustrates three two-sided trapezoid membership functions and two one-sided trapezoid membership functions;

FIG. 23 illustrates reduction of symmetric joint membership functions;

FIG. 24 illustrates re-parameterization of symmetric joint membership functions;

FIG. 25 illustrates example coordinate sets of joint three-member membership functions;

FIG. 26 illustrates trapezoid creation in an example domain;

FIG. 27 illustrates closed bound membership functions;

FIG. 28 illustrates example output membership functions in an output domain;

FIG. 29 illustrates example rewards during sequential training episodes of an example adaptive neuro-fuzzy inference system;

FIG. 30 illustrates example MAE and RMSE measures during sequential training episodes of an example adaptive neuro-fuzzy inference system;

FIG. 31 illustrates functional blocks in an vehicle being controlled by an example adaptive neuro-fuzzy inference system;

FIG. 32 shows a data and logic flow for an example hierarchical rule-base reduction procedure of a fuzzy logic controller; and

FIG. 33 shows a data and logic flow for an example procedure in generating and training an adaptive neuro-fuzzy inference system.

### DETAILED DESCRIPTION

### Path Tacking Controller

Path tracking is a critical component for autonomous vehicles and machines operating in off-road environments. When designing path tracking controllers for such autonomous vehicles, considerations for position and velocity are paramount. In particular, for vehicles used for farming, work sites, and the like, the various offroad environments pose great challenges in the design of path tracking controllers.

In addition, controller design may vary greatly in control logic for vehicles of different, steering principles. For example, for skid-steer vehicles with wheels that are fixed in orientations relative to the body of the vehicle and that are steered by controlling skids, some traditional approaches to path tracking controllers may be problematic.

For example, a skid-steer vehicle, when represented as a unicycle model, has no A matrix while the B matrix directly maps the vehicle dynamics to the control action. Such a structure may be directly at odds with model-based approaches, such as LQR (Linear Quadratic Regulator), MPC (Model Predictive Control), and H-infinity. These model-based controllers use the vehicle's A matrix and control error signal to develop an optimal and/or robust target trajectory and a corresponding control action, which are not effective for a skid-steer vehicle.

For another example, traditional frequency domain control may not be effective for skid-steer vehicles. For frequency domain control on an ideal flat road, the stability and performance criteria can be guaranteed even though better performance may require intense system identification and tuning. In contrast, for off-road settings, the dynamics and thus stability of these controllers vary greatly with velocity and terrain for a given set of gains.

For another example, sliding mode controllers operate in a binary fashion by prescribing either a maximal or minimal control effort to drive the desired error state to a sliding manifold with a zero-error state. Sliding mode controllers have been demonstrated to work to an extent on skid steer autonomous land vehicles, but the steady-state oscillations have been problematic.

For yet another example, learning-based controllers that create a multivariable, nonlinear, sensor input-control output mapping have been considered for autonomous vehicle control applications. However, vehicles can become unstable when presented with disturbances outside of their training space, such as unexpected changes to the vehicle dynamics, ground contact physics, or unforeseen sensor measurements. As such, such controllers may be unstable for off-road environments.

In the various embodiments of the disclosure below for path tracking, a waypoint navigation controller and corresponding controlling methods are described, where the controller functions as a multiple input-multiple output, e.g., nonlinear angular velocity and linear speed controller for a land vessel such as a skid-steer vehicle. The controller and the controlling methods may be based on a fuzzy logic controller (alternatively referred to as “fuzzy controller”). The membership functions of the fuzzy controller may employ a trapezoidal structure with a symmetric rule-base. In addition, a Hierarchical Rule-Base Reduction (HRBR) may be incorporated into the controller so as to select only the rules most influential on state errors by selecting inputs/outputs, determining the most globally influential inputs, and generating a hierarchy relating inputs via a Fuzzy Relations Control Strategy (FRCS). The resulting fuzzy controller covers an entire operating environment of the vehicle, but a rule for every possible combination of variables, states, and outputs is no longer necessary. As a result, the described fuzzy controller can increase both the number of inputs and their associated fidelity without its rule-base being dramatically increased.

Comparison of performance is made between the disclosed fuzzy logic controller and geometric controllers that (let ermine optimal control action based on manifolds defined by the geometric based constraints on the vehicle and its error state. Such controllers are chosen as a baseline controller because, for differential and skid-steer vehicles, the most common form of geometric control is pure pursuit. As a baseline for comparison, these geometric controllers are robust, so long as the target point is far enough away from the vehicle to account for the maximum system time delays and any discrepancies between the real-world vehicle dynamics and model dynamics.

### Fuzzy Logic Controllers

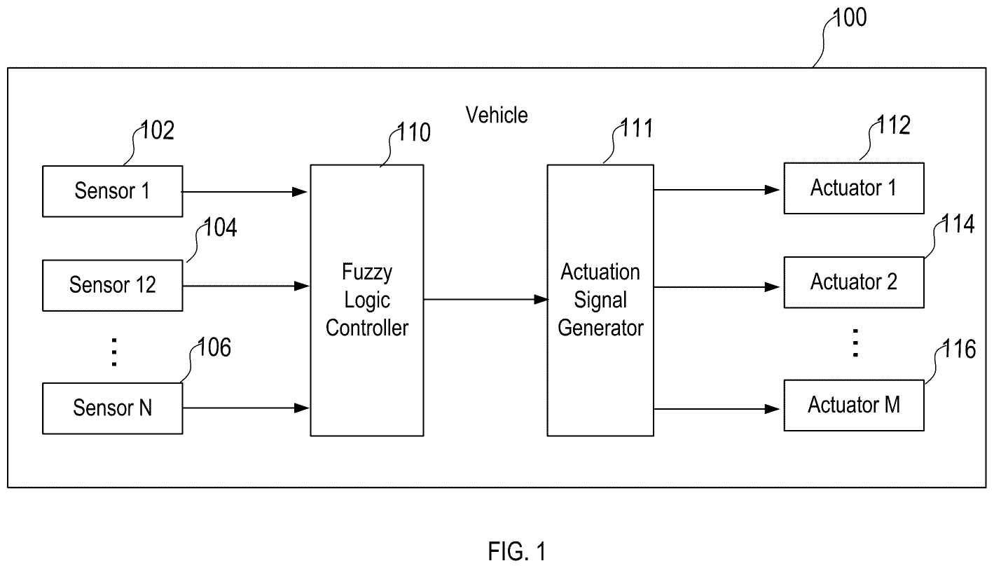

An example vehicle that is generally operated under control via fuzzy logic is shown in FIG. 1. The vehicle 100 of FIG. 1 may include one or more sensors 102, 104, and 106 for generating a set of input signals to a fuzzy logic controller 110. The fuzzy logic controller may be configured to generate a set of output signals that may be further processed by an actuator signal generator 111 to generate actuation signals that are applied to actuators 112, 112 and 116 for controlling the operation of the vehicle. Example of sensors may include cameras, lidars, thermometers, weight scales, and the like. The actuators may include brakes, steering column, accelerators, and the like.

The additional disclosure below describes example implementations of the fuzzy controller 110 given a plurality of inputs for generating a plurality of outputs with hierarchically reduced symmetric rule-base, with trapezoid membership functions for input linguistic variables, and with a set of input control metrics including a waypoint distance.

In some example implementations of fuzzy logic control, crisp inputs, zϵ [symbol] ⁿ may be feed into the input linguistic variables Iₙ, which are then categorized into in input linguistic values A_{n,m} in a process referred as fuzzification. L inguistic values describe their associated variable's performance with linguistic (and thus human-understandable/explainable) descriptors like fast and slow, near and far, and the like. Membership functions, μ_{Z}_{_{n,m}}, determine what elements comprise the fuzzy set associated with a given linguistic value.

After fuzzification, output value membership is determined using IF-THEN rules. An example rule structure is presented below in Equation (1) with Oₖ being the output linguistic variables and B_{n,m} being the output linguistic values. How the AND, OR, and IF-THEN operations interact with the membership functions for the values in the antecedents and consequents varies with implementation.

IF I₁ is A_{1,2} AND/OR I₂ is A_{2,5} THEN O₁ is B_{1,1} (1)

In some example implementations, a Mamdani type implementation using a product AND (t-norm) may be used for a fuzzy controller. Such a controller may have a plurality of control outputs. For example, for controlling a vehicle, the control output of the fuzzy controller may include two variables for controlling the vehicle's linear speed and angular velocity. To calculate these crisp outputs, Center of Mass (CoM) defuzzification may be used to generate quantified control signals as shown below in Equation (2). In Equation (2), n represents the number of membership functions, xᵢ represents the amount of control output for membership function i, and μ_{c}(xᵢ) represents the degree of membership in membership function i.

$${x}_{CoM} = \frac{{\sum }_{i = 1}^{n} {μ}_{c} ( {x}_{i} ) ( {x}_{i} )}{{\sum }_{i = 1}^{n} {μ}_{c} ( {x}_{i} )} \qquad ( 2 )$$

In some example implementations, as illustrated in further detail below, the controller's rule-base may be designed to be symmetric with respect to certain output variables. For example, the controller may be assumed to act with the same magnitude but opposite gains while making right or left turns.

In addition, in some example implementations, the fuzzy controller may use trapezoidal input membership functions, as opposed to the traditional triangular or Gaussian membership functions, as illustrated in further detail below. Such a trapezoidal membership function generates control signals that resemble those exerted by a human operator. Furthermore, the use of trapezoidal membership functions reduces bang-bang and improves overall system stability as the flat regions of the trapezoids provide a margin of acceptable error in the input, especially around the zero error region, without producing unnecessary oscillations in the output activation signal. Moreover, using a trapezoid allows for some of the more desirable traits of a Gaussian function to be captured, thereby providing a Gaussian approximation with trapezoidal parameterization that dramnatically improves comnputationally efficiency.

The example fuzzy controller disclosed herein may incorporate a relatively large number of input error functions (5 inputs, for example) while still keeping the rule-base fairly small (40 rules, for example) as compared to the potential hundreds of rules that would result from a standard fuzzy controller with the same linguistic variables and values. As described in further detail below, this level of fidelity is achieved through use of a Fuzzy Relations Control Strategy (FRCS).

For example, relevant controller linguistic variables, Fuzzy Relations Control Variables (FRCVs), and outputs may first be established. Then, the FRCS determines the most globally influential FRCVs and by placing the FRCVs in a hierarchy of influence. This hierarchy may be used to divide the operating environment of the vehicle into distinct, regions or spaces (or branches) of operation. Following, the relations in the hierarchy/regions may be used to inform a selection of the rules most influential on state errors. This entire top-down process resulted in an HRBR.

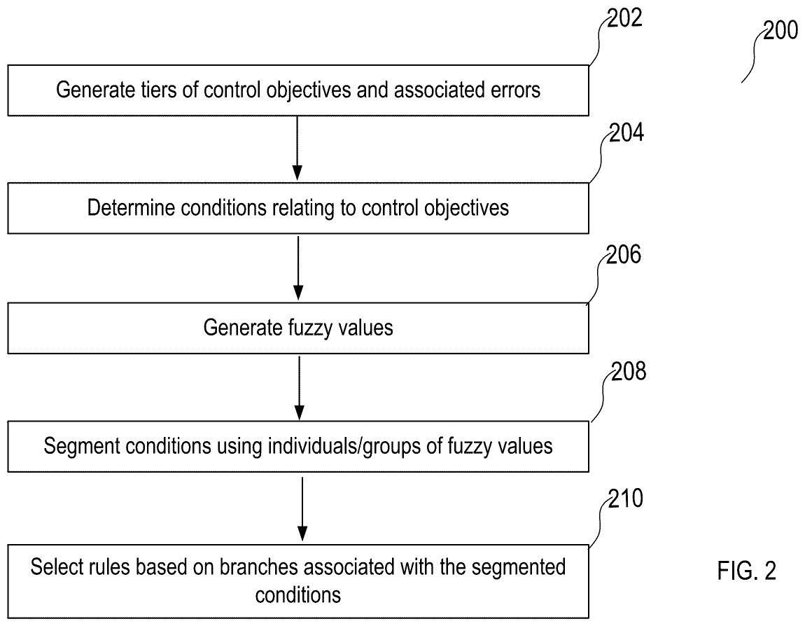

As such, the HRBR represents a generic strategy for reducing the size of a fuzzy logic rule-base. The reduction of the rule-base follows directly from model and FRCV generation, with example steps illustrate din the data and logic flow 200 of FIG. 2, which includes example steps of: Step 202 for generating tiers of control objectives and associated errors; Step 204 for determining conditions relating to control objectives; Step 206 for generating fuzzy values; Step 208 for segmenting conditions using individuals/groups of fuzzy values; and Step 210 for selecting rules based on branches associated with the segmented conditions.

In some example implementations for generating tiers of control objectives and error functions in Step 202 of FIG. 2, errors may follow directly from system objectives. For example, one of the chief priorities of the path tracking controller disclosed herein may be completing each path segment. As such, one important error may be the distance to the target point for the current path segment. In some example implementations, correcting the distance error thus may be considered as a primary control objective. From there secondary control objectives may be further identified. For the fuzzy controller relevant to controlling the example vehicles or robots disclosed herein, these secondary control objectives may include matching a relative angle of the vehicle to a current path segment (heading into the path) and reducing a distance to the path. The errors for the relative angle to the current path segment and distance to the path segments may be determined. In some example implementations, tertiary controller objectives may follow. For example, such tertiary control objectives may include but are not limited to a recovery of vehicle in the case that it has strayed from the path. Such recovery objective may include transitioning the vehicle's heading to the next path segment. The associated errors for such an example tertiary control objective may be an misalignment between a relative heading of the vehicle to some recovery point on the path segment and the relative heading to the next segment.

In some example implementations, the hierarchy for the rules may follow from the conditions in which each control objective and thus associated error is important. For the entire duration of the control effort, completing each of the path segments may be considered unconditionally important. Particularly, when a current segment is still far from being completed. When the vehicle is close to completing the current path segment, then aligning the relative error to the next path segment may become increasingly more important. As such, fuzzy values for distances close to the next path segment and far from the next path segment may be created. These conditions and associated fuzzy values may be used to determine the branches of the hierarchy through all control actions.

Example segmentation for the remainder of the controller are shown in Table 1. Fuzzy values for each of the FRCVs may be chosen heuristically given the symmetry constraint (see above), zero constraint (from the flat portion of the output trapezoid membership functions), and number of segmentations necessary for higher priority FRCVs. In the example of Table 1, the FRCVs or control metrics are: the distance from the vehicle to the target point (distErrTarget), the minimum distance from the vehicle to the current path segment (distErr Line), the angle between the vehicle's heading and the current path segment (θ_{Near}), the angle between the vehicle's heading and the next path segment (A_{Lookahead}), and the angle between the vehicle's heading and a waypoint F on the current path segment between the vehicle's projection onto the current segment and the next waypoint (θ_{Far}). Error signal functions, represented by the FRCVs, are minimized when the vehicle is in a specific state with the span of all error states corresponding to all possible vehicle positions and orientations.

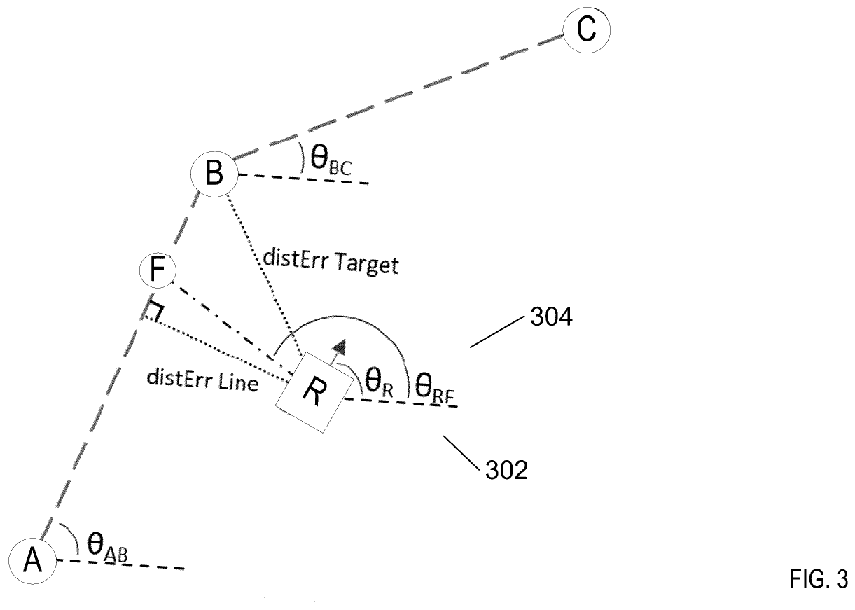

These FRCVs are illustrated or can be identified in FIG. 3. In FIG. 3, A represents a waypoint that the vehicle most recently passed; B represents a current target waypoint; C is the next waypoint on the trajectory after the current target waypoint; F represents the far point from trajectory target point. (which is explained in further detail below), and R is the robot's current position. The box 302 represents the vehicle with its current heading 304. The distance error signals including disErr Line and DisErr Target are also illustrated in FIG. 3. The angles θ_{AB}, θ_{BC}, θ_{R}, θ_{RF} for segment AB, BC, the vehicle heading, and RF direction are shown relative to the dotted reference line. The angular errors θ_{Near}, θ_{far}, and θ_{Lookahead} above can be calculated using Equations (3)-(5) below:

$${θ}_{near} = {θ}_{AB} - {θ}_{R} \qquad ( 3 )$$

$${θ}_{Lookahead} = {θ}_{BC} - {θ}_{R} \qquad ( 4 )$$

$${θ}_{Far} = {θ}_{RF} - {θ}_{R} \qquad ( 5 )$$

An example hierarchical FRCS developed over these FRCVs is illustrated generally in Table 1 and specifically in Table 2. Table 1 shows a general design where the FRCVs are hierarchically considered in building the rule set. Specifically,

TABLE 1
Summary of example applied hierarchical FRCS

| | Metric Used for FRCS Classification | | |
|---|---|---|---|
| | | distErr Target Far | |
| | | dist Err | |
| | | Line | |
| | distErr | Zero/ | |
| | Target | Close/ | distErr |
| FRCVs | Near | Near | Line Far |
| distErr Target | 2 | 3 | 3 |
| distErr Line | | 2 | 2 |
| θ_{Lookahead} | | | |
| θ_{Near} | | 1 | |
| θ_{Far} | | | 1 |

the FRCV of DisErrTarget (distance to the target point of the current segment) is evaluated at a first hierarchy level as being either near or f ar. If it is near, then the next level decision for controlling the vehicle (e.g., the speed adjustment, and turning) would depend on how the vehicle is aligned with the target point of the next segment (θ_{Lookahead}) regardless of DisErr Line, θ_{Near}, and θ_{far}. If DisErrTarget is far, then the rule set may further depends on how far the vehicle is off the path of the current segment in distance (DisErr Line). If DisErr Line is not very off the current path (zero, close or near) with the distance to the target point of the current segment being still far, then the rule set may mainly target brining the vehicle towards the target point in the current segment (θ_{Near}. Otherwise, if DisErr Line is very off the current path (far) and still far from the current target point (DisErr Target being far), then the goal may be to first bring the vehicle more aggressively towards the way point in the current path before the current target point (θ_{Far}. As such, Table 1 are populated with priority consideration level (1 being the highest priority) of the FRCVs under the hierarchical branches. The FRCV combination showing as blank cells would not show up in the rule set, thereby achieving a reduction of the number of rules.

Once a hierarchy is designed and completed, as shown in Table 1, the rule reduction may be performed by only including rules relevant to each state of a branch. An example is illustrated in Table 2 with hierarchical branches for the various example linguistic variables above. As a result of left-right symmetry, Table 2 only shows half of the rules and their hierarchy.

As indicated in Table 1 and an example hierarchy of Table 2, the distErr T arget metrics, for example, may be associated with two linguistic vari-ables, far and near, which partitions the space in a first level into being near the target point or far away from it. Furthermore, the error (or metric) distErr Line partitions a subspace representing far from the target space in a second level into several sub-sub-spaces according to the minimum distance from the vehicle to the current target path using various example linguistic variables of distErr Line. For example, distErr Line error may be associated with seven linguistic variables to cat-egorize how far away the vehicle is from the current target trajectory: far left, near left, close left, zero, close right, near right, and far right (Table 2 only shows the left half and zero sub-subspaces). The remaining example FRCVs (θ_{Near}), (θ_{Far}), and (θ_{Lookahead}) may, for example, all use similar five linguistic variables to qualify the orientation of the vehicle far left, close/near left, zero, close/near right, and far right.

As such, for the example hierarchical rule reduction of Table 2, the dis-tance to the target point (or next segment) may be atop the hierarchy with two branches, a “near” branch and a “far” branch. For the “near” branch in which the vehicle is close to the target point or the next path segment, the primary goal may be align the vehicle's heading with the next path segment. As such, the rules for this branch may be selected as depending only on θ_{Lookahead} with other variables being ignored. Because θ_{Lookahead} may be associated with, for example, five fuzzy values, only five example rules linking these five θ_{Lookahead} values with the two output variables (steering action \dot{θ}_{R} and speed control) may be necessary (Table 2 shows three rules for θ_{Lookahead} values being “far left”, “close left”, and “zero”, but the full rule set in this branch would be five once the symmetric half of “far right”, “close right” for θ_{Lookahead} is included).

In the example of Table 2, and in the sub-sub-space of the “far left” lin-guistic variable (and “far right” linguistic variable, not shown) for the distErr Line error, it may be determined that because the vehicle is very far away from the current target path segment, the primary goal may be to get back on track, and thus, the controlling of the steering and the speed of the vehicle only need to depend on lin-guistic variables associated with θ_{Far}, and the heading angles of the vehicle relative to the current segment (θ_{Near}) and next segment line (θ_{Lookahead}) are not important for consideration. The rule sets in this sub-sub-space may be reduced to only linking the five example linguistic variables of θ_{Far} metrics to the steering and speed control output (Table 2 only shows left half and the zero variables).

Thus, by using the hierarchical space division as illustrated in Table 2, while every fuzzy value should be used, only a heuristically selected subset of all possible combination of all values in a branch are used in the rule set, thereby achieving a reduction of the rules for the fuzzy logic.

In the example implementation above, the pursuit back to the target path is achieved by targeting a fixed distance in front of the vehicle's projection onto the trajectory. The primary downside of this approach occurs when the projection onto the path is very close to the target, but the vehicle has drifted from the path. This scenario leads to the vehicle meeting its completion criteria when it is far away from

TABLE 2
Half of the Symmetric Fuzzy Controller Rule-Base

| IF | | | | | | |
|---|---|---|---|---|---|---|
| distErr | distErr | | | | THEN | |
| Target | Line | θ_{Lookahead} | θ_{Far} | θ_{Near} | \dot{θ}_{R} | Speed |
| near | | far left | | | right 4 | slow |
| near | | close left | | | right 2 | med |
| near | | zero | | | zero | fast |
| far | far left | | far left | | right 4 | slow |
| far | far left | | close left | | right 1 | fast |
| far | far left | | zero | | zero | fast |
| far | near left | | | far left | right 4 | slow |
| far | near left | | | near left | right 3 | med |
| far | near left | | | zero | right 2 | med |
| far | close left | | | far left | right 4 | slow |
| far | close left | | | near left | right 2 | med |
| far | close left | | | zero | right 1 | fast |
| far | zero | | | far left | right 3 | med |
| far | zero | | | near left | right 1 | fast |
| far | zero | | | zero | zero | fast |

the target. If this occurs, the vehicle state would then be projected onto the next segment. This could result in an extremely large jump in the projected distance and potentially the skipping of a future waypoint altogether. In obstacle-riddled environments with a small number of navigable paths, obstacle avoidance protocols can lead to such an error cascade.

The example fuzzy controller above uses (θ_{Far}) when the positional error state is far away from the target trajectory and target point (when distErr Target is large). As shown above in relation to Table 2, the controller may be designed to orient the vehicle so as to minimize (θ_{Far}) and head towards the far point from trajectory target point (F in FIG. 3). In some example implementations, the location of F may be designed as shown in Equation (6). Such design is a non-trivial task as there are benefits and costs to putting it anywhere between the vehicle's projection onto the current path segment and the target point B in FIG. 3.

$$\begin{matrix}F = k * {proj}_{\overline{AB}} R + ( 1 - k ) \times B & 0 \leq k \leq 1\end{matrix} \qquad ( 6 )$$

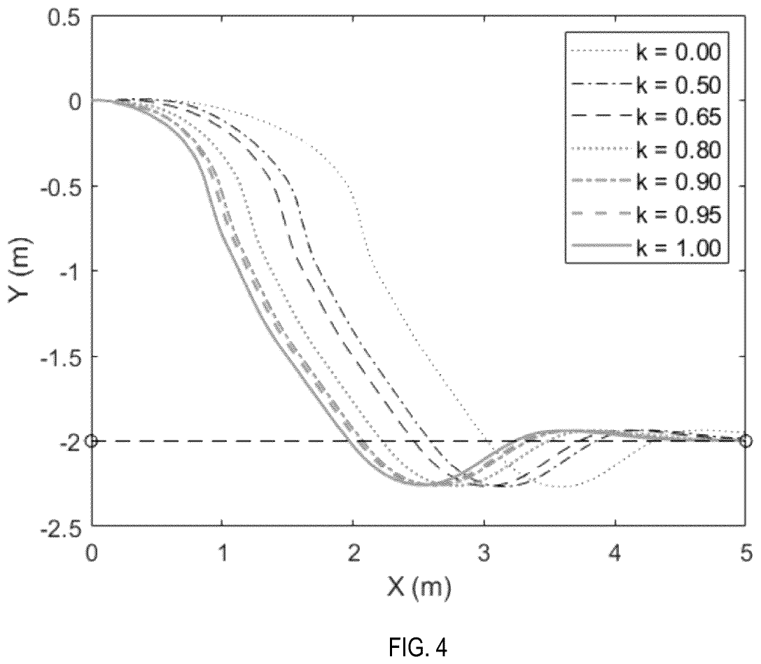

In some example implementations, in order to have the controller approach the trajectory quickly, the value of k may be chosen to be close to 1. FIG. 4 shows the constant speed system approach behavior over a range of k values, which are used for tuning purposes to select the desired k. For an example controller, a k of 0.95 may be selected.

This method of using constant-speed approaching to select F provided a harmonious solution that solved several issues. Using such a method, the vehicle may be controlled to aggressively approached the waypoint when segment completion is imminent, while approaching from a more casual angle when the end of the segment is further away. This casual angle decreases the overall (or speed up) completion time for the path, and in cases where the waypoints are far enough apart for the approach angle to be substantially shallow, it would typically be much less important than the path being tightly followed.

As described above for the implementation of Table 2, when distErrTarget is small and in the range of its “near” linguistic value, minimizing (θ_{Lookahead}) may be used as the sole control objective. Similarly, minimizing (θ_{Far}) may be the sole control objective when distErr Target is in its “far” range and distErr line is in its “far left” range or “far right” range. As a result, both of the angle metrics have the same linguistic variables. In the example implementation of Table 2, they are also both mapped to or linked to very similar steering control output variables such that: far left mapped to right 4, near left mapped to right 2 or 1 respectively, zero mapped to zero, near right mapped to left 2 or 1 respectively, and far right mapped to left 4. The control variable for steering include a change of steering direction and change amount. For example, right 4 indicate changing steering to the right with an aggressive amount of 4. “Zero” represent no change (keep the current steering).

As described above for the implementation of Table 2, when the vehicle is close to the path but away from the target point, the control objective may be multifaceted. It may prioritize minimizing θ_{Near}) while also driving and then maintaining distErr Line to/at zero. This task incorporates five l inguistic variables f rom the distErr Line membership functions (near left, close left, zero, close right, and near right), and all five linguistic variables from the θ_{Near}) membership functions (far left, near left, zero, near right, and far right). These are combined to make 25 example rules that stabilized the vehicle about its equilibrium point. When the distErr line is zero, the steering control output may minimize (θ_{Near}) as follows: far left mapped to right 3, near left mapped to right 1, zero mapped to zero, near right mapped to left 1, and far right mapped to left 3.

In some example fuzzy system, as described above, the output angular velocity setpoint that ranges from −ωₘₐₓ to ωₘₐₓ may be designed be associated with, for example, nine potential linguistic variables. Those linguistic variables are left 4, left 3, left 2, left 1, zero, right 1, right 2, right 3, and right 4. The output linear speed setpoint may be configured to range from 0 m/s to 2 m/s. Linear speed may be associated with the linguistic values slow, medium, and fast. In the rule-base, the slow output may be assigned to rules where angular velocity is right/left 4, medium may be assigned to right/left 2 and 3, and fast may be assigned to right/left 1 and zero.

Example membership functions for the various input linguistic variables above and the output variables are described in further detail below. In some example

TABLE 3
distErr Target Membership Functions

| Linguistic Values | Membership Functions |
|---|---|
| close | trap(−100, −100, 0, 0.6418) |
| far | trap(0, 0.6418, 100, 100) |

implementations, the membership functions of the various input linguistic variables for the fuzzy logic may take the form of a trapezoid, whereas the membership functions of the output variables may take the form of a triangle.

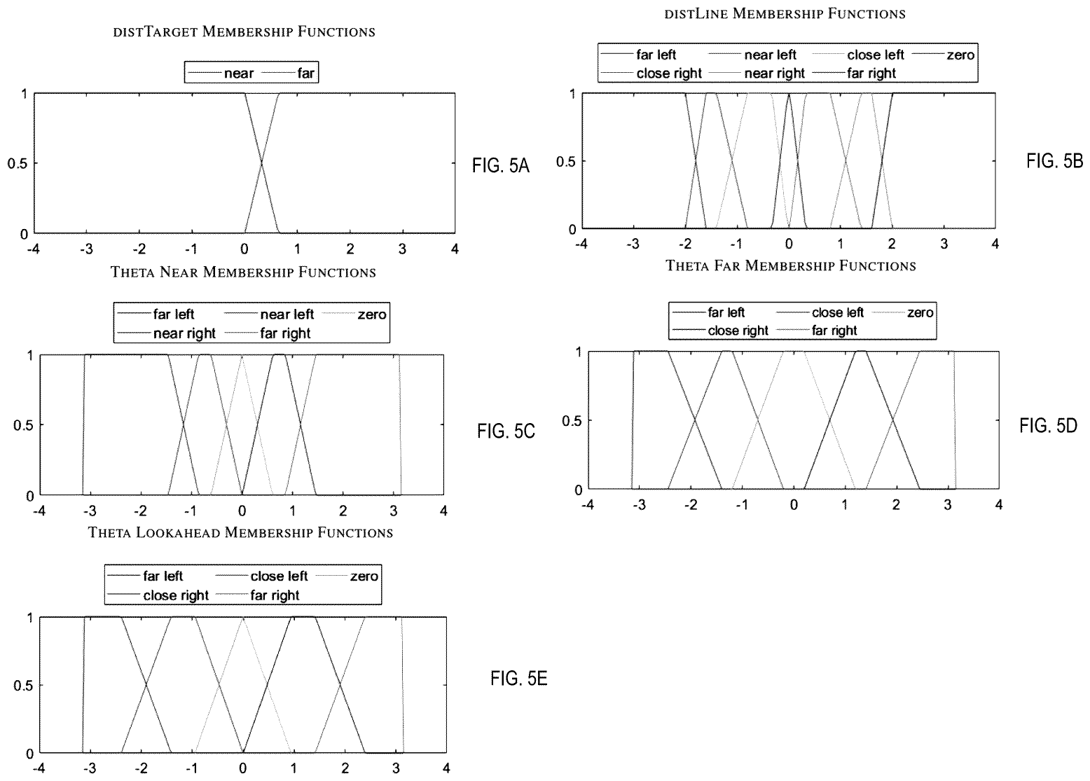

Example membership functions for the input linguistic variables (close and far) for distErr Target are illustrated in Table 3 and in FIG. 5A. Example mem-bership functions for the input linguistic variables (far left, near left, close left, zero, close right, near right, far right) for distErr linet are illustrated in Table 4 and in FIG. 5B. Example membership functions for the input linguistic variables (far left, near left, zero, near right, far right) for θₙₑₐᵣ are illustrated in Table 5 and in FIG. 5C. Example membership functions for the input linguistic variables (far left, near left, zero, near right, far right) for θ_{far} are illustrated in Table 6 and in FIG. 5D. Example membership functions for the input linguistic variables (far left, near left, zero, near right, far right) for θ_{lookahead} are illustrated in Table 7 and in FIG. 5E. The x-axis in FIGS. 5A to SD may be based any predefined distance or angle units. For example, the x-axis angles for FIGS. 5C-5E may be radiant, ranging from −π to π. The x-axis in FIGS. 5A-5B, for example, may be in meters.

In some example implementations, unlike the membership functions associated with the input linguistic variables, the membership functions of linguistic variables for the steering control output and speed control output may be constructed as triangular. In some example implementations, the triangles may have a same area among the linguistic variables within each of the output. Example membership functions

TABLE 4
distErr Line Membership Functions

| Linguistic Values | Membership Functions |
|---|---|
| far left | trap(−100, −100, −2, −1.6) |
| near left | trap(−2, −1.6, −1.398, −0.7981) |
| close left | trap(−1.3981, −0.7981, −0.3247, −0.01645 |
| zero | trap(−0.3247, −0.01645, 0.01645, 0.3247) |
| close right | trap(0.01645, 0.3247, 0.7981, 1.3981) |
| near right | trap(0.7981, 1.3981, 1.6, 2) |
| far right | trap(1.6, 2, 100, 100) |

TABLE 5
θₙₑₐᵣ Membership Functions

| Linguistic Values | Membership Functions |
|---|---|
| far left | trap(−3.142, −3.142, −1.46, −0.8556) |
| near left | trap(−1.46, −0.8556, −0.6118, −2.447e−05) |
| zero | trap(−0.6118, −2.447e−05, 2.447e−05, 0.6118) |
| near right | trap(2.447e−05, 0.6118, 0.8556, 1.46) |
| far right | trap(0.8556, 1.46, 3.142, 3.142) |

TABLE 6
θ_{far} for Membership Functions

| Linguistic Values | Membership Functions |
|---|---|
| far left | trap(−3.142, −3.142, −2.45, −1.4) |
| close left | trap(−2.45, −1.4, −1.2, −0.2) |
| zero | trap(−1.2, −0.2, 0.2, 1.2) |
| close right | trap(0.2, 1.2, 1.4, 2.45) |
| far right | trap(1.4, 2.45, 3.142, 3.142) |

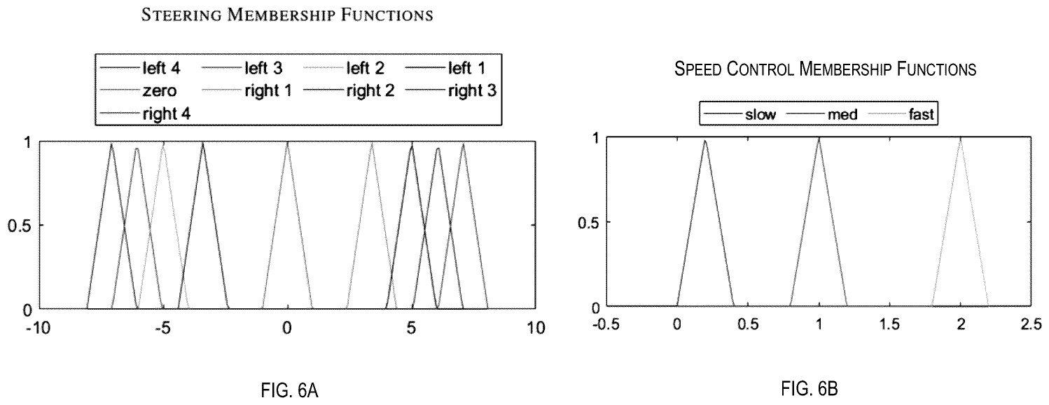

for linguistic variables (left 4, left 3, left 2, left 1, zero, right 1, right 2, right 3, and right 4) of the steering control output are illustrated in Table 8 and FIG. 5A. Example membership functions for linguistic variables (slow, mediate, and fast) of the speed control output are illustrated in Table 9 and FIG. 5B. The x-axis in FIGS. 6G and 6B may be based any predefined angle change or speed units. For example, the x-axis angles for FIGS. 5C-5E may be radiant, ranging from −π to π. The x-axis in FIGS. 6B, for example, may be in meters second.

The defuzzification process, which combined these control signals, may use

TABLE 7
θ_{lookahead}

| Linguistic Values | Membership Functions |
|---|---|
| far left | trap(−3.142, −3.142, −2.391, −1.414) |
| close left | trap(−2.391, −1.414, −0.9409, −0.0034) |
| zero | trap(−0.9409, −0.0034, 0.0034, 0.9409) |
| close right | trap(0.0034, 0.9409, 1.414, 2.391) |
| far right | trap(1.414, 2.391, 3.142, 3.142) |

TABLE 8
Steering Membership Functions

| Linguistic Values | Membership Functions |
|---|---|
| left 4 | tri(−8.0704, −7.0704, −6.0704) |
| left 3 | tri(−7.0561, −6.0561, −5.0561 |
| left 2 | tri(−5.9934, −4.9934, −3.9934) |
| left 1 | tri(−4.3981, −3.3981, −2.3981) |
| zero | tri(−1, 0, 1) |
| right 1 | tri(2.3981, 3.3981, 4.3981) |
| right 2 | tri(3.9934, 4.9934, 5.9934) |
| right 3 | tri(5.0561, 6.0561, 7.0561) |
| right 4 | tri(6.0704, 7.0704, 8.0704) |

TABLE 9
Speed Control Membership Functions

| Linguistic Values | Membership Functions |
|---|---|
| slow | tri(0, 0.2, 0.4) |
| med | tri(0.8, 1, 1.2) |
| fast | tri(1.8, 2, 2.2) |

the CoM approach discussed previously. As each of the output membership functions are triangles with the same area, defuzzification involved taking a weighted average of the peak values of the triangles, with the weights being the percentage that the associated rules are active. The normalized input membership functions as shown above the examples of FIGS. 5A-5E, may span all errors to ensure that at all states the vehicle correspond to an output function membership. However, the controller performance need not require the potential outputs spanning the space of all possible control inputs. The defuzzificated steering output and the speed output may then be used to generate one or more actuation signals to various actuators of the vehicle.

### Vehicle Physical Model for Steering Control and Speed Control

The generation of actuation signal for achieving the various steering control and speed control as generated by the fuzzy logic controller may be based on a physical model of the vehicle and its interaction with the ground. The disclosure below provides an example physical model of a vehicle. While the model is provided in the context of a skid steer type of vehicle, the under line methodology and general principle apply to other type of vehicles with modification and/or adaptation.

### Forward Dynamics

In some example implementations, five interconnected bodies are used to model or represent a vehicle (a skid steer vehicle, in particular). Each of these bodies may be associated with a reference frame. For example, the five bodies may include a main body and four wheels. The main body referenced frame F1, and each of the wheels referenced frames F₂-F₅, are illustrated in FIG. 7. Accordingly, these wheels are specified as i=2, 3, 4, 5.

The spatial velocity vector for the main body F1 may be given by Equation (7) below. This vector may include an angular velocity and a translational velocity represented by w and v respectively.

$${v}_{1} = {[ \begin{matrix}{ω}_{1 x} & {ω}_{1 y} & {ω}_{1 z} & {v}_{1 x} & {v}_{1 y} & {v}_{1 z}\end{matrix} ]}^{T} \qquad ( 7 )$$

Equation (8) represents the velocity of each of the wheels. The motion transformation from F₁ to Fᵢ is given by ⁱX₁, the subspace matrix of each wheel is denoted by Sᵢ, and the angular velocity is denoted by \dot{q}ᵢ.

$${v}_{i} = {}^{i} {X}_{1} {v}_{1} + {S}_{i} {\dot{q}}_{i} \qquad ( 8 )$$

The inertia matrix of body i at the body's center of mass (CoM) are defined by Iᵢ. The inertia matrix for the main body may be given by (9) and for the wheels by Equation (10), where a, b, and c represent the dimensions of the main body in x, y, and z, respectively. Similarly, in Equation (10), where 2r, w, 2r represent the dimensions of the wheels in x, y, and z (r represents the radius of the wheels, and w represents the wheels' width).

$${I}_{1} = \frac{{m}_{1}}{12} [ \begin{matrix}{b}^{2} + {c}^{2} & 0 & 0 \\ 0 & {a}^{2} + {c}^{2} & 0 \\ 0 & 0 & {a}^{2} + {b}^{2}\end{matrix} ] \qquad ( 9 )$$

$${I}_{i} = \frac{{m}_{i}}{12} [ \begin{matrix}3 {r}^{2} + {w}^{2} & 0 & 0 \\ 0 & 6 {r}^{2} & 0 \\ 0 & 0 & 3 {r}^{2} + {w}^{2}\end{matrix} ] \qquad ( 10 )$$

For bodies n=1, 2, . . . , 5, mₙ represents the mass of the corresponding body. Likewise, the COM location for each body, expressed in body coordinates is given by cₙ. Combining the above, the generalized version of the parallel axis theorem for spatial inertia is shown in Equation (11) below.

$${I}_{n} = [ \begin{matrix}{I}_{n} + {m}_{n} {c}_{n} \times {c}_{n} {\times }^{T} & {m}_{n} {c}_{n} \times \\ {m}_{n} {c}_{n} {\times }^{T} & {m}_{n} {1}_{3}\end{matrix} ] \qquad ( 11 )$$

Relative to the main body, Equation (12) below represents an apparent inertia of any wheel to the main body:

$${I}_{1 / i} = {I}_{i} - {I}_{i} {{S}_{i} ( {S}_{i}^{T} {I}_{i} {S}_{i} )}^{- 1} {S}_{i}^{T} {I}_{i}^{T} , i = 2 , 3 , … , N \qquad ( 12 )$$

The total spatial inertia of the main body may then be derived as in Equation (13) below.

$${I}_{1}^{′} = {I}_{1} - {\sum }_{i = 2}^{5} {I}_{1 / i} \qquad ( 13 )$$

In addition, Equation (14) below may be used to determine a force due to the velocity-product.

$${f}_{ic} = {v}_{i} {\times }^{*} {I}_{i} {v}_{i} \qquad ( 14 )$$

The external spatial force on the main body can be evaluated using Equation (15). The symbol \hat{k}₁ represents the unit vector parallel to the z₁-axis. The force due to gravity on the main body is represented by f_{1grav}. The symbol f_{iw}¹ represents the reaction force on each wheel.

$$\begin{matrix}{f}_{1 ext} = [ \begin{matrix}{n}_{1 extx} {n}_{1 exty} {n}_{1 extz} & {{f}_{1 {ext}_{x}} {f}_{1 {ext}_{y}} {f}_{1 {ext}_{z}} ]}^{T}\end{matrix} \\ = [ \begin{matrix}{\sum }_{i = 2}^{5} ( {r}_{i} - r {\hat{k}}_{1} ) \times {f}_{iw}^{1} \\ {\sum }_{i = 2}^{5} {f}_{iw}^{1}\end{matrix} ] + {f}_{1 grav}\end{matrix} \qquad ( 15 )$$

The inertial acceleration of the main body may be given by Equation (16), where ¹Xᵢ* represents the force transformation from Fᵢ to F₁.

$${a}_{1} = {\underbrace{( {I}_{1}^{′ - 1} ) {f}_{1 c} + ( {I}_{1}^{′ - 1} ) {\sum }_{i = 2}^{N} {}^{1} {X}_{i}^{*} {f}_{ic}}}_{{a}_{1 c}} - {\underbrace{( {I}_{1}^{′ - 1} ) {\sum }_{i = 2}^{N} {}^{1} {X}_{i}^{*} {f}_{i} ext}}_{{a}_{1 / i} ext} - {\underbrace{( {I}_{1}^{′ - 1} ) {f}_{1 ext}}}_{{a}_{lext}} \qquad ( 16 )$$

The angular acceleration of each wheel, \ddot{q}ᵢ, may be determined using Equation (17). Conversely, the applied torque may be given by τᵢ and dᵢ=ⁱX₁a₁+vᵢ×Sᵢ\dot{q}ᵢ.

$${\overline{q}}_{i} = ( {τ}_{i} - {S}_{i}^{T} {f}_{i} - {I}_{i} {S}_{i} ( {d}_{i} ) ) {( {S}_{i}^{T} {I}_{i} {S}_{i} )}^{- 1} \qquad ( 17 )$$

### Ground Contact

In the example model described above, the vehicle is treated as a rigid body that interacts with a compliant ground. This compliant ground can be modeled as a uniform distribution of an infinite number of non-linear spring-damper pairs. Further, these rigid body-ground interactions may be represented as a set of discrete contact points, each of which caused the ground to deflect spherically.

The relative modulus of elasticity between the wheel(s) and the ground, denoted by E*, may be computed using Equation (18). In Equation (18), the wheel(s) and ground may be associated with moduli of elasticity of E_{w} and E_{g}, respectively, and with Poisson ratios given by v_{w} and v_{g}, respectively.

$$\frac{1}{{E}^{*}} = \frac{1 - {v}_{w}^{2}}{{E}_{w}} + \frac{1 - {v}_{g}^{2}}{{E}_{g}} \qquad ( 18 )$$

A stiffness and damping coefficients may be defined as shown in Equation (19) below, where r represents the radius of the sphere and α represents a constant.

$$K = - 2 {E}^{*} \sqrt{r} , D = 4 πα \qquad ( 19 )$$

The normal force from the ground Nₖ may be calculated using Equation (20) at some point k. In Equation (20), δₖ represents a penetration distance, \dot{δ}ₖ represents a penetration velocity, K represents a surface stiffness coefficient, and D represents the surface damping coefficient. It is assumed that that δₖ<0, i.e. penetration is considered as being into the ground.

$${N}_{k} = \sqrt{- {δ}_{k}} [ - K {δ}_{k} - D {\dot{δ}}_{k} ] \qquad ( 20 )$$

Correspondingly, the slipping force may be given by (21), where μ represents the coefficient of friction.

$${f}_{{slip}_{k}} = μ {N}_{k} \qquad ( 21 )$$

The stick component of friction between the wheel(s) and ground may be further evaluated using Equation (22). The symbol u may be considered as representing the tangential deformation of the ground at the contact point,” and Vₛₚₕ may be considered as representing “the tangential velocity of the bottom point of the sphere.”

$${f}_{{stick}_{k}} = - K {δ}^{\frac{1}{2}} u - D {δ}^{\frac{1}{2}} {V}_{sph} \qquad ( 22 )$$

Given the example representations above, the friction force may be formulated using (23).

$${f}_{k} = \{ \begin{matrix}{f}_{{slip}_{k}} , & \vert {f}_{{slip}_{k}} \vert < \vert {f}_{{stick}_{k}} \vert \\ {f}_{{stick}_{k}} , & \vert {f}_{{slip}_{k}} \vert \geq \vert {f}_{{stick}_{k}} \vert\end{matrix} \qquad ( 23 )$$

The example modeling above provides a connection between a desired translational speed/acceleration of the main body, rotational speed/angular acceleration of the wheels in slipping or sticking frictional interaction with the ground, and the drive torques. As such, the desired control output linguistic variables from the fuzzy controller above may then be mapped to actuation signal that can generated torques and other controlling actuation to generate desired steering angles and speeds. Such mapping may be implemented in the actuation signal generator 111 of FIG. 1.

### Stability Analysis of Path Tracking Controller

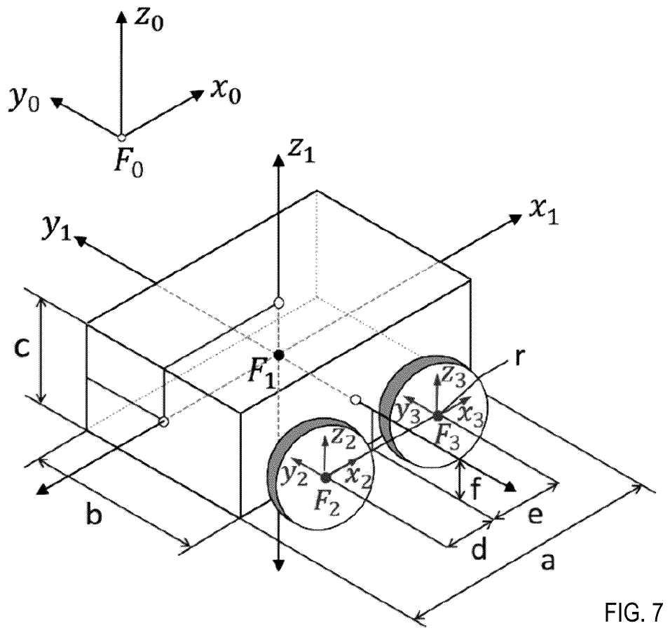

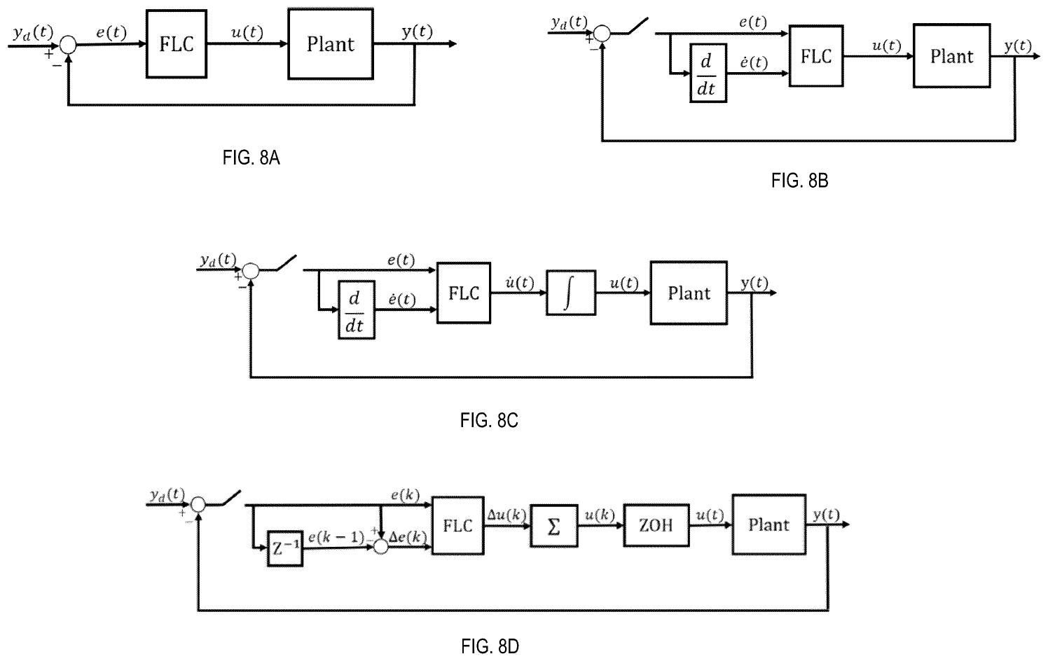

In order to show the stability of the fuzzy controller or controlling methods described above, an equivalent controller as shown in FIG. 8A is constructed to represent a popular passively stable fuzzy structure. In FIG. 8A, the error input into the controller is e(t) and the output is u(t) as seen in Equation (24) below. The output u(t) then enters the plant and results in y(t) which in tandem with y_{d}(t), as shown in Equation (25), is combined to make the new updated e(t).

$$e ( t ) = [ \begin{matrix}{θ}_{near} \\ {θ}_{far} \\ {θ}_{lookahead} \\ distError Line \\ distError Target\end{matrix} ] , u ( t ) = [ \begin{matrix}{\dot{θ}}_{R} \\ speed\end{matrix} ] \qquad ( 24 )$$

$$y ( t ) = [ \begin{matrix}{θ}_{R} \\ {θ}_{R} \\ {θ}_{R} \\ - distError Line \\ - distError Target\end{matrix} ] , {y}_{d} ( t ) = [ \begin{matrix}{θ}_{AB} \\ {θ}_{RF} \\ {θ}_{BC} \\ 0 \\ 0\end{matrix} ] \qquad ( 25 )$$

In FIG. 8B, an additional input of ė(t) is included on top of the controller of FIG. 8A. Furthermore, each of the previous rule's antecedents are t-normed (ANDed) with singular linguistic values of ė(t). This singular linguistic value Dummiy is assumed to have membership 1 regardless of input. As such, the controllers in FIGS. 8A and 8B are equivalent.

In FIG. 8C, the output of the controller is taken to be \dot{u}(t) which is then integrated so the plant still takes in u(t). Thus, from the plant's perspective the controllers in FIGS. 8A, 8B, and 8C are all equivalent.

FIG. 8D is a discrete equivalent of the FIG. 8C with u(k)=u(k+1)+Δu(k) and similarly Δe(k)=e(k)−e(k−1). The transition from discrete to continuous time for this controller may be achieved via a Zero Order Hold (ZOH) which held the controller output/plant input for time Δt.

The e(t) and ė(t) terms can be transformed into:

$${e}_{1} = \overline{e} ( t , {θ}_{near} ( t ) , … , distError Target ( t ) )$$

$${e}_{2} = \dot{\overline{e}} ( t , {\dot{θ}}_{near} ( t ) , … , distErro \dot{r} Target ( t ) ) ,$$

where e₁ is the representative singular input error generated by the input error element composing e(t) with little concern as the range of resulting values or how those values would be calculated. A similar simplification may be provided for e₂ and u₁ with n₁ being the output trajectory of the vehicle. This output trajectory may be derived by combining the rule-base's two outputs of angular velocity and linear speed. Consequently, each antecedent and consequent combination of linguistic values for each of the rule described above became their own linguistic value. For example, if distErr Target is far, distErr Line is far left, and θ_{far} is close left, Angular Velocity would be set to right 1 and Linear Speed would be set to fast. Here e₁ would have the linguistic value TF, LFL, θ_{f}CL (Target Far, Line Far Left, θ_{far} Close Left) whose level of membership would be determined by taking the t-norm of the level of membership in distErr Target in Far, distErr Line in Far Left, and θ_{far} in Close Left.

The Theorem 1, Definitions 1-3 below for proving the stability are provided with the following:

$${\dot{e}}_{1} = {e}_{2}$$

$${u}_{1} = Φ ( {e}_{1} , {e}_{2} )$$

$$- {e}_{1} = \overline{e} ( t , - {θ}_{near} ( t ) , … , - dE Line ( t ) , dE Target ( t ) )$$

$$- {e}_{2} = \dot{\overline{e}} ( t , - {\dot{θ}}_{near} ( t ) , … , - dE \dot{L} ine ( t ) , dE \dot{T} arget ( t ) )$$

### Theorem 1

A sufficient condition for asymptotic stability of the fuzzy control closed-loop is the input-output passivity of the system itself.

### Definition 1

For any fuzzy controller with two inputs and one output, if the input-output non-linear mapping can be described by a continuous bounded Lipschitz function Φ(·,·) with the following properties, with the fuzzy controller referred to as an SFC:

$$1. \vert Φ ( {e}_{1} , {e}_{2} ) \vert \leq {u}_{M} and M = {max}_{j} {x}_{j} ;$$

$$2. Φ ( 0 , 0 ) = 0 ( steady state condition ) ;$$

$$3. Φ ( {e}_{1} , {e}_{2} ) = - Φ ( - {e}_{1} , - {e}_{2} ) ( odd symmetry ) ;$$

$$4. Φ ( {e}_{1} , 0 ) = 0 ⇒ {e}_{1} = 0 ;$$

5.Φ(·,·) is a sectional function, in the sense that for every

$$( {e}_{1} , {e}_{2} ) , there exist {X}^{′} , {γ}^{′} > 0 such that :$$

$$0 \leq {e}_{1} \cdot ( Φ ( {e}_{1} , {e}_{2} ) - Φ ( 0 , {e}_{2} ) ) \leq {λ}^{′} {e}_{1}^{2}$$

$$0 \leq {e}_{2} \cdot ( Φ ( {e}_{1} , {e}_{2} ) - Φ ( {e}_{1} , 0 ) ) \leq {γ}^{′} {e}_{2}^{2} ”$$

Since every input that e₂(k) could take has membership 1 in Dummy, Φ(e₁,e₂)=Φ(e₁,0) and Φ(0,e₂)=0. As a result, the property 5 above simplifies to:

$$0 \leq {e}_{1} \cdot ( Φ ( {e}_{1} , {e}_{2} ) - 0 ) \leq {λ}^{′} {e}_{1}^{2} \qquad ( 26 )$$

$$0 \leq {e}_{2} \cdot ( Φ ( {e}_{1} , {e}_{2} ) - Φ ( {e}_{1} , {e}_{2} ) ) \leq {γ}^{′} {e}_{2}^{2} \qquad ( 27 )$$

$$0 \leq {e}_{1} \cdot Φ ( {e}_{1} \cdot {e}_{2} ) \leq {λ}^{′} {e}_{1}^{2} \qquad ( 28 )$$

$$0 \leq 0 \leq {γ}^{′} {e}_{2}^{2} \qquad ( 29 )$$

Taking e₂=0 in Equation (28) further results in

$$0 \leq {e}_{1} \cdot Φ ( {e}_{1} , 0 ) \leq {λ}^{′} {e}_{1}^{2} \qquad ( 30 )$$

which is true for ∀λ′≥uₘ/|e₁|, ∀γ′>0, and for every (e₁, e₂).

For example, θₙₑₐᵣ has membership functions μₙ(xₙ), θ_{far} has membership functions μ_{f}(x_{f}), θ_{lookahead} has membership functions μₗ(xₗ), distError Line has membership functions μ_{L}(x_{L}), and distError Target has membership functions μ_{T}(x_{T}) such that zₙ, x_{f}, xₗϵ{−π, π} and x_{T}, x_{L}ϵ [symbol] . Since the controller possesses the Mandani structure, the Aggregation operation on the output membership functions for each of the rules is a maximum and the t-norm between input membership functions for a given rule is a minimum.

For rules i=1-10, θ_{far}, distError Line, distError Target determine the membership in the output as follows:

$${μ}_{{1}_{ia}} = probOR \{ {μ}_{{f}_{i}} ( {x}_{f} ) , {μ}_{{L}_{i}} ( {x}_{L} ) \}$$

$${μ}_{{1}_{i}} = probOR \{ {μ}_{{1}_{ia}} , {μ}_{{T}_{i}} ( {x}_{T} ) \}$$

with the output membership for this set of rules determined by

$${μ}_{1} = \prod \{ {μ}_{{1}_{1}} , {μ}_{{1}_{2}} , … , {μ}_{{1}_{10}} \}$$

For rules i=11-35, θₙₑₐᵣ, distError Line, distError Target determined the membership in the output as follows:

$${μ}_{{2}_{ia}} = probOR \{ {μ}_{{n}_{i}} ( {x}_{n} ) , {μ}_{{L}_{i}} ( {x}_{L} ) \}$$

$${μ}_{{2}_{i}} = probOR \{ {μ}_{{2}_{ia}} , {μ}_{{T}_{i}} ( {x}_{T} ) \}$$

with the output membership for this set of rules determined by

$${μ}_{2} = \prod \{ {μ}_{{2}_{11}} , {μ}_{{2}_{12} ,} … , {μ}_{{2}_{35}} \}$$

For rules i=36-40, θ_{lookahead}, distError Target determined the membership in the output as follows:

$${μ}_{{3}_{i}} = probOR \{ {μ}_{{l}_{i}} ( {x}_{l} ) , {μ}_{{T}_{i}} ( {x}_{T} ) \}$$

with the output membership for this set of rules determined by

$${μ}_{3} = \prod \{ {μ}_{{3}_{36}} , {μ}_{{3}_{37}} , … , {μ}_{{3}_{40}} \} \qquad ( 31 )$$

$$μ = \prod \{ {μ}_{1} , {μ}_{2} , {μ}_{3} \}$$

$$Φ = \frac{{\sum }_{j = 1}^{N} ( {x}_{j} * μ ( {x}_{j} ) )}{{\sum }_{j = 1}^{N} μ ( {x}_{j} )} ,$$

considering a continuous system in the state-space form as

$$\dot{x} = f ( x , u ) , x ∈ {n}^{} , u ∈ {m}^{} \qquad ( 32 )$$

$$y = h ( x , u ) , y ∈ {m}^{} \qquad ( 33 )$$

where f(·, ·) and h(·, ·) are smooth functions.

### Definition 2

System Equation (32) with a properly chosen output. Equation (33) is referred to as being passive with respect to the supply rate s(u,y)=u^{T}yϵ [symbol] , if there exists a positive definite function V with V(0)=0, regarded as the storage function, such that the following inequality is satisfied for all x(t₀):

$$V ( x ( {t}_{f} ) ) - V ( x ( {t}_{0} ) ) \leq {\int }_{{t}_{0}}^{{t}_{f}} s ( u ( σ ) , y ( σ ) ) d σ , ∀ x , ∀ u$$

Then, the fuzzy controller can be considered as a single-input single-output (SISO) non-linear system with internal dynamics, where e₂ is the input, u₁ is the output and eᵢ is the state variable.

Applying [the above] definition of passivity results in:

$$\begin{matrix}\text{?} {e}_{2} ( σ ) {u}_{1} ( σ ) d σ = {\int }_{0}^{t} {e}_{2} ( τ ) Φ ( {e}_{1} ( τ ) , {e}_{2} ( τ ) ) d τ \\ = {\int }_{0}^{t} {e}_{2} ( τ ) Φ ( {e}_{1} ( τ ) , 0 ) d τ \\ + {\int }_{0}^{t} {e}_{2} ( τ ) ( Φ ( {e}_{1} ( τ ) , {e}_{2} ( τ ) ) \\ - Φ ( {e}_{1} ( τ ) , 0 ) ) d τ \\ \geq {\int }_{0}^{t} {e}_{2} ( τ ) Φ ( {e}_{1} ( τ ) , 0 ) d τ \\ = {\int }_{0}^{t} {\dot{e}}_{2} ( τ ) Φ ( {e}_{1} ( τ ) , 0 ) d τ \\ = {\int }_{{e}_{1} ( 0 )}^{{e}_{1} ( t )} Φ ( {e}_{1} , 0 ) {de}_{1} \\ = V ( {e}_{1} ( t ) ) - V ( {e}_{1} ( 0 ) )\end{matrix}$$

$$\text{?} \text{indicates text missing or illegible when filed}$$

As such, as the sufficient condition for asymptotic stability of the continuous fuzzy control closed-loop of Theorem 1 is met.

Including delays the state space form becomes:

$$\dot{x} = f ( x ( t ) , u ( t ) ) + f ( x ( t - {T}_{n} ) , u ( t ) ) \qquad ( 34 )$$

$$\vert ∀ t \geq 0 , x ( t ) ϵ {ℛ}^{n} and u ( t ) ϵ {ℛ}^{m}$$

$$y = h ( x ( t ) , u ( t ) ) + h ( x ( t - {T}_{n} ) , u ( t ) ) , \qquad ( 35 )$$

$$\vert ∀ t \geq 0 , y ϵ {ℛ}^{m}$$

where Tₙ is some delay s.t. 0≤Tₙ<c for cϵ [symbol] ⁺. The supply rate from Definition 2 remains s(u,y)=u^{T}y. However, u and y change in accordance with Equations (34) and (35) respectively. As a result,

$$\begin{matrix}{\int }_{{t}_{0}}^{{t}_{f}} {e}_{2} ( σ ) {u}_{1} ( σ ) d σ = {\int }_{0}^{t} {e}_{2} ( τ ) \\ * ( Φ ( {e}_{1} ( τ ) , {e}_{2} ( τ ) ) + Φ ( {e}_{1} ( τ - {T}_{1} ) , {e}_{2} ( τ - {T}_{1} ) ) ) d τ \\ = {\int }_{0}^{t} {e}_{2} ( τ ) ( Φ ( {e}_{1} ( τ ) , 0 ) + Φ ( {e}_{1} ( τ ) - {T}_{1} , 0 ) ) d τ \\ + {\int }_{0}^{t} {e}_{2} ( τ ) ( Φ ( {e}_{1} ( τ ) , {e}_{2} ( τ ) ) + Φ ( {e}_{1} ( τ - {T}_{1} ) , {e}_{2} ( τ - {T}_{1} ) ) \\ - Φ ( {e}_{1} ( τ ) , 0 ) - Φ ( {e}_{1} ( τ - {T}_{1} ) , 0 ) ) d τ \\ \geq {\int }_{0}^{t} {e}_{2} ( τ ) ( Φ ( {e}_{1} ( τ ) , 0 ) + Φ ( {e}_{1} ( τ - {T}_{1} , 0 ) ) d τ \\ = {\int }_{0}^{t} ( {\dot{e}}_{1} ( τ ) + {\dot{e}}_{1} ( τ - {T}_{1} ) ) \\ * ( Φ ( {e}_{1} ( τ ) , 0 ) + Φ ( {e}_{1} ( τ - {T}_{1} ) , 0 ) ) d τ \\ = {\int }_{0}^{t} ( {\dot{e}}_{1} ( τ ) Φ ( {e}_{1} ( τ ) , 0 ) ) d τ + {\int }_{0}^{t} ( {\dot{e}}_{1} ( τ ) Φ ( {e}_{1} ( τ - {T}_{1} ) , 0 ) ) ) d τ \\ + {\int }_{0}^{t} ( {\dot{e}}_{1} ( τ - {T}_{1} ) Φ ( {e}_{1} ( τ ) , 0 ) ) d τ \\ + {\int }_{0}^{t} ( {\dot{e}}_{1} ( τ - {T}_{1} ) Φ ( {e}_{1} ( τ - {T}_{1} ) , 0 ) ) ) d τ \\ = {A}_{1} + {A}_{2} + {A}_{3} + {A}_{4} \\ \geq 4 {C}_{n} {\int }_{{e}_{1} ( 0 )}^{{e}_{1} ( t )} Φ ( {e}_{1} , 0 ) {de}_{1} \\ = V ( {e}_{1} ( t ) ) - V ( {e}_{1} ( 0 ) )\end{matrix}$$

For example, there may then be 4 possibilities at any time t. Rather min(A₁, A₂, A₃, A₄)=A₁. Then,

$${C}_{n} = {A}_{1} / {A}_{1} = 1$$

$$min ( {A}_{1} , {A}_{2} , {A}_{3} , {A}_{4} ) = {A}_{2} .$$

$${C}_{n} = min ( {A}_{2} / {A}_{1} ) from 0 to t$$

$$min ( {A}_{1} , {A}_{2} , {A}_{3} , {A}_{4} ) = {A}_{3} .$$

$${C}_{n} = min ( {A}_{3} / {A}_{1} ) from 0 to t$$

$$min ( {A}_{1} , {A}_{2} , {A}_{3} , {A}_{4} ) = {A}_{4} .$$

$${C}_{n} = {A}_{2} / {A}_{1}$$

Consider a discrete system in the state-space form as

$$x ( k + 1 ) = f ( x , u ) , x ϵ {ℛ}^{n} , u ϵ {ℛ}^{m} \qquad ( 36 )$$

$$y = h ( x ( k ) , u ( k ) ) , y ϵ {ℛ}^{m} \qquad ( 37 )$$

where f(·, ·) and h(·, ·) are smooth functions.

### Definition 3

System Equation (36) with a properly chosen output in Equation (37) is said to be passive with respect to the supply rate s(u(k), y(k))=u(k)^{T}y(k)ϵR (k≥0), if there exists a positive definite function V with V(0)=0, regarded as the storage function, such that the following inequality is satisfied for all x(0), and ∀kϵ [symbol] ⁺=0, 1, 2, . . . .

$$V ( x ( k + 1 ) ) - V ( x ( k ) ) \leq s ( u ( k ) , y ( k ) ) , ∀ x ( k ) , ∀ u ( k ) , ∀ k$$

Applying the definition of passivity in the discrete case we get:

$$\begin{matrix}{e}_{2} ( k ) {u}_{1} ( k ) = {e}_{2} ( k ) {Φ}_{1} ( {e}_{1} ( k ) , {e}_{2} ( k ) ) \\ = {e}_{2} ( k ) Φ ( {e}_{1} ( k ) , 0 ) \\ + {e}_{2} ( k ) ( Φ ( {e}_{1} ( k ) , {e}_{2} ( k ) ) - Φ ( {e}_{1} ( k ) , 0 ) ) \\ \geq {e}_{2} ( k ) Φ ( {e}_{1} ( k ) , 0 ) \\ = ( {e}_{1} ( k ) - {e}_{1} ( k - 1 ) ) Φ ( {e}_{1} ( k ) , 0 ) \\ = {e}_{1} ( k ) Φ ( {e}_{1} ( k ) , 0 ) - {e}_{1} ( k - 1 ) Φ ( {e}_{1} ( k ) , 0 ) \\ = V ( {e}_{1} ( k + 1 ) ) - V ( {e}_{1} ( k ) )\end{matrix}$$

As such, as the sufficient condition for asymptotic stability of the discrete fuzzy control closed-loop of Theorem 1 is met.

Including delays in the discrete system, the state space form becomes

$$x ( k + 1 ) = f ( x ( k ) , u ( k ) ) + f ( x ( k - {T}_{m} ) , u ( k - {T}_{m} ) ) , \qquad ( 38 )$$

$$x ϵ {ℛ}^{n} , u ϵ {ℛ}^{m}$$

$$y = h ( x ( k ) , u ( k ) ) + h ( x ( k - {T}_{m} ) , u ( k - {T}_{m} ) ) , \qquad ( 39 )$$

$$y ϵ {ℛ}^{m}$$

where Tₘ represents some delay s.t. 0≤Tₘ<d for dϵ [symbol] ⁺. The supply rate from Definition 3 remains s(u, y)=u(k)^{T}y(k). However, u and y change in accordance with (38) and (39) respectively. As a result:

$$\begin{matrix}{e}_{2} ( k ) {u}_{1} ( k ) = {e}_{2} ( k ) ( {Φ}_{1} ( {e}_{1} ( k ) , {e}_{2} ( k ) ) + {Φ}_{1} ( {e}_{1} ( k - {T}_{3} ) , {e}_{2} ( k - {T}_{3} ) ) ) \\ = {e}_{2} ( k ) Φ ( {e}_{1} ( k ) , 0 ) + Φ ( {e}_{1} ( k - {T}_{3} ) , 0 ) \\ + {e}_{2} ( k ) ( Φ ( {e}_{1} ( k ) , {e}_{2} ( k ) ) + Φ ( {e}_{1} ( k - {T}_{3} ) , {e}_{2} ( k - {T}_{3} ) ) \\ - Φ ( {e}_{1} ( k ) , 0 ) - Φ ( {e}_{1} ( k - {T}_{3} ) , 0 ) ) \\ \geq {e}_{2} ( k ) ( Φ ( {e}_{1} ( k ) , 0 ) + Φ ( {e}_{1} ( k - {T}_{3} ) , 0 ) ) \\ = ( ( {e}_{1} ( k ) - {e}_{1} ( k - 1 ) + ( {e}_{1} ( k ) - {e}_{1} ( k - 1 ) - {e}_{1} ( k - {T}_{3} ) ) \\ * ( Φ ( {e}_{1} ( k ) , 0 ) + Φ ( {e}_{1} ( k - {T}_{3} ) , 0 ) ) \\ = ( 2 {e}_{1} ( k ) - 2 {e}_{1} ( k - 1 ) - {e}_{1} ( k - {T}_{3} ) ) \\ * ( Φ ( {e}_{1} ( k ) , 0 ) + Φ ( {e}_{1} ( k - {T}_{3} ) , 0 ) ) \\ = V ( {e}_{1} ( k + 1 ) ) - V ( {e}_{1} ( k ) )\end{matrix}$$

### Simulation and Experimental Studies of Path Tracking Controller

### Test Courses

An example methodology for validating controller performance is used in the disclosure below for both the fuzzy and pure pursuit controllers. The approach validated controller performance by testing controllers under a set of path conditions that emphasized the efforts of disturbance rejection, phase lag, overshoot, and the like.

Example test courses are used. There are no figures in this section associated with blank versions of each of these test courses. However, each course is shown in in later sections with plots of the vehicle performance overlaid.

Test Course 1 includes a single left turn with the waypoints laid out in an L shape. The purpose of having such a sharp turn is to examine a simple yet common layout related steering disturbance a controller might experience when moving around a building or other human structures.

The next path, Test Course 2, incorporates above minimum radius turns that are still relatively sharp. These above minimum radius turns allow for a more accurate assessment of RMSE as a vehicle that could not turn in place could still have zero error. Accordingly, straightaways are paired with these above minimum radius turns to evaluate overshoot. This distinction is more important than it would initially seem as squaring the error term amplifies the errors associated with overshooting. Test Courses 2 also has both right-handed and left-handed turns, thus ensuring that the vehicle operated identically in both directions.

Test Course 3 is a figure-eight like path. The at or below minimal turn radii of the circles are used to evaluate the ability of a controller to accommodate the associated steering disturbances as present in the Maximum Error (ME). Meanwhile, the curvature of this design is useful in evaluating path phase lag about the curves which could lead to distance error and thus higher Root Mean Squared Error (RMSE).

Test course 4 incorporates both oscillatory turning that invoked phase lag similar to Test Course 3 and the above minimum radius turns are paired with straightaways of Test. Course 2. Thus, the course allowed for a more holistic examination of the controllers given the factors associated with RMSE and ME discussed above.

### Pure Pursuit

On each course, the fuzzy controller's performance is compared to that of an example classical pure pursuit algorithm. This choice is made as pure pursuit is one of the most commonly used waypoint navigation control algorithms and thus can be use-d as an ideal baseline controller. For that reason, the controller used is the default MATLAB pure pursuit control block.

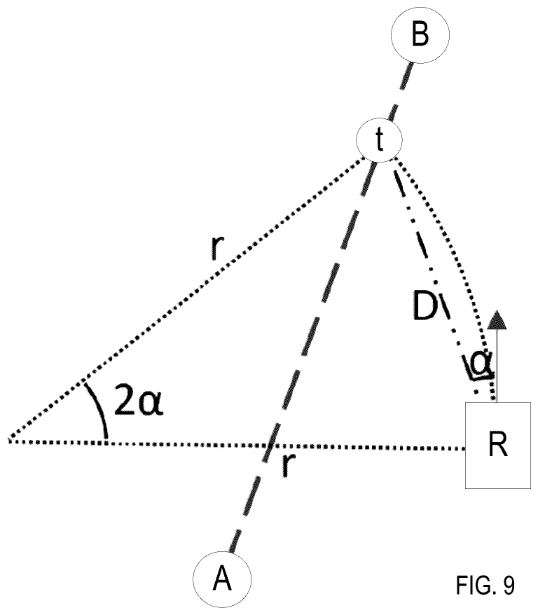

The geometric structure of the controller is presented in FIG. 9 with D being the lookahead distance from the vehicle to the path, α being the angle between the vehicle's orientation, and r being the radius of the curve that the vehicle R travels along. Moreover, r is computed using D and α with the equation

$$r = \frac{D}{2 sin ( α )} .$$

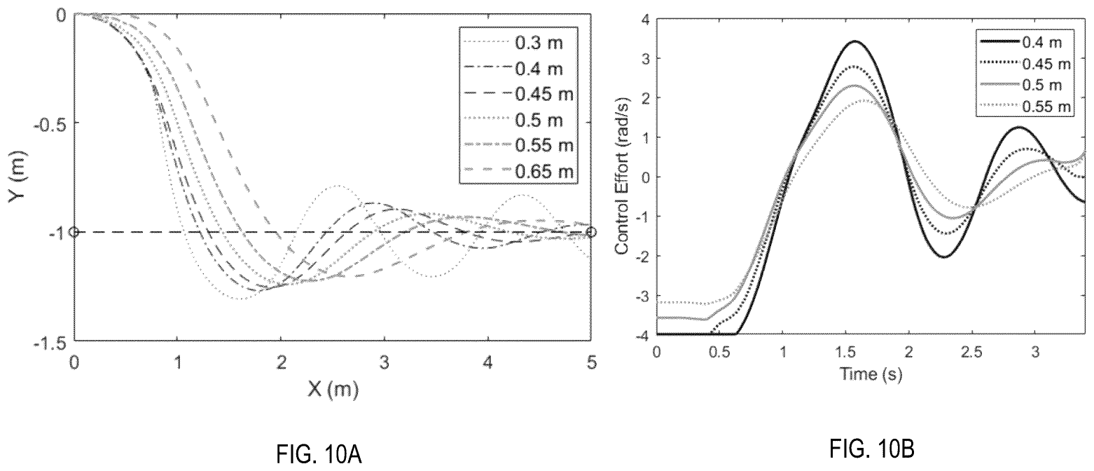

The lookahead distance is chosen to be 0.5 meters by sweeping through potential lookahead values while converging to a straight line with an initial offset. The results of this experiment are run in simulation and can be seen below in FIGS. 10A and 10B. The lookahead value of 0.5 meters is selected because it appeared to have reasonably small overshoots while also having acceptably fast rise times and settling distances.

In test cases like the one presented in FIG. 10A, it makes sense to choose a further lookahead point between 0.55 m and 0.65 m because it further reduces overshoot and does not sacrifice much in terms of settling distance. In addition, it can be gleaned from FIG. 10B that a further lookahead point requires less control action. However, these controllers perform worse in terms of accumulating phase lag. The 0.5 m lookahead controller also performs slightly better than these controllers in terms of minimizing the RMSE over the path, with \sqrt{mse} values of 0.3150 m for 0.5 m and 0.3151 m, 0.3192 m, and 0.3178 m for 0.55 m, 0.60 m and 0.65 m of lookahead distance respectively.

An other reason for using slightly smaller lookahead values may be because they have slightly smaller \sqrt{mse} values; with 0.40 m having had a value of 0.3126 m and 0.45 m having had a value of 0.3113 m. However, on the actual test courses, these controllers perform worse than the controller with a lookahead distance of 0.5 m. This may be because the settling distance and overshoot become much more important metrics than rise distance when the vehicle is initialized on the path. If the vehicle is expected to have to regularly converge to paths from far away the benefits from these controllers may outweigh the costs, but this is an edge case in most day-to-day operations.

### Simulation and Experimental Setup for Path Tracking Controller

The metrics used to compare the controllers are the square root of the mean squared distance error with respect to the target trajectory, the maximum distance error with respect to the target trajectory, and the time required to complete the courses. The controller tuning is done by hand and with the aid of automation scripts.

The experimental results are acquired by running a Clearpath Jackal on a lightly worn concrete parking lot. An instance of the Robot Operating System (ROS) runs on the Clearpath Jackal. Using ROS allows for both sensor data to be sent to and commands to be received from an external laptop. To enable such communication/control, the laptop runs MATLAB, the MATLAB ROS Toolbox, the MATLAB Fuzzy Logic Toolbox, and Simulink. In Simulink, a subscriber block subscribes to the position and orientation inputs from the ROS topic ‘/odomnetry/filtered.’ Next, these inputs are converted into vehicle states and a target trajectory. Those are then fed into the fuzzy controller. The controller proceeds to determine the angular velocity setpoint. Both the predefined linear and controlled angular velocity setpoints are then published to the ROS topic ‘/cmd_vel’ using a publish block. At the same time, the x position, y position, angular velocity, and distError Line are saved to a

TABLE 10
Example Vehicle Model Parameters

| Property | Chassis | | | Wheels | | |
|---|---|---|---|---|---|---|
| Dimen- | x: | 0.420 | m | r: | 0.098 | m |
| sion | y: | 0.310 | m | w: | 0.040 | m |
| | z: | 0.184 | m | | | |
| Offset | x: | 0 | m | x: | 0.131 | m |
| | y: | 0 | m | y: | 0.188 | m |
| | z: | 0 | m | z: | 0.0345 | m |
| Mass | | 16.52 | kg | | 0.477 | kg |

| | | |
|---|---|---|
| Moment of Inertia | $[ \begin{matrix}0.3136 & - 0.002 & 0.0164 \\ - 0.0008 & 0.3922 & 0.0009 \\ 0.0164 & 0.0009 & 0.4485\end{matrix} ]$ | $[ \begin{matrix}0.00116 & 0 & 0 \\ 0 & 0.00229 & 0 \\ 0 & 0 & 0.00116\end{matrix} ]$ |

matrix in MATLAB.

The same data are saved in the simulation where results are acquired using the skid-steer vehicle dynamic model presented above. Accordingly, an example Spatial_v2 toolbox allows for implementation of the dynamic model. Table 10 below shows example vehicle model parameters for the Clearpath Jackal used in the experiments above.

Further, the Simulink portion of the model in the simulation is divided into four major components: the forward dynamics solver, the ground contact model, an external vehicle controller, and an internal vehicle controller.

The forward dynamics solver is used to apply forces/torques to update the vehicle's position and velocity. The ground contact model is used to determine how the ground applied forces and torques back to the vehicle.

The external vehicle controller functions much the same as in the experimental equivalent. It receives the vehicle position, orientation, and target path and output the target linear and angular velocities in order to minimize error with respect to the target trajectory. The internal vehicle controller accepts these velocity targets as inputs and translates them into wheel torques.

It is thus assumed that the control processes consisted of a high-level and low-level controller. The high-level controller would receive the linear speed and angular velocity control setpoints and transformed them into lower-level actuator setpoints. The low-level controller would instruct the actuators to hit those set points. This low-level control is chosen to be a PID controller with an integral windup saturation limit. Related parameters are defined as: Kₚ=4, Kᵢ=500, K_{d}=−0.002, Wheel Velocity Saturation=2.2 m/s, Torque Saturation=7 Nm, and Realistic Linear Velocity Factor=0.9225. Here, the “Realistic Linear Velocity Factor” is used to match the linear velocity the vehicle would actually achieve, given the speed it is commanded to achieve. Furthermore, for ease of implementation, each wheel is modeled as having an associated motor despite the actual vehicle having only one motor for the left two wheels and one motor for the right two wheels.

Additionally, an initialization file is used to create an environment for the vehicle to interact with, which consisted of the ground geometry and ground contact coefficients K=1000000, D=1000, and μ=0.85. Next, it creates a 6 DOF floating base parent link with the physical characteristics of the base of the vehicle. Then, it creates wheel models with the physical characteristics of the wheels and links them to the base with a 1 degree of freedom rotation link. After that, the file defines the contact point locations of the base, which are the corners, and the wheels which are 32 points evenly spaced about the circumference of the wheels. Lastly, the vehicle and wheel initial positions, orientations, and velocities are defined.

To verify the proposed dynamic model and tune any inaccurate parameters a high fidelity motion capture system with 7 motion capture cameras located in the University of Illinois Intelligent. Robotics Laboratory are used. These cameras are designed to track the wavelength of light reflected by the silver balls attached to the vehicle. This is done by performing a least-squares regression/triangulation of the position of each of the individual balls, which allows it to calculate the position of the balls with 1 mm accuracy. The proposed ball configuration is thus deemed sufficient to accurately measure the position/orientation data through differentiation and to develop a polynomial fit to map the wheel velocity setpoint allocation.

The communication delay of the Jackal is also incorporated. To measure the communication time delay, a discontinuity is generate between the vehicle's zero angular velocity and a commanded nonzero angular velocity. The time between the Jackal's localization package recognizing the command and the angular velocity of the wheels changing is then measured. Across several trials, this value averages out to 0.068 seconds. However, since the simulation is not real-time, the delay is increased to 0.075 seconds to reduce time discrepancies between it and the experiment. Due to the uncertainty of the Course Completion Time (CCT) of the simulation, experimental and simulation CCTs ware calculated by dividing the total distance traveled by the overall Cartesian velocity.

For both the simulation and the experiment, the Clearpath Jackal runs at an angular velocity set-point ranging between −4 rad/s and 4 rad/s across all three courses. However, the constant linear speed is 2 m/s for the first to fourth courses. This gives the vehicle a theoretical minimum turn radius of 0.5 m.

### Experimental Results for Path Tracking Controller

The control efforts, where differences are most visible, for both the simulation and experiment are similar. As such, the experimental linear and angular control effort plots are presented for each of the test courses. For a similar reason,

TABLE 11
Controller Performance Results: Pure Pursuit and Variable Linear Speed

| | Pure Pursuit | | | Variable Linear Speed, Fuzzy | | | Percent Change (%) | | |
|---|---|---|---|---|---|---|---|---|---|
| Course | RMSE | Max Error | Time | RMSE | Max Error | Time | RMSE | Max Error | Time |
| 1 Sim. | 0.2165 | 0.6284 | 4.3123 | 0.0694 | 0.2521 | 4.3727 | −67.945 | −59.882 | 1.4006 |
| 1 Exp. | 0.338 | 0.6853 | 4.2459 | 0.0770 | 0.1152 | 4.152 | −77.219 | −83.190 | −2.2115 |
| 2S | 0.28 | 0.574 | 3.5725 | 0.2237 | 0.574 | 3.6492 | −20.107 | 0 | 2.14707 |
| 2E | 0.2922 | 0.5506 | 3.5021 | 0.0652 | 0.1417 | 3.7681 | −77.687 | −74.264 | 7.5954 |
| 3S | 0.1074 | 0.2561 | 9.8601 | 0.0349 | 0.1313 | 10.2569 | −67.505 | −48.731 | 4.0243 |
| 3E | 1.6373 | 2.6778 | 14.3836 | 0.1367 | 0.2568 | 10.3042 | −91.651 | −90.410 | N/A |
| 4S | 0.0873 | 0.2237 | 30.5961 | 0.0195 | 0.093 | 30.9785 | −77.663 | −58.426 | 1.2498 |
| 4E | 0.0901 | 0.2765 | 30.2438 | 0.0736 | 0.1423 | 31.6682 | −18.313 | −48.535 | 4.7097 |

TABLE 12
Controller Performance Results: Constant and Variable Linear Speed

| | Constant Linear Speed, Fuzzy | | | Variable Linear Speed, Fuzzy | | | Percent Change (%) | | |
|---|---|---|---|---|---|---|---|---|---|
| Course | RMSE | Max Error | Time | RMSE | Max Error | Time | RMSE | Max Error | Time |
| 1 Sim. | 0.176 | 0.5404 | 4.2094 | 0.0694 | 0.2521 | 4.3727 | −60.568 | −53.349 | 3.8794 |
| 1 Exp. | 0.2645 | 0.5712 | 4.1678 | 0.077 | 0.1152 | 4.152 | −70.888 | −79.832 | −0.37910 |
| 2S | 0.2496 | 0.574 | 3.5267 | 0.2237 | 0.574 | 3.649 | −10.377 | 0 | 3.4735 |
| 2E | 0.2239 | 0.4517 | 3.3873 | 0.0652 | 0.1417 | 3.768 | −70.880 | −68.630 | 11.242 |
| 35 | 0.0828 | 0.2385 | 9.679 | 0.0349 | 0.1313 | 10.257 | −57.850 | −44.948 | 5.9707 |
| 3E | 0.2289 | 0.3039 | 9.4269 | 0.1367 | 0.2568 | 10.304 | −40.280 | −15.499 | 9.3064 |
| 4S | 0.0497 | 0.1163 | 29.9559 | 0.0195 | 0.093 | 30.979 | −60.765 | −20.0344 | 3.4136 |
| 4E | 0.1205 | 0.2235 | 29.9869 | 0.0736 | 0.1423 | 31.668 | −38.921 | −36.331 | 5.6068 |

only the experimental path plots are presented below. Additionally, a tabulated set of results for all test courses can be found in Table 11 and Table 12. For brevity, exact RMSEs, MEs, and CCTs are not shown, as the Percent Change (PC) is most relevant when comparing controllers. The unit for RMSE and Max Error are meters. The unit for Time is seconds.

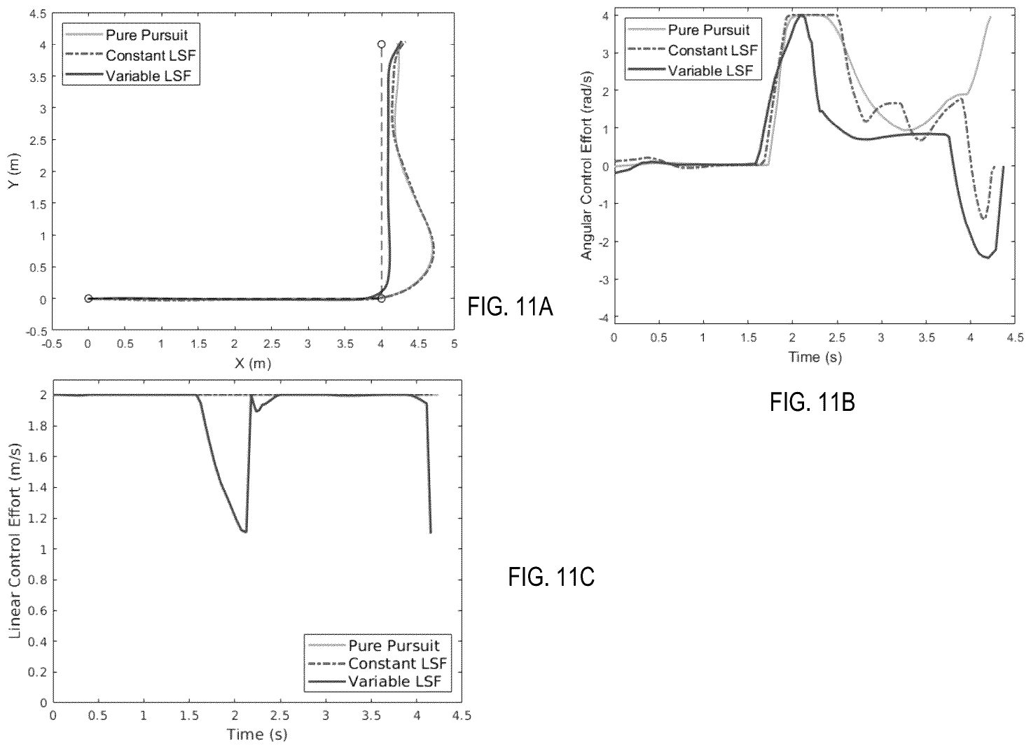

Test course 1, as shown in FIG. 11A, and as discussed above, is designed to assess the response of the controller to layout related steering disturbance. In Figure FIG. 11A, the Variable Linear Speed Fuzzy (VLSF) controller dramatically outperforms both the pure pursuit and Constant Linear Speed Fuzzy (CLSF) controller in terms of overshoot.

The related control efforts can be seen in FIGS. 11B and 11C. In FIG. 11B, the main turn occurs around the 1.5 second mark and the VLSF is the first to reduce it's control action from the maximum. FIG. 11C depicts that as turning about the main turn starts, the VLSF's speed decreased.

In terms of metrics, the VLSF controller handily outperforms the pure pursuit. In simulation, percent changes are −67.9446% for RMSE −59.8822% for ME, and 1.40064% for CCT. The experimental values are all larger with a RMSE PC at −77.2189%, ME PC at −83.1898%, and CCT PC at −2.21155%.

A similar increase from simulation to experiment i also observed against the constant linear speed fuzzy controller. In simulation, percent changes are −60.5682% for RMSE, −53.3494% for ME, and 3.87941% for CCT. While, the experimental values are a RMSE PC at −70.8885%, ME PC at −79.8319%, and CCT PC at −0.3791%.

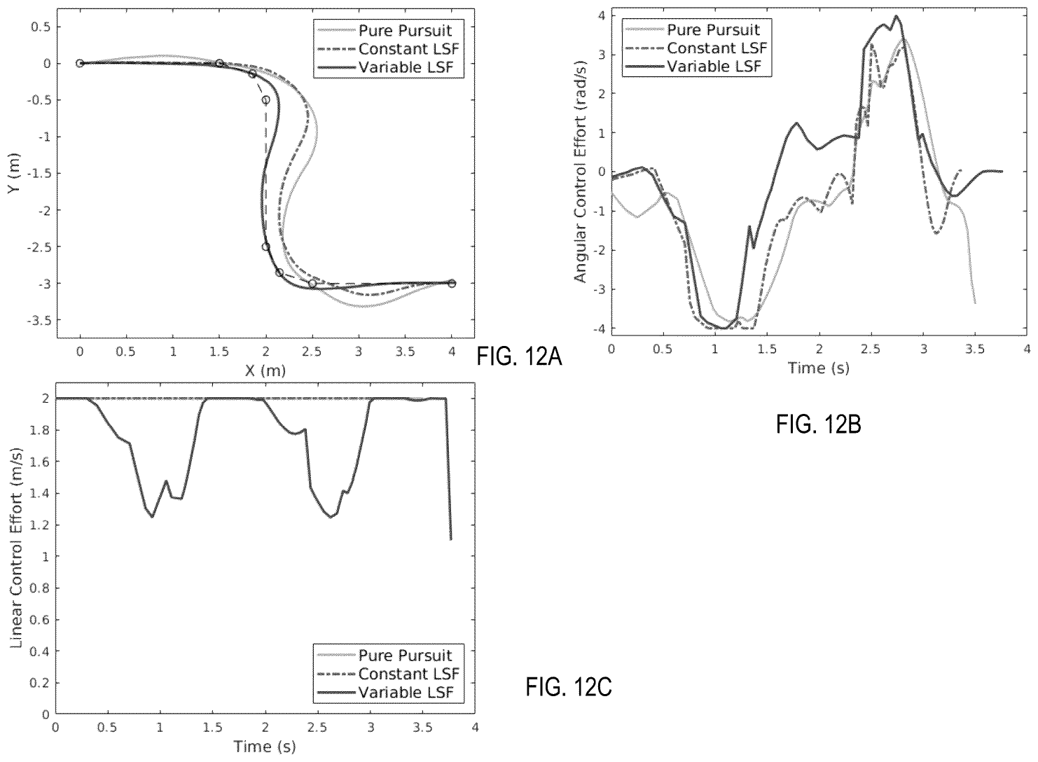

Test Course 2, as shown in FIG. 12A, and as discussed above, is designed to examine overshoot on turns when the vehicle's turn radius is no longer a factor. In FIG. 12A, the VLSF controller outperform the pure pursuit controller in terms of overshoot for the first turn while seeing more overshoot than the pure pursuit on the second turn.

The associated control efforts are illustrated in FIG. 12B and FIG. 12C. The angular velocity control efforts of the VLSF are similar to the CLSF with a fraction of a second more time used to settle on the end waypoint. The linear speed control efforts in FIG. 12C contains dips in speed associated with each turn and the return to the endpoint for the VLSF.

Numerically, the controller yields simulated results of a RMSE PC of −20.107% and ME PC of 0% with a marginal increase in CCT at 2.1470%. While experimentally the RMSE PC is larger at −77.6865%. Likewise, the ME PC is −74.2644%, and the CCT PC yields a larger increase than other courses to 7.59544%.

Similar trends are seen against the CLSF. In simulation, percent changes are −10.3766% for RMSE, 0% for ME, and 3.4735% for CCT. Experimentally, values of RMSE PC are at −70.8799%, ME PC at −68.6296%, and CCT PC at 11.242%.

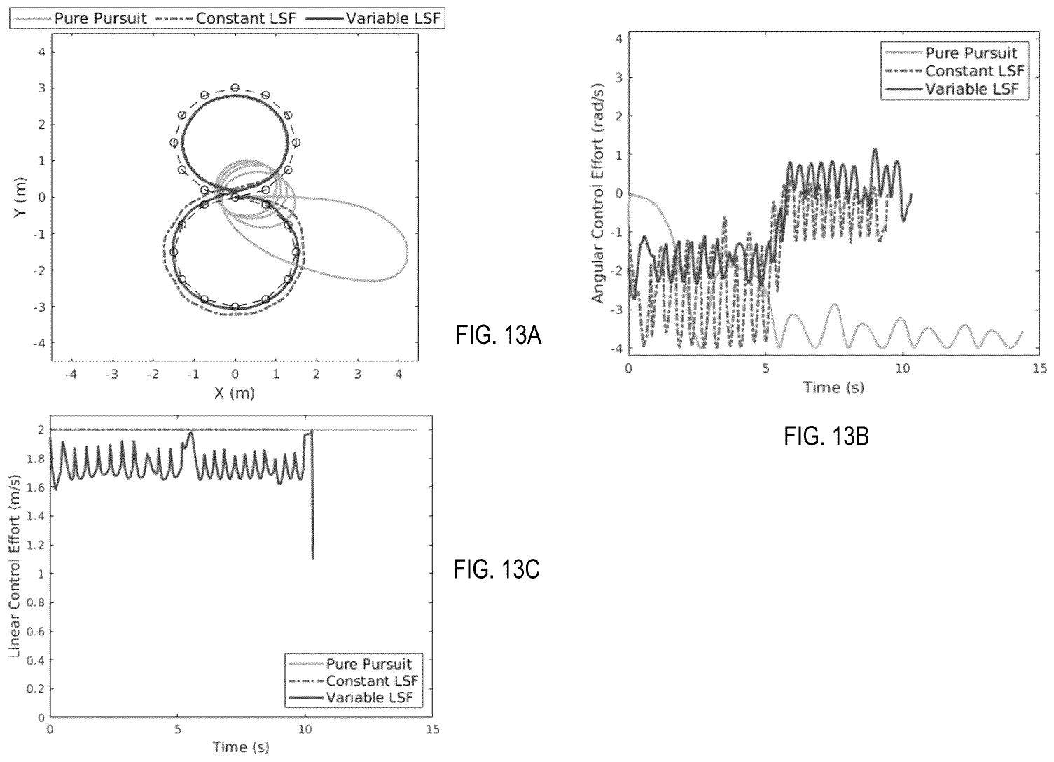

Test Course 3, as shown in FIG. 13A, and as discussed above, is designed to assessing whether the controllers experienced non-minimum phase due to layout related steering disturbance.

The associated control efforts can be seen in FIG. 13B and FIG. 13C with the VLSF besting both the pure pursuit and CLSF in terms of both overshoot. As in Test Course 3, the angular velocity control effort of the VLSF mimics that of the constant linear speed fuzzy controller. However, in FIG. 1313, a moderate phase lag from the CLSF to the VLSF is present. This may be due to the VLSF slowing down (see FIG. 13C), to account for the tight turns of the course.

In terms of metrics, the VLSF fuzzy controller again has a strong showing in simulation against the pure pursuit with the RMSE PC of −67.5047% and ME PC of −48.7310% with the CCT PC of 4.02423%. The experimental results are quite a bit larger RMSE PC at −91.6509% and ME PC at −90.41% than the simulation result. The CCT PC is NV/A as the experimental pure pursuit is stopped as it appeared to be in a loop and thus would be unable to compete the course in a timely manner.

In simulation against the CLSF controller, percent changes are −57.8502% for RMSE −44.9476% for ME, and 5.97066% for CCT. The experimental error are smaller with a RMSE PC of −40.2796%, ME PC of −15.4985%, and CCT PC of 9.30635%.

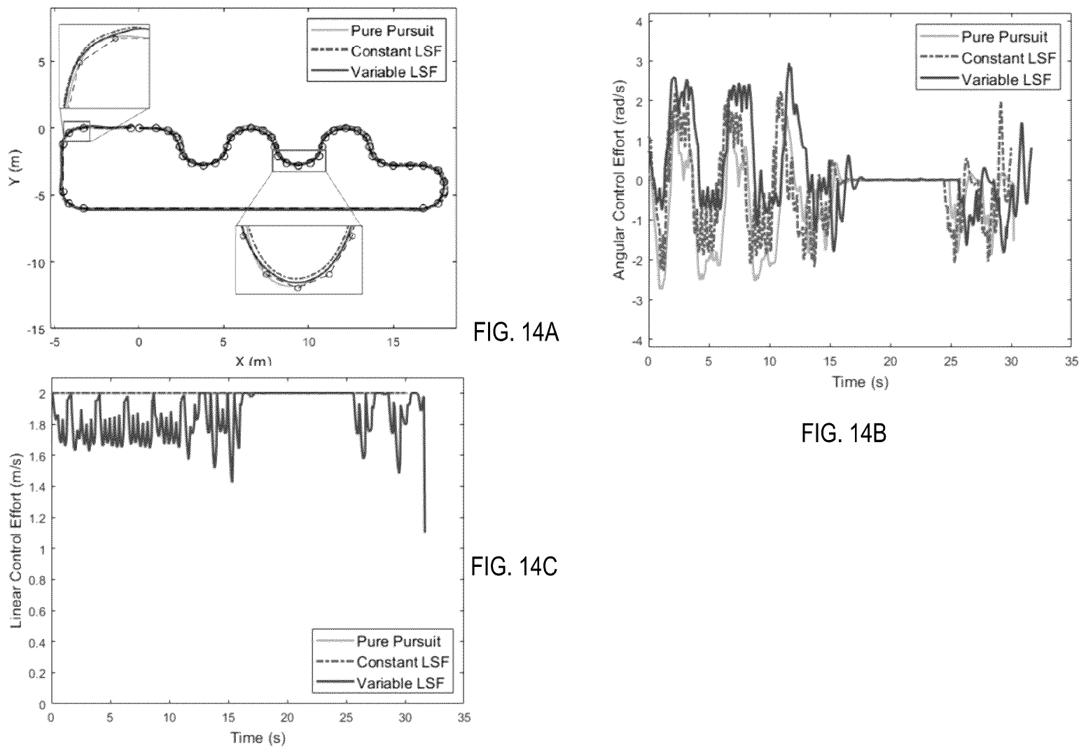

Test Course 4, as shown in FIG. 14A, and as discussed above, is designed to examine both phase lag and overshoot, as well as to examine if the two combine to create instability in the controller.

The associated control efforts can be seen in FIG. 1413 and FIG. 14C with the variable linear speed fuzzy controller outperforming the pure pursuit controller in terms of both phase lag and overshoot.

In terms of metrics, the constant linear speed fuzzy controller again has a strong showing in simulation with the RMSE PC of −77.6632% and ME PC of −58.4265% while the CCT PC is relatively small at 1.24983%. The experimental results yields a smaller RMSE PC at −18.313% than the simulation result. The ME PC is still favorable yet a bit smaller than the simulation at −48.5353% and the CCT PC of 4.70973% remains at a similar small positive value.

The variable linear speed fuzzy controller similarly outperforms the constant linear speed fuzzy controller. In simulation, percent changes are −60.7646% for RMSE −20.0344% for ME, and 3.41368% for CCT. The experimental values are still commendable with a RMSE PC at −38.9212%, ME PC at −36.3311%, and CCT PC at 5.60678%.

For the pure pursuit controller, the phase lag appears to compound linearly on top of the overshoot as compared to the fuzzy controllers. There is a similar degree of overshoot observed between the pure pursuit and CLSF. Although, as seen in FIG. 14B, the VLSF's angular control effort are both lower on turns, 0 s-15 s, and less volatile. In addition, all three controllers remain stable despite the increased stress on the pure pursuit, and both can again be said to perform adequately.

### Adaptive Neuro-Fuzzy Inference System (ANFIS)

A general navigational controller may be configured to generate control signals to a plurality of actuators based on environmental input from a plurality of sensors. Such navigational controllers may be used in applications including but not limited to indoor/outdoor robotics, on-road autonomous vehicles, as well as off-road or worksite autonomous vehicles/machines. For these applications, timely response to environmental variables such as positions, speed, road/site conditions and the like is critical.

Controller design may vary greatly in control logic for vehicles/machines operated/steered under different principles with different response timescales and in different, environment. For example, controller design for skid-steer vehicles with wheels that are fixed in orientations relative to the body of the vehicle and that are steered by controlling skids, as described above, may need to be drastically different from controllers for traditional autonomous directional-steer vehicles.

A navigational controller may be generally viewed as including circuitry that contains hardware, software, firmware, and the like, and the combination thereof for processing a set of dynamic input signals to generate a set of control signals that are used to drive the various actuators associated with, e.g., steering columns, accelerators, brakes, and the like. A navigational controller may be designed as an Machine Learning (ML) controller system embodied as, for example, one or more neural networks (NNs). Each of such NNs may include several layers of neurons having specific connectivity with specific weights, bias, and other parameters. Such NNs are trained to determined a set of NN parameters using iterative parameter adjustment via error calculations and back-propagation based on training datasets and deep learning techniques. However, these types of MIL systems have a critical disadvantage: they are non-explainable. Specifically, the various neural network layers and parameters correspond to features that are extracted through deep learning and represent patterns that are hidden and are generally not human-interpretable. The decision of the neural network in response to a set of input is thus generally non-human-explainable. These types of controllers thus represent black boxes that connect a set of input and a plurality of control outputs. Because the parameters in such systems are non-explainable, their adjustment and improvements must go through a cumbersome and time-consuming training/retraining process.

In some controller applications, it may be desirable to avoid the black box approach to controller design. In other words, it may be desirable that the controller include components/parameters that are explainable and human-interpretable such that they can be easily modified and improved upon. Fuzzy logic controllers (alternatively referred to as fuzzy controllers) are one example type of controllers that are explainable. A fuzzy controller may be embedded with explainable and interpretable linguistic values, parameters, and rule set. It can be explained why and how a fuzzy logic controller makes its decisions. Human can easily understand the system and its decision and thus can modify the various parameters for improvement of the controller.

In some example implementations, a fuzzy logic controller may be implemented as a neural network with well-defined layers such that some of the parameters (such as membership functions of the fuzzy logic) can be optimized by training and yet interpretable and explainable by human. Such combination of Fuzzy logic approach and neural network approach to the controller design, referred to as an Adaptive Neuro-Fuzzy Inference System (ANFIS) are both trainable and explainable.

In the example ANFIS systems further disclosed below, a fuzzy control logic is first generated with reduced rule-base by hierarchically retaining critical rules and removing unimportant rules. The fuzzy logic with reduced rules are then embodied in a neural network. The membership functions of the fuzzy logic in each input domain are modeled as parameterized trapezoidal functions. The membership functions in each input domain are modeled jointly, thereby further reducing the number of membership function parameters. The membership parameters, as part of the model parameters in the neural network is further reduced by taking advantage of the a symmetry property of the membership functions of the fuzzy logic. The resulting ANFIS is trained via reinforcement training using the ANFIS as an actor, thus providing a training process that is adapted to a particular type of vehicle/machine and in a particular operating environment. The training process is significantly simplified and streamlined as a result of the hierarchical rule-base reduction and additional parameter reduction based on membership function symmetry.

Fuzzy Logic Controllers with Hierarchical Rule-Base Reduction

A fuzzy logic replicates the human decision-making methodology and it deals with uncertainty and vagueness of the given information. Using fuzzy logic, a certain system would be able to make a decision based on degrees of output. For example, a computer cannot express how delicious a food is when the information is given using a numerical value. If the information, however, is provided to the fuzzy system, it is able to determine the degree of taste of the food based on the information with a numerical value between 0 and 1. This fuzzy logic reduces uncertainty for a computer when making a decision so that it can make a choice for a given situation/fact just like a human operator. A fussy logic system may be alternatively referred to a fuzzy interference system.

Such fuzzy logic may be applied in a navigational controller. Given the circumstances, for example, a fuzzy controller can determine how much it should make a turn to control a maneuver of the vehicle so that the fuzzy controller decreases the uncertainty of the decision for steering of a vehicle. This shows that one of the positive characteristics of a fuzzy system: applicability to nonlinear systems with uncertainty models. Another characteristic of the fuzzy system is it uses a linguistic common sense rule base, which make it human-interpretable and explainable.

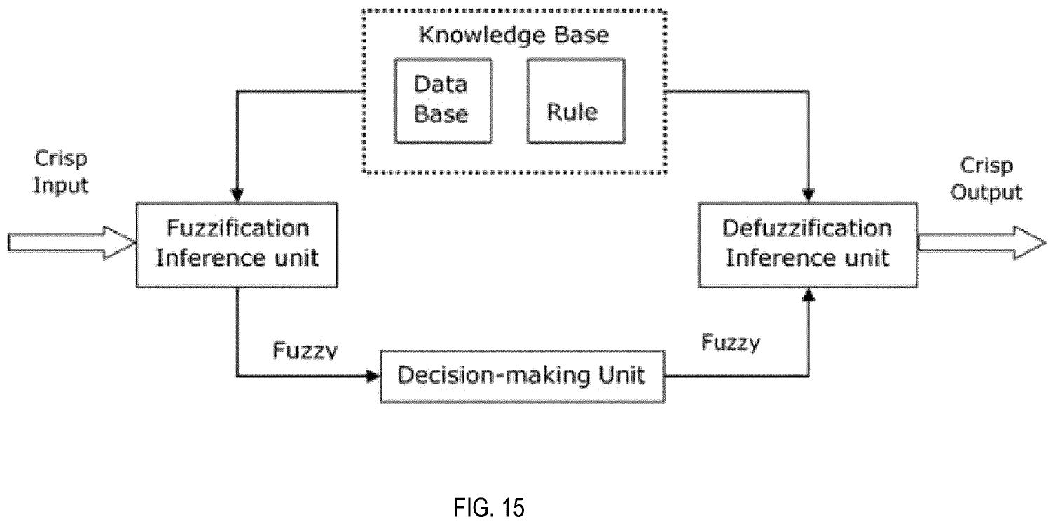

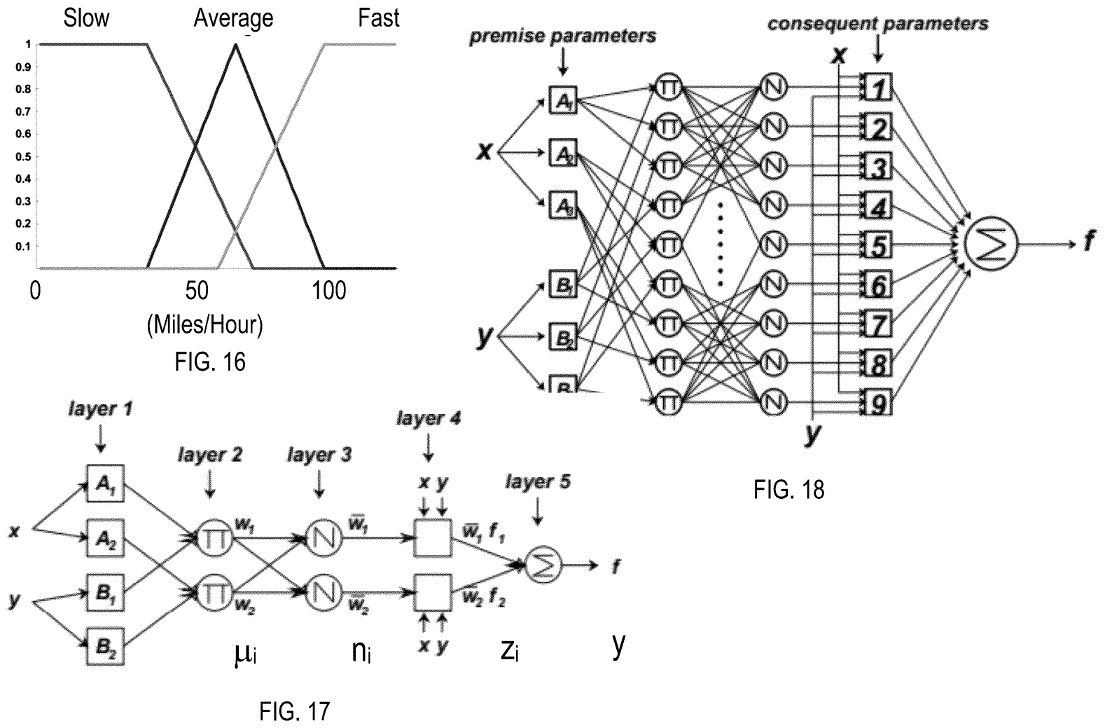

An example fuzzy logic may include five functional parts: rule base, database, fuzzification, decision-making, and defuzzification, as shown in FIG. 15. Input to the fuzzy logic may form various quantifiable domains (e.g., measurements from sensors), referred to as variables, such as speed measurement of the vehicle being controlled. A linguistic variable may be alternatively referred to as linguistic descriptor. Various linguistic values may be established in relation to a particularly variable. For example, a variable may be velocity measurement of the vehicle in miles per hour. A linguistic variable thus may be “speed” for linguistically describing how rapidly the vehicle is moving. A measured speed may be an input to the fuzzy logic. The linguistic variable “speed” may include a number of linguistic values, such as “fast” “medium”, and “slow”, each defined with a membership function in the domain of the variable “speed” as shown in FIG. 16. The membership functions numerically turn the input measurement of the a variable into numerical descriptions of the corresponding linguistic values. This step may be referred to as fuzzification. Membership functions of a linguistic values may be established in various shapes, such as Gaussian, trapezoid, triangle, sigmoid differences, etc.

As described above, the rule-set or rule-base of a fuzzy logic system or fuzzy inference systems may be established involving linguistic variables and their linguistic values. The rule set or rule base may include a plurality of if-then rules. Fuzzy if-then rules may be expressed in the form of:
IF A AND/OR B THEN O

The notations A and B are labels inside fuzzy sets attributed to a logic decisions of specific membership functions. For example:
IF rain is heavy AND speedlimit is high
   THEN velocity=low

In this example, the entities referred to as rain, speedlimit, and velocity are linguistic variables or descriptors, whereas heavy, high, and low are linguistic values of the linguistic variables defined through corresponding membership functions. In other words, numerical description of a linguistic value depends on the corresponding domain or variable and such dependency defines the linguistic value's membership functions. For example, the numerical description of the linguistic values' “high” or “low” for the linguistic variable “speed limit” may be a function of a quantified variable speed limit in, for example, number of miles per hour and may be normalized between numerical description of 0 and 1.

An example fuzzy inference system often performs the following four steps.
1. From a crisp input, numerically compute the membership level or values in each linguistic value of input variables. This step is often referred to as a fuzzification step.
2. Compute the firing strength of each rule through the combination of the membership values for the inputs. The combination operator may be implemented through a T-Norm operation. This step represents evaluating the example rule combination of “rain is heavy AND speedlimit is high” above in the rule base.
3. The output of each rule is then associated with the corresponding consequent linguistic variable and its value. This represents the “IF . . . THEN set velocity to low” operation in the rule base.
4. Finally, the outputs of the rules are aggregated to produce a crisp output. This step may be referred to as defuzzification.

In a fuzzy system, the inputs are fuzzified by the membership functions of the fuzzy system which generates defuzzified output. One of the problems with a fuzzy system is that the number of rules is exponentially increased depending on the number of inputs and membership functions. If there are x input and y membership functions for each input, a full combination of the rules will be x^{y}. For example, if there are 5 inputs and 5 membership functions, the number of the rules will be 5⁵=3125. The more inputs and membership functions in the fuzzy system, the more rules rule base would contain. This makes the fuzzy system computationally expensive and difficult to understand for a human operator. However, the fuzzy system for an navigational system such as an autonomous vehicle/machine does not need all of the rules to control the vehicle. A fussy relations control strategy (FRCS) may be used for a hierarchical rule-based reduction for the fuzzy vehicle controller to exponentially reduce the number of the rules. For example, once the hierarchical rule-base reduction is applied to the fuzzy system with 3 inputs and 5 membership functions, the number of the rules can be decreased, for example, from 3⁵=243 to 25. This technique makes the behavior of the controller as simple as possible and reduces the computation time. This is important because it decreases many parameters in the fuzzy system, so the computational time during training will be dramatically decreased. The rules are common sense and essentially fixed which reduces the size of the resulting ANFIS networks, and reduces the computational effort and the number of training epochs.

For example, relevant controller linguistic values, Fuzzy Relations Control Variables (FRCVs), and outputs may first be established. Then, the FRCS determines the most globally influential FRCVs and by placing the FRCVs in a hierarchy of influence. This hierarchy may be used to divide the operating environment of the vehicle into distinct regions or spaces (or branches) of operation. The relations in the hierarchy/regions may then be used to inform a selection of the rules most influential on state errors. This entire top-down process resulted in a Hierarchical Rule-Base Reduction (HRBR).

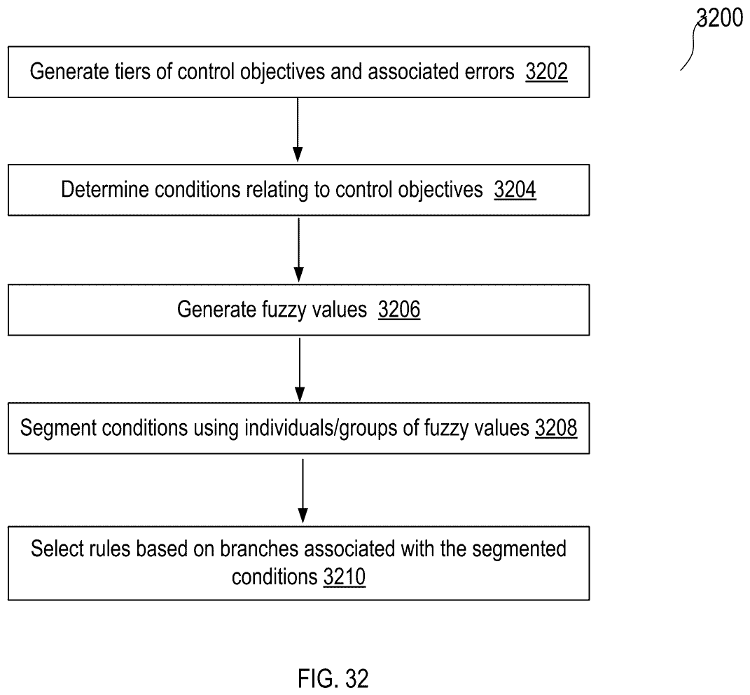

As such, the HRBR represents a generic strategy for reducing the size of a fuzzy logic rule-base. The reduction of the rule-base follows directly from model and FRCV generation, with example steps illustrated in the data and logic flow 3200 of FIG. 32, which includes example steps of: Step 3202 for generating tiers of control objectives and associated errors; Step 3204 for determining conditions relating to control objectives; Step 3206 for generating fuzzy values; Step 3208 for segmenting conditions using individuals/groups of fuzzy values; and Step 3210 for selecting rules based on branches associated with the segmented conditions.

In some example implementations for generating tiers of control objectives and error functions in Step 3202 of FIG. 32, errors may follow directly from system objectives. For example, one of the chief priorities of the path tracking controller in a navigational control system may be completing each path segment. As such, one important error may be the distance to the target point for the current path segment. In some example implementations, correcting the distance error thus may be considered as a primary control objective. From there secondary control objectives may be further identified. For the fuzzy controller relevant to controlling the example vehicles or robots, these secondary control objectives may include matching a relative angle of the vehicle to a current path segment (heading into the path) and reducing a distance to the path. The errors for the relative angle to the current path segment and distance to the path segments may be determined. In some example implementations, tertiary controller objectives may follow. For example, such tertiary control objectives may include but are not limited to a recovery of vehicle in the case that it has strayed from the path. Such recovery objective may include transitioning the vehicle's heading to the next path segment. The associated errors for such an example tertiary control objective may be an misalignment between a relative heading of the vehicle to some recovery point on the path segment and the relative heading to the next segment.

Further example for HRBR can be find in U.S. Provisional Patent Application No. 63/529,967 entitled “HIERARCHICAL FUZZY CONTROLLER WITH MULTIPLE CONTROL OUTPUT, filed by the same Applicant on Jul. 31, 2023, which is herein incorporated by reference in its entirety.

### Adaptive Neuro-Fuzzy Inference System (ANFIS)

### Overview:

Various parameters involved in a fuzzy logic controller with HRBR, including but not limited to the parameters for defining the various membership functions and the weights among the various rules in the rule-base may be determined in various manners. But once these parameters are determined for a particular application (e.g., a particular type of vehicle/machines operating in a particular environment), they are not easily transferable to other applications even if the same membership function scheme can be used. As such, a new set of parameters for the membership functions may need to be determined. In other words, a fuzzy logic controller, by itself, is not very adaptable from application to application.

In some example implementations, a fuzzy logic may be embodied as an adaptive neural network to provide the adaptability that is missing in a traditional fuzzy logic controller. Such a system may be referred to as an Adaptive Neuro-Fizzy Inference System (ANFIS). An ANFIS embeds a fuzzy logic controller in a neural network by combining the power of trainability and adaptability of neural networks in model parameter optimization (e.g., parameters associated with membership functions) and the explainability of linguistics in fuzzy logic, thereby rendering a neural network system that is less of a black box and is yet adaptable between applications/environments.

Some example implementations of neural network, adaptability may be provided based on new information by training the various parameters using the errors from supervised or unsupervised learning. For example, if someone wants to train the neural network to control the amount of water in a water tank and have it depend on various situations, a large number of input and output data covering the various situations are required to train the neural network under supervised learning. The training would involve the neural networks taking the collected inputs and predict the outputs, then calculate the errors between the predicted outputs and the desired outputs corresponding to the inputs. The errors are then back-propagated through the neural networks to update the weight in the various neural network layers. As such, when a neural network starts learning, it takes an initial guess with random outputs; and errors will be calculated between random outputs calculated by ANN and desired outputs. The error will then be back-propagated through the neural network to adjust the parameters. This process will gradually converge to an adapted set of parameters to decrease the errors.

An ANFIS, for example, may include a model structured similarly to a fully connected neural network to emulate a fuzzy logic controller. While structured to perform the functions of the fuzzy logic controller, thus preserving the interpretability and explainability advantages, the combined model may be designed to enable a tuning of its parameters through dynamic back-propagation. Specifically, a fuzzy controller developed as a deliverable can be translated into an ANFIS system and converted back to a linguistically based fuzzy system.

In one example conversion of a fuzzy logic system into an ANFIS, the fuzzy logic may be represented in the neural network as a number of (e.g., five) sequential neurological layers, each representing a step in the fuzzy logic controller (or fuzzy logic inference system) described above, except that. Layers 2 and 3 of the neural network jointly represent step 2 of the fuzzy logic controller above. Such an example ANFIS is shown in FIG. 17.

Layer 1. In Layer 1, as shown in FIG. 17, the fuzzification of each of the crisp inputs x̅, y̅ϵ [symbol] (e.g., velocity measurement, temperature measurement) may be performed through the use of, for example, one or more generally trapezoidal membership functions, μ_{k,p}, with each membership function being 0 for all input values not included in its trapezoidal section. For the membership functions, k specifies the associated linguistic descriptors (e.g., “speed”) and p the given linguistic value (e.g., a “fast” value, a “medium” value, a “slow” value, etc.). The value of the function represents numerical value as a function of the domain x̅ and/or y̅, between, for example a normalized range of [0,1].

$${μ}_{k , p} = {trapezoid}_{k , p} ( x ) \qquad ( 40 )$$

wherein the trapezoid function merely represents one example of the shape of this example membership function. Layer 1 may be alternatively referred to as premise layer.

Layer 2. Layer 2 represents the weights of the outputs of the fuzzy logic rules. For a given rule, i, a combination of the chosen input membership functions, μₖ_{₁}_{,p}_{₁}, μₖ_{₂}_{,p}_{₂}, determine the output membership function firing rate, μᵢ. A product T-Norm combines the input membership functions and facilitates the gradient computation.

$${μ}_{i} = {μ}_{{k}_{1} , {p}_{1}} * {μ}_{{k}_{2} , {p}_{2}} \qquad ( 41 )$$

Layer 3. Layer 3 represents a normalization layer, where the output membership function firing rates are normalized (where r represents a number of member functions).

$${n}_{i} = \frac{{μ}_{i}}{{\sum }_{i = 1}^{r} {μ}_{i}} \qquad ( 42 )$$

Layer 4. Layer 4 represented the consequent portion of the network. Using an example triangle output membership functions and the Center-of-Maximum defuzzification implementation, the output for each rule may be simply a scalar product of the peak of its associated output membership function and normalized firing rate.

$${z}_{i} = {triangle}_{{O}_{i}} * {n}_{i} \qquad ( 43 )$$

Layer 5. Layer 5 is where these weighted rule outputs may be combined into a crisp output.

$$y = {\sum }_{i = 1}^{r} {z}_{i} \qquad ( 44 )$$

Layer 5 may be alternately referred to as consequential layer.

FIG. 18 shows another ANFIS structure with more parameters. There may be membership functions in the premise layer and output control functions (represented by “consequential parameters”) in the consequent layer. The ANFIS of FIG. 18 and FIG. 17 compute the errors from its last layer and the errors are backpropagated to tune parameters in the premise and consequent layers.

The above layers of the ANFIS thus form an neural network embedding the fuzzy logic and may be trained (with respect to input and output membership functions, for example) and used to process one or more inputs to generate one or more control outputs.

For example, in premise layer, each premise parameter can be written as:

$$p ( t + 1 ) = p ( t ) - α \frac{\partial E}{\partial p} \qquad ( 45 )$$

where p=parameter to be tined; α=learning rate; and E=error to be back-propagated.

Then, the partial derivatives are:

$$E = \frac{1}{2} ( y - {y}^{′} ) , \qquad ( 46 )$$

$$\frac{\partial E}{\partial y} = y - {y}^{′}$$

$$\frac{\partial E}{\partial {p}_{ij}} = \frac{\partial E}{\partial f} * \frac{\partial E}{\partial {w}_{ij}} * \frac{\partial {w}_{ij}}{\partial {u}_{ij}} * \frac{\partial {u}_{ij}}{\partial {p}_{ij}} \qquad ( 47 )$$

where u=numerical description of the linguistic value.

### Input Membership Function

The disclosure below provide example implementations of membership functions with characteristics that allows for unique and efficient training of the ANFIS.

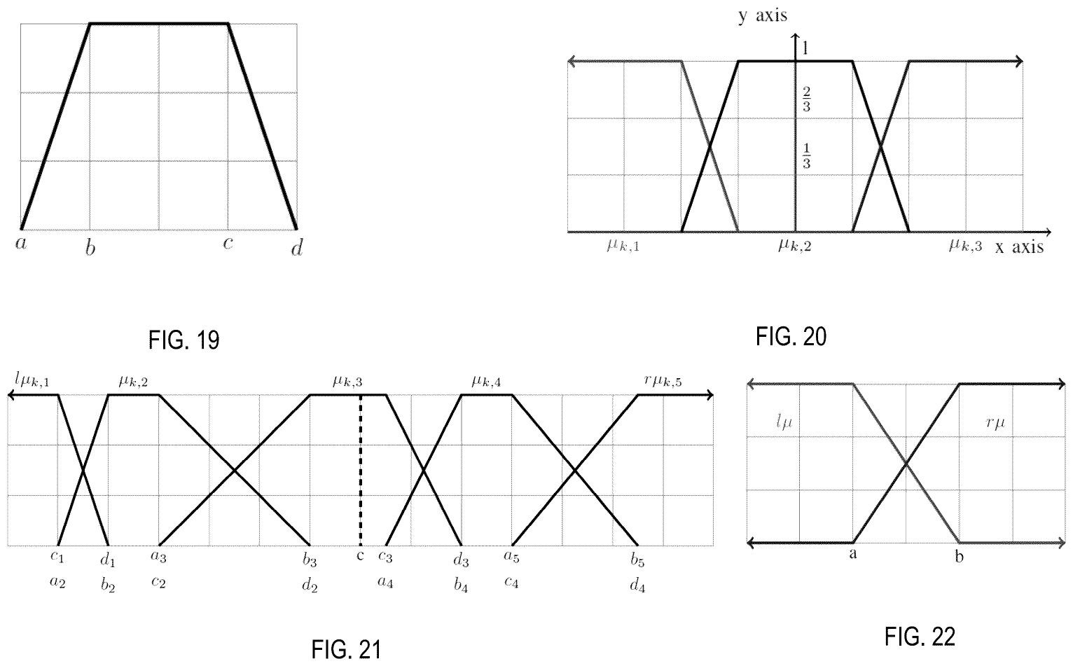

Classical Trapezoid. FIG. 19 illustrates an example classical trapezoid membership function. In FIG. 19, a trapezoid may be defined using four parameters a, b, c, d. These parameters may define the totality of the membership function. In turn, this function may be linear and piece-wise continuous:

$$trapezoid ( x ) = μ ( x ) = \{ \begin{matrix}0 & if x < a \\ \frac{x - a}{b - a} & if a \leq x < b \\ 1 & if b \leq x < c \\ \frac{x - d}{c - d} & if c \leq x < d \\ 0 & if x \geq d\end{matrix} \qquad ( 48 )$$

The parameters a, b, c, d may be assumed to follow the following constraints in FIG. 19 such that a, b, c, dϵ [symbol] .

$$a \leq b \leq c \leq d \qquad ( 49 )$$

Following the function definition, the partial derivatives of the system concerning a, b, c, d may be defined:

$$Case ( x < a ) ⋃ ( b \leq x < c ) ⋃ ( x \geq d ) \qquad ( 50 )$$

$$\frac{\partial μ}{\partial a} = \frac{\partial μ}{\partial b} = \frac{\partial μ}{\partial c} = \frac{\partial μ}{\partial d} = 0$$

$$Case a \leq x < b \qquad ( 51 )$$

$$\frac{\partial μ}{\partial a} = \frac{x - b}{{( a - b )}^{2}} ,$$

$$\frac{\partial μ}{\partial b} = \frac{a - x}{{( a - b )}^{2}} ,$$

$$\frac{\partial μ}{\partial c} = \frac{\partial μ}{\partial d} = 0$$

$$Case c \leq x < d \qquad ( 52 )$$

$$\frac{\partial μ}{\partial a} = \frac{\partial μ}{\partial b} = 0 ,$$

$$\frac{\partial μ}{\partial c} = \frac{d - x}{{( c - d )}^{2}} ,$$

$$\frac{\partial μ}{\partial d} = \frac{x - c}{{( c - d )}^{2}}$$

Trapezoid membership functions may be used to mitigate “bang-bang” problem. Specifically, in control systems, “bang-bang” refers to rapidly switching between two extreme values in response to noisy or fluctuating input signals. This behavior can cause high-frequency outputs that can harm the system, leading to malfunctions due to oscillations and generating less smooth results. Trapezoidal membership functions are sometimes used instead of other membership functions in fuzzy logic systems to mitigate this issue. As shown in FIG. 19, trapezoidal functions have flat regions that provide a margin of acceptable error in the input, especially around the zero error region, which can reduce the effect of noisy inputs and improve overall system stability. Using trapezoids also allows for some of the desirable traits of function of other shapes, such as a Gaussian function to be captured computationally efficiently. This can lead to better performance and more accurate results while minimizing the potential adverse effects of bang-bang behavior on the system.

Joint Membership Functions-Constraints. In some implementations, joint membership functions of various linguistic values over a domain may be used. An example constraint may be imposed on the system such that the sum of all the numerical descriptions of the membership functions is equal to one (or any other predefined normalized value) at every point in each linguistic domain point, as shown by the three-linguistic-value joint trapezoid functions in FIG. 20 and the five-linguistic-value joint trapezoid functions in FIG. 21 (all membership functions shown in FIG. 20 and FIG. 21 are considered as falling in a general category of trapezoid functions). As such:

$${\sum }_{i = 1}^{pk} {μ}_{k , {p}_{i}} ( x ) = 1 , \qquad ( 53 )$$

$$∀ k , x$$

Through such a constraint, the membership function parameters a, b, c, d for each trapezoid depended on some other trapezoids. The boundary trapezoids are defined as single-sided functions as shown in FIG. 22:

$$l μ ( x ) = \{ \begin{matrix}1 & if x < c \\ \frac{x - d}{c - d} & if c \leq x < d \\ 0 & if x \geq d\end{matrix} \qquad ( 54 )$$

$$r μ ( x ) = \{ \begin{matrix}0 & if x < a \\ \frac{x - a}{b - a} & if a \leq x < b \\ 1 & if x \geq b\end{matrix} \qquad ( 55 )$$

The trapezoid function parameters may thus be defined relative to each other i=1, 2, . . . , pₖ ∀k in a joint manner:

$${c}_{i} = {a}_{i + 1} , \qquad ( 56 )$$

$${d}_{i} = {b}_{i + 1}$$

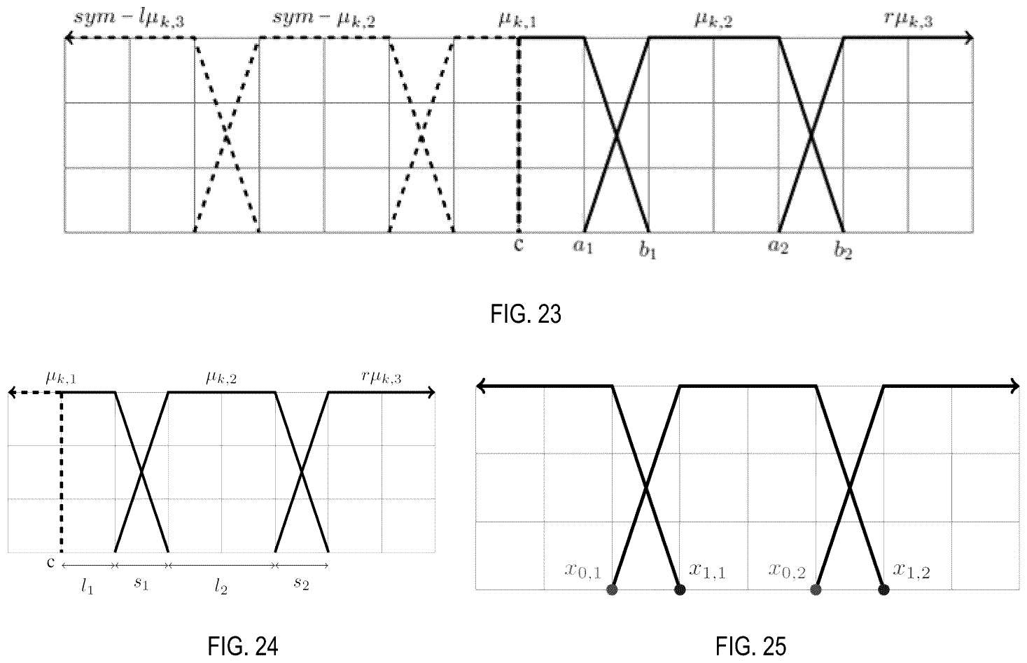

The variable pₖ may be defined as the number of membership functions or linguistic values with respect to an input domain k. This constraint 53 helped to reduce the parameter set size from 4(pₖ−1) to 2(pₖ−1) for the input domain k. The parameter set size may be further reduced by assuming that the system is symmetric along input domain axis c and then only defining the membership functions on one side of the axis, as shown in FIG. 23. For example, the symmetry constraint further reduces the parameter set to a size pₖ. For all these scenarios, it may be assumed that pₖ≥2; otherwise, the membership function would be defined as μ(x)=1, ∀x, which is a trivial function indicating an unnecessary linguistic value. In the example of FIG. 23, the five membership functions are symmetric around “c” in the domain represented by the x axis. The three middle trapezoid functions are associated with 12 parameters (four for each trapezoid function), The two side trapezoid functions are each associated with two parameters. Because of the constrain above with respect to joint trapezoid functions and the symmetry, the number of total parameters reduces to 5. shown as c, a₁, b₁ a₂, and b₂ in FIG. 23.

Thus, the reduced membership function parameters aₙ, bₙ, and c are defined as coordinates on the domain x-axis. However, to further introduce the constraint c≤a₁≤b₁≤ . . . ≤aₙ≤bₙ into the system, a redefinition of the trapezoid function parameters may be implemented. For example, the parameters may instead be redefined as widths between key points, as shown FIG. 24 for the example of FIG. 23, where for the example 5 constrained joint membership functions, the 5 parameters c, a₁, a₂, a₃ may be redefined as lₙ and sₙ, representing the width of the flat portions and the slopy portions of the trapezoids, respectively. This parameter redefinition may allow the system to occupy the same size p parameter set (in this example, the size is 2 for each of the flat and slop parameter set).

As such, through the redefinition of the parameter set, the c≤a₁<b₁< . . . <aₙ≤bₙ constraint becomes:

$$c \leq {a}_{1} \leq {b}_{1} \leq … \leq {a}_{n} \leq {b}_{n} \qquad ( 57 )$$

$$c \leq c + {l}_{1} \leq c + {l}_{1} + {s}_{1} \leq … \leq c + \sum {l}_{i} + \sum {s}_{i}$$

The constraint thus follows a non-negative restriction and a cumulative sum relationship. As such, constraining the trapezoid shape may become computationally efficient.

Trapezoid Computation The trapezoid computation below, the parameter set may be defined as {w, c}:

$$w = \{ \begin{matrix}{[ \begin{matrix}{l}_{1} & {s}_{1} & {l}_{2} & {s}_{2} & … & {l}_{n} & {s}_{n}\end{matrix} ]}^{T} & if {p}_{k} is odd \\ {[ \begin{matrix}{s}_{1} & {l}_{2} & {s}_{2} & {l}_{3} & … & {l}_{n} & {s}_{n}\end{matrix} ]}^{T} & if {p}_{k} is even\end{matrix} \qquad ( 58 )$$

With the size of dim(w)=p−1. To enforce non-negativity, the system may be subjected to an element-wise squaring of w, as shown in Equation (60), by using a Hadamard power:

$$B = {A}^{◦2} ⇒ {B}_{ij} = {A}_{ij}^{2} \qquad ( 59 )$$

The cumulative sum of the elements in w, may be used to compute the new set of non-negative key points representing trapezoid functions.

$${w}_{s} = {w}^{◦2} \qquad ( 60 )$$

$${t}_{c} = {[ \begin{matrix}{t}_{c , 1} & … & {t}_{c , ( p - 1 )}\end{matrix} ]}^{T} \qquad ( 61 )$$

$${t}_{ci} = {\sum }_{j = 1}^{i} {( {w}_{s} )}_{j}$$

$$for$$

$$i ϵ \{ 1 , 2 , … , p - 1 \}$$

The cumulative sum operation may be represented as a lower triangular matrix C such that C_{i,j}=1 if j≤i, Cϵ [symbol] ^{p-1>p-1}.

$${t}_{c} = {Cw}_{s} \qquad ( 62 )$$

To define the symmetrical output, the reflection operator matrix R may be calculated as Rϵ [symbol] ^{2(p-1)×(p-1)}, i, jϵ{1, 2, . . . , p−1}:

$${R}_{i , j} = \{ \begin{matrix}- 1 & if j = p - i \\ 1 & if j = ( p - 1 ) + i \\ 0 & else\end{matrix} \qquad ( 63 )$$

$$R = {[ \begin{matrix} & & - 1 & 1 & & \\ & - 1 & & & 1 & \\ - 1 & & & & & 1\end{matrix} ]}^{T}$$

$$r = {[ \begin{matrix}- {t}_{c , p - 1} & … & - {t}_{c , 1} & {t}_{c , 1} & … & {t}_{c , p - 1}\end{matrix} ]}^{T} \qquad ( 64 )$$

$$r = {Rt}_{c}$$

The vector r may be reduced to r=RCwₛ=Mwₛ, where Mϵ [symbol] ^{2(p-1)×p-1}. Once the reflected vector is calculated, the vector may be shifted to be symmetric around c.

$${r}_{c} = c + r \qquad ( 65 )$$

Following the definition of the vector r_{c}, the vector may be divided into two sub-vectors. These sub-vectors may represent coordinates associated with the sloped regions of the trapezoids, with x₀ and x₁ being associated with coordinates for the left and right, sides of the sloped regions, respectively, iϵ{1, . . . , p−1}, X₀, X₁ϵ [symbol] ^{(p-1)×2(p-1)}.

$${x}_{0 , i} = {r}_{c , k} , k = 2 i - 1 \qquad ( 66 )$$

$${x}_{1 , i} = {r}_{c , k} , k = 2 i \qquad ( 67 )$$

$$or$$

$${x}_{0} = {X}_{0} {r}_{c} , {x}_{1} = {X}_{1} {r}_{c} \qquad ( 68 )$$

$${X}_{{0}_{i , k}} = 1 , k = 2 i - 1$$

$${X}_{{1}_{i , k}} = 1 , k = 2 i$$

where X₀_{_{i,k}}, X₁_{_{i,k}}=0 otherwise. A graphical representation of the x₀, x₁ coordinate subset is demonstrated in FIG. 25.

The Hadamard division, Ø, (element-wise vector division) may be annotated below as:

$$C = A B {C}_{ij} = \frac{{A}_{ij}}{{B}_{ij}} \qquad ( 69 )$$

From the vector subsets x₀ and x₁, sᵤₚ may define the sloped regions, such that the scalar x is broadcasted to become a vector x∈ [symbol] ^{p-1×1}.

$$\begin{matrix}{s}_{up} ( x ) & = & ( x - {x}_{0} ) ( {x}_{1} - {x}_{0} ) & ( 70 ) \\ & = & ( x - {X}_{0} {r}_{c} ) ( {X}_{1} {r}_{c} - {X}_{0} {r}_{c} ) & \\ & = & ( x - {X}_{0} {r}_{c} ) ( ( {X}_{1} - {X}_{0} ) {r}_{c} ) & ( 71 )\end{matrix}$$

If r_{c} is zero, a division by zero error may arise, so an ϵ may be added to the r_{c} component, r_{c}→r_{c}+ϵ. Following the creation of the linear region, clamping may be used to define the regions of zero slope. As a result, scᵤₚ(x) may represent the increasing sides of the trapezoids and sc_{down}(x) may represent the decreasing sides of the trapezoids. These sides may be bounded such that, scᵤₚ(x), sc_{down}(x)ϵ[0,1] with dimensions [symbol] ^{p-1×1} and:

$${sc}_{up} ( x ) = max \{ \vec{0} , min \{ \vec{1} , {s}_{up} ( x ) \} \} \qquad ( 72 )$$

$${sc}_{down} ( x ) = \vec{1} , {s}_{up} ( x ) \qquad ( 73 )$$

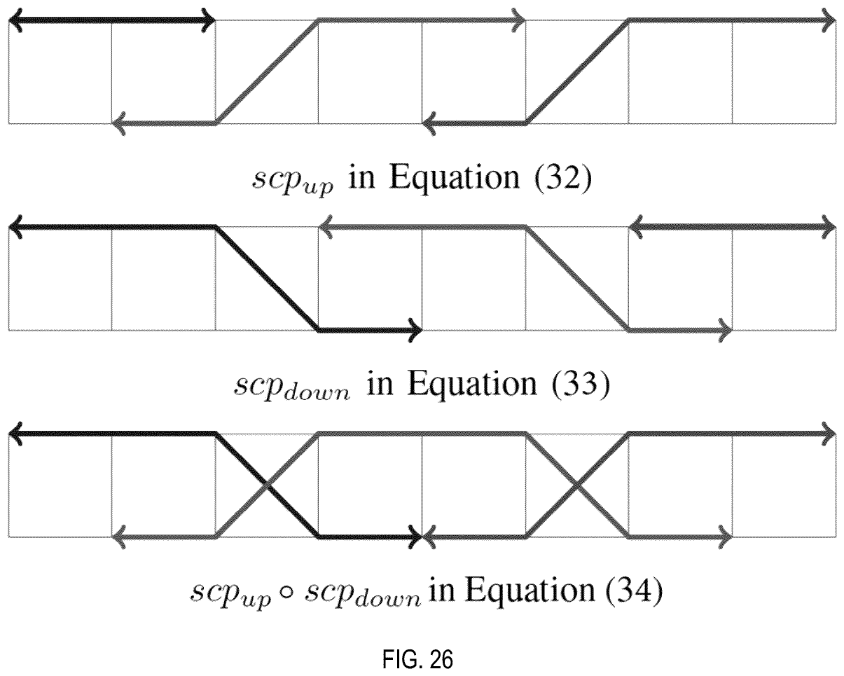

Finally, the vectors, scpᵤₚ(x), scp_{down}(x)ϵ [symbol] ^{p×1}, may be padded and combined using Hadamard product. (C=A∘B→C_{i,j}=A_{i,j}B_{i,j}) to produce the final trapezoid outputs, as illustrated in FIG. 26:

$${scp}_{up} ( x ) = [ \begin{matrix}1 & {sc}_{up} ( x ) ]\end{matrix} \qquad ( 74 )$$

$${scp}_{down} ( x ) = [ \begin{matrix}\begin{matrix}{sc}_{down} ( x ) & 1\end{matrix} ]\end{matrix} \qquad ( 75 )$$

$$trapezoid ( x ) = {scp}_{up} ( x ) \cdot {scp}_{down} ( x ) \qquad ( 76 )$$

Single Sided Constraint. The single sided membership function assumed that the domain of the linguistic value is restricted to a single direction i.e. [c, ∞). To satisfy this constraint, the function may be restricted from using the reflection operator in Equation (64).

Closed Domain Constraint In some previous implementations of the linguistic value's joint membership functions assumed that the domain for the variable is (−∞, ∞) in [symbol] . These linguistic values may represent, for example, velocity or signed perpendicular distance to a line. However, some problems are bounded to [a, b]. These linguistic values may represent headings of a robot, which are bounded to [−π, π]. In the example implementations below, the linguistic value's membership functions are constrained within the symmetrical domain of [a, b]=[c−L, c+L]. The primary constraint on the system may involve restricting the cumulative sum of the widths not to exceed distance L. A normalization step may be performed on the squared width vector wₛ, iϵ{1, . . . , pₖ} from Equation (60).

$${w}_{s , i} = \frac{{w}_{i}^{2}}{{\sum }_{i = 1}^{p} {w}_{i}^{2}} L \qquad ( 77 )$$

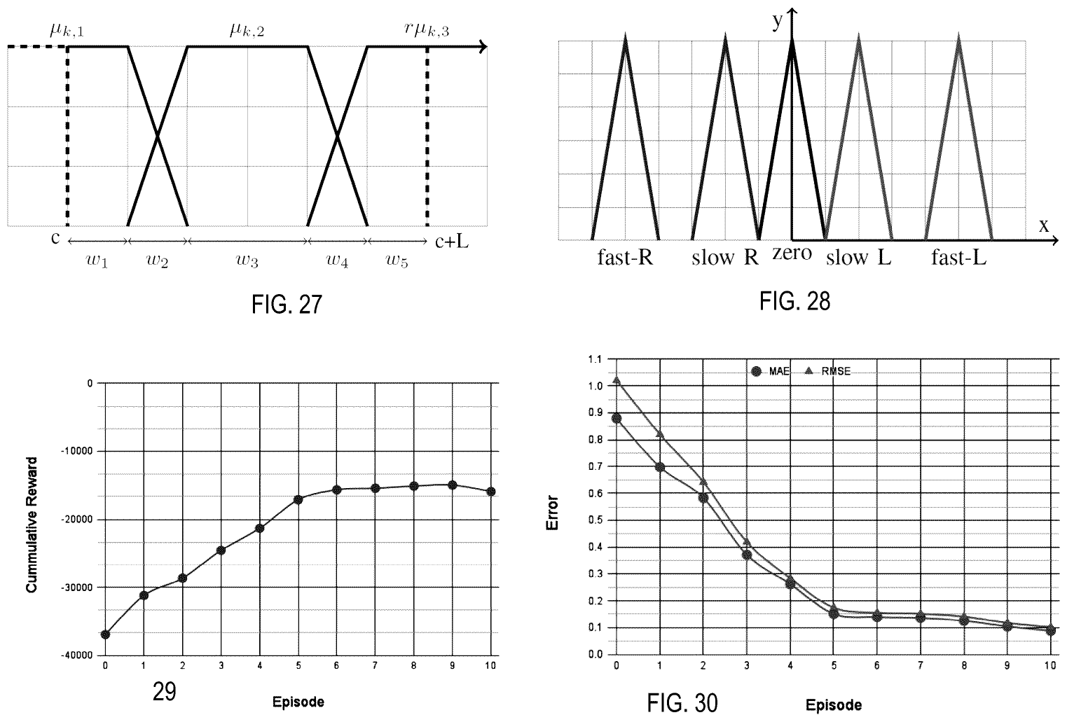

This constraint introduces an additional width variable wₚ_{ₖ}, as seen in FIG. 27, as w₅. However, only the iϵ{1, . . . , p−1} weights may be needed to compute the trapezoid functions following the aforementioned steps. The contribution wₚ_{ₖ} may be provided to act as a normalization constant to

$${\sum }_{i = 1}^{p} {w}_{i}^{2} .$$

It may also be trained when computed in the gradients.

### ANFIS Model Optimization

### Overview

As described above, an example ANFIS implementation may be defined as comprising five different layers defined in Equations (40), (41), (42), (43), and (44). The example implementations below reduce the ANFIS system of equations into a more compact model. The compact model may follow a similar structure to the Takagi-Sugeno fuzzy inference system architecture and the like. The implementations below of the ANFIS model exemplarily follow a Mamdani rule set approach to the rule-base formulation.

### Defuzzification and Output Aggregation Combination

As described above, triangle_{O}_{ᵢ} may represent a triangular output membership function associated with rule i. nᵢ may be a normalized output weight for rule i. r may represent the total number of rules.

Following those definitions, Equation (44) may be redefined as a linear operator to improve computational efficiency. The matrix P may be a set of trainable weights representing the triangular output membership functions through a Center-of-Mass representation, such that Pϵ [symbol] ^{1×n}, Qϵ [symbol] ^{n×r}, Nϵ [symbol] ^{r×1}.

$$\begin{matrix}y & = & {\sum }_{i = 1}^{r} ( {triangle}_{{O}_{i}} * {n}_{i} ) & ( 78 ) \\ & = & [ \begin{matrix}{triangle}_{{O}_{1}} & … & {triangle}_{{O}_{n}} ] [ \begin{matrix}↑ & & ↑ \\ {e}_{1} & … & {e}_{r} \\ ↓ & & ↓\end{matrix} ]\end{matrix} [ \begin{matrix}{n}_{1} \\ ⋮ \\ {n}_{r}\end{matrix} ] & ( 79 ) \\ & = & PQN & ( 80 )\end{matrix}$$

where eᵢ is a unit vector representing which output, Oₙ, each rule, r, may be associated with, such that eᵢϵ{0,1} and eᵢ^{T}eᵢ=1.

$${e}_{i} = {[ \begin{matrix}0 & … & 1 & … & 0\end{matrix} ]}^{T} \qquad ( 81 )$$

### Normalization Expansion

The vector W may be used represent the output of each rule given as the output of the fuzzification operation, e.g., the product T-norm.

$$W = {[ \begin{matrix}{w}_{1} & \begin{matrix}… & {w}_{r}\end{matrix}\end{matrix} ]}^{T} \qquad ( 82 )$$

$$N = [ \begin{matrix}{n}_{1} \\ ⋮ \\ {n}_{r}\end{matrix} ] = [ \begin{matrix}\text{?} \\ ⋮ \\ \text{?}\end{matrix} ] = \frac{1}{{\sum }_{i = 1}^{r} {w}_{i}} [ \begin{matrix}{w}_{1} \\ ⋮ \\ {w}_{r}\end{matrix} ] = \frac{1}{{\sum }_{i = 1}^{r} {w}_{i}} W \qquad ( 83 )$$

$$\begin{matrix}y & = & PQN & ( 84 ) \\ & = & PQ ( \frac{1}{{\sum }_{i = 1}^{r} {w}_{i}} W ) & ( 85 ) \\ & = & \frac{1}{{\sum }_{i = 1}^{r} {w}_{i}} PQW & ( 86 )\end{matrix}$$

$$\text{?} \text{indicates text missing or illegible when filed}$$

Given that wᵢϵ[0,1], thus

$${w}_{i} \geq 0 , {\sum }_{i = 1}^{r} {w}_{i}$$

may be rewritten as

$${‖ W ‖}_{1} = {\sum }_{i = 1}^{r} \vert {w}_{i} \vert .$$

The final step may involve the redefinition of the antecedent layer.

### Antecedent Compression

The product T-Norm (x*y) may be used to compute the antecedents. Vector T contained the firing rates for each of the input membership functions μ_{k,p} over all the k linguistic values and their pₖ number of associated numerical descriptions. In total,

$$f = {\sum }_{i}^{k} {p}_{i} .$$

The function A(·): [symbol] ^{f×1}→ [symbol] ^{r×1} may map the f input membership functions to the r rule outputs. As such, aᵢ=Tₐ* . . . *T_{q}, may represent the specific rule: IF Tₐ AND T_{b} AND . . . AND T_{q}. In turn, the ANFIS may be represented as:

$$W = A ( T ) \qquad ( 87 )$$

$$y = \frac{1}{{‖ A ( T ) ‖}_{1}} PQA ( T ) \qquad ( 88 )$$

### Batch Input

The previous notation for the reduced ANFIS system represented single input, single output notation. However, the system may account for batched inputs. b may be the batch index x̅ϵ [symbol] ^{b×k}, T(x̅)ϵ [symbol] ^{f×1}, [symbol] (x̅)ϵ [symbol] ^{r×b}, [symbol] (x̅)ϵ [symbol] ^{1×b}.

$$𝒯 ( \overline{x} ) = [ \begin{matrix}↑ & & ↑ \\ A ( T ( {\overline{x}}_{1} ) ) & … & A ( T ( {\overline{x}}_{b} ) ) \\ ↓ & & ↓\end{matrix} ] \qquad ( 89 )$$

$$𝒩 ( \overline{x} ) = ‖ 𝒯 ( \overline{x} ) ‖ = [ \begin{matrix}‖ {𝒯}_{1} ‖ & … & ‖ {𝒯}_{b} ‖\end{matrix} ] \qquad ( 90 )$$

Hence, the single input ANFIS system in 88 may be transformed for the batch inputs case:

$${\underbrace{y}}_{1 \times b} = ( {\underbrace{P}}_{1 \times n} {\underbrace{Q}}_{n \times r} {\underbrace{𝒯 ( \overline{x} )}}_{r \times b} ) ( {\underbrace{𝒩 ( \overline{x} )}}_{1 \times b} ) \qquad ( 91 )$$

### Offline Training

### Output Weight Optimization Closed Form

The various implementations below derive the offline mean square error optimization of the ANFIS. The loss function may be defined as:

$$\text{?} ( \hat{{y}_{i}} , {y}_{i} ) \qquad = \qquad \frac{1}{2} {( \hat{{y}_{i}} , {y}_{i} )}^{2} \qquad ( 92 )$$

$$\begin{matrix}\hat{R} ( P ) & = & \frac{1}{n} {\sum }_{i = 1}^{n} \text{?} ( \hat{{y}_{i}} , {y}_{i} ) & ( 93 ) \\ & = & \frac{1}{n} {\sum }_{i = 1}^{n} \text{?} ( \frac{1}{{CT}_{i}} PQA ( {T}_{i} ) , {y}_{i} ) & \\ & = & \frac{1}{2 n} {‖ ( ( PQ 𝒯 ) 𝒩 ) - y ‖}_{2}^{2} & ( 94 )\end{matrix}$$

$$\begin{matrix}2 n \hat{R} ( P ) & = & {‖ ( ( PQ 𝒯 ) 𝒩 ) - y ‖}_{2}^{2} & ( 95 ) \\ & = & \text{?} {‖ ( ( PQ 𝒯 ) 𝒩 ) - y ‖}_{2}^{2} & ( 96 )\end{matrix}$$

$$\text{?} \text{indicates text missing or illegible when filed}$$

The normalization factor may be redefined as a broadcasted normalization vector to make the function derivative easier. The broadcast may be column-wise to ensure there are n outputs. This broadcast allows the function model to be rearranged as follows:

$$𝒲 = {\underbrace{[ \begin{matrix}← & 𝒩 & \to \\ & ⋮ & \\ ← & 𝒩 & \to \end{matrix} ]}}_{n \times b} \qquad ( 97 )$$

Together, the gradient of the output gain P and the other variables constant may revolve to:

$$\begin{matrix}0 = {▽}_{P} {‖ ( ( PQ 𝒯 ) 𝒩 ) - y ‖}_{2}^{2} \\ = {▽}_{P} {‖ P ( ( Q 𝒯 ) 𝒲 ) - y ‖}_{2}^{2} \\ = 2 ( P ( ( Q 𝒯 ) 𝒲 ) - y ) {( Q 𝒯 𝒲 )}^{T}\end{matrix} \qquad ( 98 )$$

$${\underbrace{y}}_{1 \times b} {\underbrace{{( Q 𝒯 𝒲 )}^{T}}}_{b \times n} = {\underbrace{P}}_{1 \times n} {\underbrace{( Q 𝒯 𝒲 )}}_{n \times b} {\underbrace{{( Q 𝒯 𝒲 )}^{T}}}_{b \times n} \qquad ( 99 )$$

Consequently, P may be found to be:

$$\begin{matrix}P = y {( Q 𝒯 𝒲 )}^{T} {( ( Q 𝒯 𝒲 ) {( Q 𝒯 𝒲 )}^{T} )}^{+} \\ = {{yA}^{T} ( {AA}^{T} )}^{+} \\ = {{yA}^{T} ( {A}^{T} )}^{+} {A}^{+} = {yA}^{+}\end{matrix} \qquad ( 100 )$$

$${\underbrace{P}}_{1 \times n} = {\underbrace{y}}_{1 \times b} {\underbrace{{( Q 𝒯 𝒲 )}^{+}}}_{b \times n} \qquad ( 101 )$$

and may be represented in a more standard notation of y=Ax:

$${\underbrace{{P}^{T}}}_{n \times 1} = {\underbrace{{( {( Q 𝒯 𝒲 )}^{T} )}^{+}}}_{n \times b} {\underbrace{{y}^{T}}}_{b \times 1} \qquad ( 102 )$$

### Output Weight Symmetrical Constraint

In an example robotic application, the ANFIS system may further employ a parameter reduction for the triangle output weights, namely a symmetric constraint. Most robotic systems assume that the system's dynamics are symmetric, so clockwise and counter-clockwise motion pose the same constraints. As a result, the output triangle membership function weights would be symmetric. In turn, P's gains may also be symmetrical.

$$P = [ \begin{matrix}fast - R & slow - R & zero & slow - L & fast - L\end{matrix} ] = [ \text{} \begin{matrix}- fast - L & slow - L & zero & slow - L & fast - L\end{matrix} ]$$

The example below in FIG. 28 demonstrates the symmetric constraint on the angular velocity of a mobile vehicle. Going right (R) implied a negative angular velocity, while going left implied a positive angular velocity, as demonstrated in FIG. 28.

As such, the output gain matrix P may be reduced using symmetrical constraints to the parameter set Pᵣ and the symmetry constraint operator M:

$$\begin{matrix}P = [ \begin{matrix}zero & slow - L & fast - L\end{matrix} ] [ \begin{matrix}0 & 0 & 1 & 0 & 0 \\ 0 & - 1 & 0 & 1 & 0 \\ - 1 & 0 & 0 & 0 & 1\end{matrix} ] \\ = {\underbrace{{P}_{r}^{}}}_{1 \times q} {\underbrace{P}}_{q \times n}\end{matrix} \qquad ( 103 )$$

The full system with the combination of

$${\underbrace{M}}_{q \times n} {\underbrace{Q}}_{n \times r} = {\underbrace{D}}_{q \times r}$$

may be:

$${\underbrace{y}}_{1 \times b} = ( {\underbrace{{P}_{r}}}_{1 \times q} {\underbrace{D}}_{q \times r} {\underbrace{𝒯 ( \overline{x} )}}_{r \times b} ) ( {\underbrace{𝒩 ( \overline{x} )}}_{1 \times b} ) \qquad ( 104 )$$

Following this interpretation, the optimal Pᵣ using the Least Squares Regression solution may be defined as follows:

$${\underbrace{{P}_{r}}}_{1 \times q} = {\underbrace{y}}_{1 \times b} {\underbrace{{( D 𝒯 𝒲 )}^{+}}}_{b \times q} \qquad ( 105 )$$

### Online Training

### Deep Deterministic Policy Gradient (DDPG)

In some example implementations, reinforcement learning may be used to optimize the parameter set (the positions of the flat and slope regions of the membership functions, as well as the weights) of the ANFIS in a dynamic environment. The main reinforcement learning algorithm used to train the ANFIS actor-network may be based on a Deep Deterministic Policy Gradient (DDPC) model.

The example reinforcement learning setup for discrete action spaces involves an agent acting in discrete time. At each time-step t, the actor receives an observation xₜ of its current state in the environment; the actor then decides what action aₜϵ [symbol] ^{N} to perform in the environment. The consequences are then defined as a scalar reward rₜ.

The actor's behavior is defined by the policy π attributed to it. Given that most environments are stochastic, the policy, π: [symbol] → [symbol] ( [symbol] ), may be modeled as a Markov state model with the state space [symbol] and the action space [symbol] ϵ [symbol] ^{N}.

Given the current state, sₜ, and action, aₜ, a reward is attributed to the transition, r(sₜ,aₜ). In addition, the process transition probabilities, may be defined by the probability of reaching a specific state p(sₜ₊₁|sₜ,aₜ).

Example reinforcement learning algorithms may use a recursive approach to compute a Q-value, which approximates the expected value for an action in a specific state. This approach may be executed using the Bellman equation. For example,

$${Q}^{π} ( {s}_{t} , {a}_{t} ) = {𝔼}_{{r}_{t} , {s}_{t + 1} \sim E} [ r ( {s}_{t} , {a}_{t} ) + γ 𝔼 [ {Q}^{π} ( {s}_{t + 1} , {a}_{t + 1} ) ] ] \qquad ( 106 )$$

$${Q}^{π} ( {s}_{t} , {a}_{t} ) = 𝔼 [ r ( {s}_{t} , {a}_{t} ) + γ 𝔼 [ {Q}^{π} ( {s}_{t + 1} , {a}_{t + 1} ) ] ] \qquad ( 107 )$$

The optimal Q-value may further be simplified using the optimal action a*(s), which can be found as:

$${a}^{*} ( s ) = arg {max}_{a} {Q}^{*} ( s , a ) \qquad ( 108 )$$

When formulated in a greedy optimization manner, the Bellman equation becomes:

$${Q}^{*} ( {s}_{t} , {a}_{t} ) = 𝔼 [ r ( {s}_{t} , {a}_{t} ) + γ {max}_{{a}_{t + 1}} {Q}^{*} ( {s}_{t + 1} , {a}_{t + 1} ) ] \qquad ( 109 )$$

However, given that Q is often impossible to solve, Q(s,a) may be estimated using function approximators, e.g., a neural network, parameterized by θ^{Q} which may be optimized using a mean-squared Bellman error (MSBE) function. The set of transitions, [symbol] , may be defined by (sₜ,aₜ,rₜ,sₜ₊₁,d), where d indicates whether the state is an endpoint in the system, such that dϵ{0,1}. The loss function may thus be defined as:

$$L ( {θ}^{Q} , ) = {{s}_{t} , {a}_{t} , {r}_{t} , {s}_{t + 1} \sim}_{} [ {( Q ( {s}_{t} , {a}_{t} \vert {θ}^{Q} ) - {y}_{t} )}^{2} ] \qquad ( 110 )$$

where

$${y}_{t} = r ( {s}_{t} , {a}_{t} ) + γ ( 1 - d ) Q ( {s}_{t + 1} , μ ( {s}_{t + 1} ) \vert {θ}^{Q} ) \qquad ( 111 )$$

Q-learning may be described on discrete action spaces. This is possible because the a* optimization can be used over a finite action space. However, arg max's equivalent greedy policy in the continuous aϵ [symbol] ⁿ would require an optimization process at each step. Optimizing at each time step may become prohibitively slow for real-time systems. As such, DDPG may make use of an actor-critic structure. For example, DDPG may use a parameterized actor function μ(s|θ^{μ}), which represents the system's policy through the deterministic mapping of the states to their equivalent action. As in Q-learning, the critic, which approximates Q(s, a), may be optimized through the Bellman equation. As such, the actor may be updated using the expected return of its parameters:

$${∇}_{{θ}^{μ}} J \approx [ ∇ Q ( s , a \vert {θ}^{Q} ) {\vert}_{s = {s}_{t} , a = μ ( {s}_{t} )} {∇}_{{θ}^{μ}} μ ( s \vert {θ}^{μ} ) {\vert}_{s = {s}_{t}} ] \qquad ( 112 )$$

Since the timesteps in the environment are sequentially processed and the samples D are independently and identically distributed (IID), replay buffers may be used to solve the IID problem. A replay buffer may include a finite cache [symbol] ⊂ [symbol] . While training the actor and critic, mini-batches comprising the replay buffer may be sampled uniformly from [symbol] , and when the replay buffer is full, the old values may be discarded.

In addition, DDPG may provide a solution against divergent Q(s,a|θ^{Q}) given that the updated network also calculates the target value yₜ, causing the Q update to be prone to divergence. As such, target networks may be introduced to mitigate this problem. The actor and critic target copy networks are annotated as μ′(s|θ^{μ′}) and Q′(s,a|θ^{Q′}), respectively. The target networks then get updated in a time-weighted average fashion to “soft” update the network parameter sets as θₜ₊₁′←τθₜ+(1−τ)θₜ′, where τϵ[0, 1].

DDPG Workflow with ANFIS

The DDPG may be used as the parameter optimizer, where the Q-value approximator may be defined as a deep neural network. However, the parameterized actor function μ(s|θ^{μ}) may be defined as the ANFIS system. As such, the parameter set may be defined as θ^{μ}={P,c,w}. The use of the ANFIS may be comparable to traditional neural network parameterized actors in its universal function approximation ability. However, through the ANFIS, te a drastic parameter reduction and control over the system's characteristics may be achieved.

The control over the system's characteristics stems from the ability to modify the membership functions. As such, ANFIS is advantageous for understanding the input-output relationship compared to large neural networks whose weights can be difficult to effectually alter without prior knowledge of the consequences. In other words, traditional large neural networks appear as black boxes whereas an ANFIS is explainable and modifiable. In addition, the rule set of the fussy logic in the ANFIS is defined in an intuitive and constrained manner, which provides an easier understanding of each rule set's impact and its contributions to the outputs. This makes it easier to manipulate and troubleshoot the system by using, for example, a masking operation to understand the output of each rule set. The ANFIS using Fuzzy Logic, as a neural network, can be used as a universal approximation. Thus, a minimum ANFIS definition can be derived such that one can approximate the state-to-action policy space.

### Online Training Results

### Environment

An example ANFIS is evaluated in simulation as a motion controller to an example skid-steer motion model Unmanned Ground Vehicle (UGV). Table 13 defines the system's inputs. The linear velocity is set to a constant value of

$$1. \frac{m}{s} .$$

TABLE 13
CLEARPATH JACKAL ACTION SPACE

| Action | Symbol | Min | Max |
|---|---|---|---|
| Angular Velocity | ω | −4.0 | 4.0 |

An example Clearpath Jackal represents a ground vehicle meant to follow a set of waypoints linearly. The example ANFIS is configured to act based on the current state of the robot along its path. The state of the robot may be defined through five error functions.

The waypoints are defined as specific world physical locations. The path p represented the sequential set of waypoints. To follow the robot's progress, particular waypoints may include: xₚ representing the waypoint the robot recently passed, x_{c} represents the waypoint the robot is heading towards, and x_{f} represents the next/future waypoint that the robot would reach. Finally, x describes the robot's world location.

The five example error states of the robot may be represented as:
1. Distance Target: the distance to reach the next waypoint

$${d}_{t} = {‖ {x}_{c} - x ‖}_{2} ϵ [ 0 , ∝ ) \qquad ( 113 )$$

2. Distance Line: the projected remaining distance of x on the waypoint trajectory

$${x}_{p} \to {x}_{c}$$

$$a = {x}_{c} = {x}_{p} \qquad ( 114 )$$

$$b = x - {x}_{p} \qquad ( 115 )$$

$${d}_{t} = {‖ b - ( \frac{a \cdot b}{a \cdot a} ) a ‖}_{2} ϵ ( - ∞ , ∞ ) \qquad ( 116 )$$

3. Theta Lookahead: the angle difference between the next path segment's heading and the current heading

$${θ}_{r} = arctan 2 ( {x}_{y} , {x}_{x} ) \qquad ( 117 )$$

$${θ}_{f} = arctan 2 ( {x}_{f , y} - {x}_{c , y} , {x}_{f , x} - {x}_{c , x} ) \qquad ( 118 )$$

$${θ}_{ie} = {θ}_{f} - {θ}_{r} ϵ ( - π , π ) \qquad ( 119 )$$

4. Theta Near: the angle difference between the heading of the current path segment and the agent's current heading

$${θ}_{n} = arctan 2 ( {x}_{f , y} - {x}_{c , y} , {x}_{f , x} - {x}_{c , x} ) \qquad ( 120 )$$

$$\begin{matrix}{θ}_{ne} = {θ}_{n} - {θ}_{r} ϵ ( - π , π ) & ( 121 )\end{matrix}$$

5. Theta Far: the angle difference between the projected recovery point and the agent's heading, with kϵ[0, 1]

$${f}_{proj} = \frac{a \cdot b}{a \cdot a} a + {x}_{p} \qquad ( 122 )$$

$${x}_{ft} = {kx}_{proj} + ( 1 - k ) {x}_{c} \qquad ( 123 )$$

$${θ}_{ft} = arctan 2 ( {x}_{ft , y} - {x}_{y} , {x}_{ft , x} - {x}_{x} ) \qquad ( 124 )$$

$${θ}_{fe} = {θ}_{ft} - {θ}_{r} ϵ ( - π , π ) \qquad ( 125 )$$

The reward for the system may be defined as:

$${dist}_{r} = \frac{1}{\vert {d}_{t} \vert + a} - \frac{1}{a} ϵ ( - \frac{1}{a} , 0 ] \qquad ( 126 )$$

$$θ = \frac{1}{\vert {θ}_{ne} \vert + b} - \frac{1}{b} ϵ ( - \frac{1}{b} , 0 ] \qquad ( 127 )$$

$$r = {dist}_{r} + {θ}_{ne , r} \qquad ( 128 )$$

### Model Parameters

The rule-base of the underlying fuzzy logic may be defined in the mapping function A with the rule-to-output relationship defined in matrix Q. To save space, “left” and “right” are reduced to “l” and “r,” respectively. The ordered input membership values may be represented in vector T:

$${T}_{{d}_{t}} = [ \begin{matrix}near & far\end{matrix} ] \qquad ( 129 )$$

$${T}_{{d}_{i}} = [ \begin{matrix}{far}_{l} & \begin{matrix}{near}_{l} & {close}_{l} & zero & {close}_{r} & {near}_{r} & {far}_{r}\end{matrix}\end{matrix} ]$$

$${T}_{{θ}_{ie}} = [ \begin{matrix}{far}_{l} & \begin{matrix}{close}_{l} & zero & {close}_{r} & {far}_{r}\end{matrix}\end{matrix} ]$$

$${T}_{{θ}_{fe}} = [ \begin{matrix}{far}_{l} & \begin{matrix}{close}_{l} & zero & {close}_{r} & {far}_{r}\end{matrix}\end{matrix} ]$$

$${T}_{{θ}_{ne}} = [ \begin{matrix}{far}_{l} & \begin{matrix}{near}_{l} & zero & {near}_{r} & {far}_{r}\end{matrix}\end{matrix} ]$$

$$T = {[ {T}_{{d}_{t}} \vert {T}_{{d}_{i}} \vert {T}_{{θ}_{le}} \vert {T}_{{θ}_{fe}} \vert {T}_{{θ}_{ne}} ]}^{T}$$

The output matrix weight P may be represented by:

$${Pr}_{{\dot{θ}}_{R}} = [ \begin{matrix}zero & \begin{matrix}{left}_{1} & {left}_{2} & {left}_{3} & {left}_{4}\end{matrix}\end{matrix} ] \qquad ( 130 )$$

with the additional output symmetry matrix M being:

$$M = [ \begin{matrix}0 & 0 & 0 & 0 & 1 & 0 & 0 & 0 & 0 \\ 0 & 0 & 0 & - 1 & 0 & 1 & 0 & 0 & 0 \\ 0 & 0 & - 1 & 0 & 0 & 0 & 1 & 0 & 0 \\ 0 & - 1 & 0 & 0 & 0 & 0 & 0 & 1 & 0 \\ - 1 & 0 & 0 & 0 & 0 & 0 & 0 & 0 & 1\end{matrix} ] \qquad ( 131 )$$

The input rule base mapping function A(·) may be:

$$A = [ \begin{matrix}{d}_{t , Near} & * & {θ}_{le , Far - left} & & \\ {d}_{t , Near} & * & {θ}_{le , Near - left} & & \\ {d}_{t , Near} & * & {θ}_{le , Zero} & & \\ {d}_{t , Near} & * & {θ}_{le , Near - right} & & \\ {d}_{t , Near} & * & {θ}_{le , Far - right} & & \\ {d}_{t , Far} & * & {d}_{l , Far - left} & * & {θ}_{ne , Far - left} \\ {d}_{t , Far} & * & {d}_{l , Far - left} & * & {θ}_{ne , Near - left} \\ {d}_{t , Far} & * & {d}_{l , Far - left} & * & {θ}_{ne , Zero} \\ {d}_{t , Far} & * & {d}_{l , Far - left} & * & {θ}_{ne , Near - right} \\ {d}_{t , Far} & * & {d}_{l , Far - left} & * & {θ}_{ne , Far - right} \\ {d}_{t , Far} & * & {d}_{l , Far - right} & * & {θ}_{ne , Far - left} \\ {d}_{t , Far} & * & {d}_{l , Far - right} & * & {θ}_{ne , Near - left} \\ {d}_{t , Far} & * & {d}_{l , Far - right} & * & {θ}_{ne , Zero} \\ {d}_{t , Far} & * & {d}_{l , Far - right} & * & {θ}_{ne , Near - right} \\ {d}_{t , Far} & * & {d}_{l , Far - right} & * & {θ}_{ne , Far - right} \\ {d}_{t , Far} & * & {d}_{l , Near - left} & * & {θ}_{fe , Far - left} \\ {d}_{t , Far} & * & {d}_{l , Near - left} & * & {θ}_{fe , Near - left} \\ {d}_{t , Far} & * & {d}_{l , Near - left} & * & {θ}_{fe , Zero} \\ {d}_{t , Far} & * & {d}_{l , Near - left} & * & {θ}_{fe , Near - right} \\ {d}_{t , Far} & * & {d}_{l , Near - left} & * & {θ}_{fe , Far - right} \\ {d}_{t , Far} & * & {d}_{l , Close - left} & * & {θ}_{fe , Far - left} \\ {d}_{t , Far} & * & {d}_{l , Close - left} & * & {θ}_{fe , Near - left} \\ {d}_{t , Far} & * & {d}_{l , Close - left} & * & {θ}_{fe , Zero} \\ {d}_{t , Far} & * & {d}_{l , Close - left} & * & {θ}_{fe , Near - right} \\ {d}_{t , Far} & * & {d}_{l , Close - left} & * & {θ}_{fe , Far - right} \\ {d}_{t , Far} & * & {d}_{l , Zero} & * & {θ}_{fe , Far - left} \\ {d}_{t , Far} & * & {d}_{l , Zero} & * & {θ}_{fe , Near - left} \\ {d}_{t , Far} & * & {d}_{l , Zero} & * & {θ}_{fe , Zero} \\ {d}_{t , Far} & * & {d}_{l , Zero} & * & {θ}_{fe , Near - right} \\ {d}_{t , Far} & * & {d}_{l , Zero} & * & {θ}_{fe , Far - right} \\ {d}_{t , Far} & * & {d}_{l , Close - right} & * & {θ}_{fe , Far - left} \\ {d}_{t , Far} & * & {d}_{l , Close - right} & * & {θ}_{fe , Near - left} \\ {d}_{t , Far} & * & {d}_{l , Close - right} & * & {θ}_{fe , Zero} \\ {d}_{t , Far} & * & {d}_{l , Close - right} & * & {θ}_{fe , Near - right} \\ {d}_{t , Far} & * & {d}_{l , Close - right} & * & {θ}_{fe , Far - right} \\ {d}_{t , Far} & * & {d}_{l , Near - right} & * & {θ}_{fe , Far - left} \\ {d}_{t , Far} & * & {d}_{l , Near - right} & * & {θ}_{fe , Near - left} \\ {d}_{t , Far} & * & {d}_{l , Near - right} & * & {θ}_{fe , Zero} \\ {d}_{t , Far} & * & {d}_{l , Near - right} & * & {θ}_{fe , Near - right} \\ {d}_{t , Far} & * & {d}_{l , Near - right} & * & {θ}_{fe , Far - right}\end{matrix} ] \qquad ( 132 )$$

The output query matrix Q may be:

$${Q}^{T} = [ \begin{matrix}1 & 0 & 0 & 0 & 0 & 0 & 0 & 0 & 0 \\ 0 & 0 & 1 & 0 & 0 & 0 & 0 & 0 & 0 \\ 0 & 0 & 0 & 0 & 1 & 0 & 0 & 0 & 0 \\ 0 & 0 & 0 & 0 & 0 & 0 & 1 & 0 & 0 \\ 0 & 0 & 0 & 0 & 0 & 0 & 0 & 0 & 1 \\ 1 & 0 & 0 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & 0 & 0 & 0 & 0 & 1 \\ 1 & 0 & 0 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & 0 & 0 & 0 & 0 & 1 \\ 1 & 0 & 0 & 0 & 0 & 0 & 0 & 0 & 0 \\ 0 & 1 & 0 & 0 & 0 & 0 & 0 & 0 & 0 \\ 0 & 0 & 1 & 0 & 0 & 0 & 0 & 0 & 0 \\ 0 & 0 & 0 & 1 & 0 & 0 & 0 & 0 & 0 \\ 0 & 0 & 0 & 0 & 0 & 0 & 1 & 0 & 0 \\ 1 & 0 & 0 & 0 & 0 & 0 & 0 & 0 & 0 \\ 0 & 0 & 1 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 0 & 0 & 1 & 0 \\ 0 & 1 & 0 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & 0 & 0 & 0 & 1 & 0 \\ 0 & 1 & 0 & 0 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & 0 & 0 & 1 & 0 & 0 \\ 0 & 0 & 0 & 0 & 0 & 0 & 0 & 0 & 1 \\ 0 & 0 & 1 & 0 & 0 & 0 & 0 & 0 & 0 \\ 0 & 0 & 0 & 0 & 0 & 1 & 0 & 0 & 0 \\ 0 & 0 & 0 & 0 & 0 & 0 & 1 & 0 & 0 \\ 0 & 0 & 0 & 0 & 0 & 0 & 0 & 1 & 0 \\ 0 & 0 & 0 & 0 & 0 & 0 & 0 & 0 & 1\end{matrix} ] \qquad ( 133 )$$

The ANFIS system may then be trained using DDPG with an Adam optimizer for the critic and actor parameters with learning rates of 0.001 and 0.0001, respectively. The critic is represented as a deep neural network and the actor is the ANFIS. The symmetry axis c may be uniformly set to 0 for all joint membership functions. Each linguistic value's respective parameters and membership type may be initially assigned to values displayed in Table 14. Three membership types may be utilized: Unrestricted (U), Single-Sided (S), and Bounded (B), each represent-ing membership functions with domains (−∞, ∞), [c, ∞), and [a, b], respectively, as described above.

The performance of the example system is evaluated by analyzing the training process results. The cumulative reward function of the system reaches an equilibrium point within a few episodes, typically between 6 to 10 episodes, as depicted in FIG. 29. Consistent improvements may be documented in the graphs of Mean Absolute

TABLE 14
INITIAL JOINT MEMBERSHIP STATE

| Variable | Type | Weights |
|---|---|---|
| dₗ | S [0, ∞) | 0, 0.701, 0, 0.701, 0, 0.701 |
| dₜ | U (−∞, ∞) | 0,1 |
| θₗₑ | B [−π, π] | 0, 0.701, 0, 0.701, 1.463 |
| θ_{fe} | B [−π, π] | 0, 0.701, 0, 0.701, 1.463 |
| θₙₑ | B [−π, π] | 0,0.701, 0, 0.701, 1.463 |
| P | | 0, 0.25, 0.5, 0.75, 1 |

Error (MAE) and Root Mean Squared Error (RMSE) throughout the episodes. The MSE and the RMSE are calculated relative to the Distance Line dₗ input parameter, which indicated the robot's proximity to the trajectory. The results obtained from the experiments are presented in FIG. 30. The initial system parameters enabled the robot to achieve an MAE and RMSE of 0.88 m and 1.02 m, respectively. However, after the training process, the system achieves significantly improved results, with an MAE and RMSE of 0.087 m and 0.10 m, respectively. This represented a ten-fold improvement in the system's trajectory following capability, as demonstrated by the trained ANFIS.

The accuracy of the example ANFIS model after tuning may be assessed by examining how well it followed the trajectory. As shown in FIG. 30, the new ANFIS model is observed to accurately track the course, without any delays or inaccuracies, even during the initial curved section. Overall, the results indicate that the proposed system effectively enabled the robot to track the trajectory accurately. Table 0.15 displays the final parameter set values.

The various example ANFIS implementations/models above may be used as a controller in applications with symmetrically constrained problems. These example ANFIS model required fewer parameters and less computation than typical neural network approaches via HRBR and symmetry considerations, leading to faster parameter

TABLE 15
FINAL JOINT MEMBERSHIP STATE

| Variable | Weights |
|---|---|
| dₗ | 0,0.2089, 0, 0.1965, 0, 0.1989 |
| dₜ | 0.0826, 0.9491 |
| θₗₑ | 0, 0.6388, 0, 0.6661, 1.522 |
| θ_{fe} | 0, 0.4631, 0, 0.4676, 1.709 |
| θₙₑ | 0.0194, 0.3396, −0.0311, 0.5272, 1.832 |
| P | 0, 0.05334, 0.709, 1.036, 1.655 |

convergence and more stable system characteristics. These ANFIS models includes human-interpretable and malleable parameters that are trained and at the same time directly human-modifiable, a desirable feature as, for example, motion controllers. The example ANFIS's rule-set and non-linear membership functions correspond to various neural network layers and thus effectively mitigate the black box approach of traditional neural network-based controllers through the explainability of its membership functions and rule set embedded in the network layers.

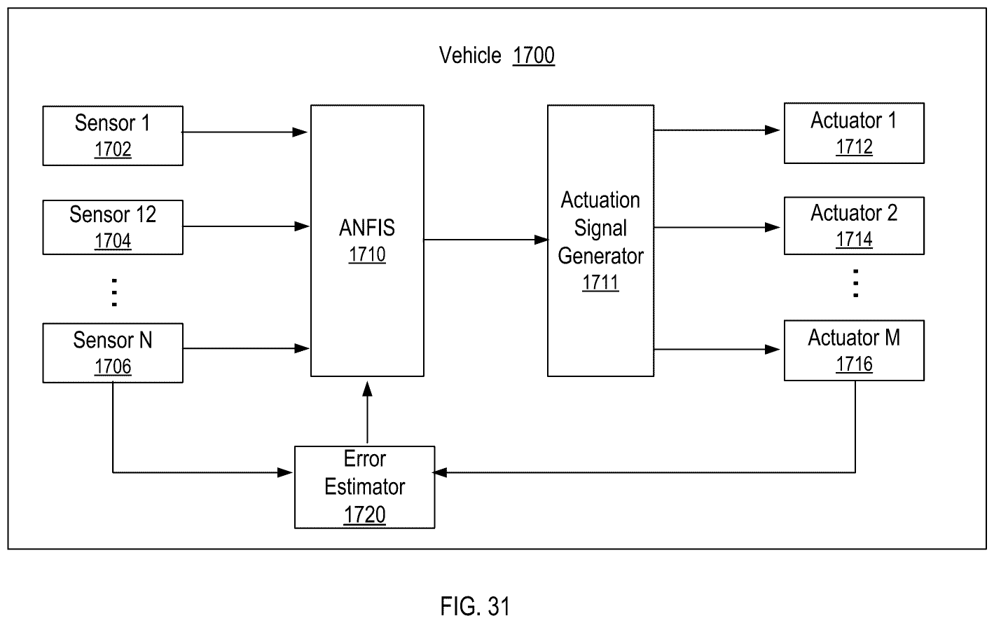

FIG. 31 shows an example use of an ANFIS 3110 for controlling a vehicle or machine 3100. The vehicle 3100 of FIG. 31 may include one or more sensors 3102, 3104, and 3106 for generating a set of input signals to the ANFIS 3110. The ANFIS may be configured to generate a set of output signals that may be further processed by an actuator signal generator 3111 to generate actuation signals that are applied to actuators 3112, 3114 and 3116 for controlling the operation of the vehicle. Example of sensors 3102, 3104, and 3106 may include cameras, lidars, thermometers, weight scales, and the like. The actuators 3110, 3114, and 3116 may include brakes, steering column, accelerators, and the like. The actuator output would change the state of the vehicle as controlled by the ANFIS 3110. Such state may be partially or fully captured by the sensors 3102, 3104, and 3106. During reinforcement training process of the ANFIS 3110, the error signal may be generated to represent the delta difference between the measured vehicle states based on the sensor measurements and the expected vehicle state predicted by an estimator 3120. The error signal may be feed back to the ANFIS for back-propagation for the adjustment of its parameters, such as membership function parameters described above.

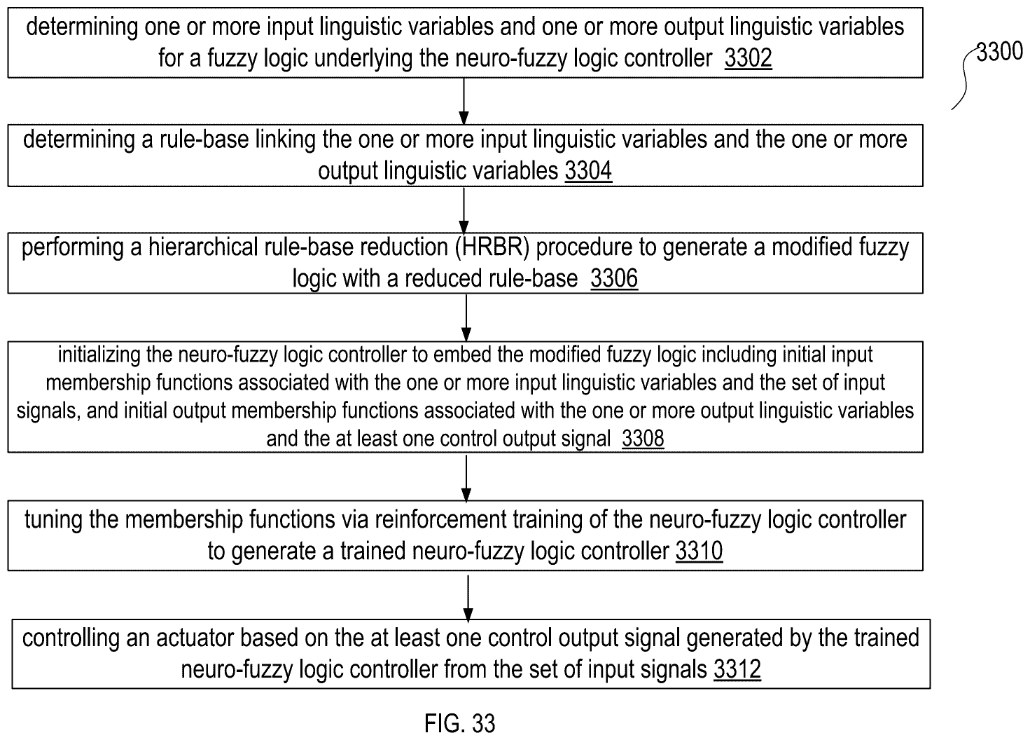

Finally, FIG. 33 illustrates an example data and logic flow 3300 for establishing and reinforcement training of neuro-fuzzy logic controller, the neuro-fuzzy logic controller being configured to generate at least one control output signal from a set of input signals. In Step 3302, one or more input linguistic values and one or more output linguistic values is determined for a fuzzy logic underlying the neuro-fuzzy logic controller. In step 3304, a rule-base linking the one or more input linguistic values and the one or more output linguistic values is determined. In Step 3306, a hierarchical rule-base reduction (HRBR) procedure is performed to generate a modified fuzzy logic with a reduced rule-base. In Step 3308 the neuro-fuzzy logic controller is initialized to embed the modified fuzzy logic including initial input membership functions associated with the one or more input linguistic values and the set of input signals, and initial output membership functions associated with the one or more output linguistic values and the at least one control output signal. In Step 3310, the membership functions are tuned via reinforcement training of the neuro-fuzzy logic controller to generate a trained neuro-fuzzy logic controller. In Step 3312, an actuator is controlled based on the at least one control output signal generated by the trained neuro-fuzzy logic controller from the set of input signals.

In the disclosure above, a method for generating a neuro-fuzzy logic controller is disclosed, the neuro-fuzzy logic controller being configured to generate at least one control output signal from a set of input signals, the method comprising: determining one or more input linguistic values and one or more output linguistic values for a fuzzy logic underlying the neuro-fuzzy logic controller; determining a rule-base linking the one or more input linguistic values and the one or more output linguistic values; performing a hierarchical rule-base reduction (HRBR) procedure to generate a modified fuzzy logic with a reduced rule-base; initializing the neuro-fuzzy logic controller to embed the modified fuzzy logic including initial input membership functions associated with the one or more input linguistic values and the set of input signals, and initial output membership functions associated with the one or more output linguistic values and the at least one control output signal; tuning the membership functions via reinforcement training of the neuro-fuzzy logic controller to generate a trained neuro-fuzzy logic controller; and controlling an actuator based on the at least one control output signal generated by the trained neuro-fuzzy logic controller front the set of input signals.

In any one of the method above, the input membership functions may comprise trapezoid relations between numerical values of the one or more input linguistic values and the set of input signals.

In any one of the method above, the output membership functions comprise triangular relations between numerical values of the one or more output linguistic values and the at least one control output signal.

In any one of the method above, the input membership functions comprise a combination of double sided and single sided trapezoids.

In any one of the method above, the input membership functions are symmetric with respect to an input domain associated with each of the set of input signals.

In any one of the method above, a shape of each double sided trapezoid of the input membership functions and the output membership functions is represented by four parameters in a corresponding domain.

In any one of the method above, a shape of each single sided trapezoid of the input membership functions and the output membership functions is represented by two parameters in the corresponding domain.

In any one of the method above, neighboring trapezoids of the input membership functions of a domain are constrained to have two joint parameters representing a slope region of the domain for the neighboring trapezoids.

In any one of the method above, the hierarchically reduced rule-base comprises a set of if-then rules linking the one or more input linguistic values to the one or more output linguistic values that cover fewer than all possible if-then linking combinations of the one or more input linguistic values and the one or more output linguistic values.

In any one of the method above, the hierarchically reduced rule-base comprises rule branches and sub-branches based on hierarchically prioritizing within a set of control metrics according to the one or more input linguistic values.

In any one of the method above, the neuro-fuzzy logic controller comprises five neurological layers.

In any one of the method above, the five neurological layers comprises a premise layer, a weighting layer, a normalization layer, a consequence layer, and an output layer.

In any one of the method above, parameters of the input membership functions are tuned in the premise layer.

In any one of the method above, the reinforcement training of the neuro-fuzzy logic controller is based on using the neural-fuzzy logic controller as an actor.

In any one of the method above, the reinforcement training of the neuro-fuzzy logic controller is based on back-propagation of errors representing expected senor signal and actual sensor signal as a result of the actuator being actuated by the neuro-fuzzy logic controller.

In any one of the method above, the reinforcement training is based on a Deep Deterministic Policy Gradient (DDPG) model.

In any one of the method above, the euro-fuzzy logic controller is installed in a skid-steer vehicle for navigational control of the skid-steer vehicle.

In the disclosure above, a control circuitry is disclosed. The control circuitry comprises the neuro-fuzzy logic controller of any one of the methods above and configured to perform any one of the methods above.

### Hardware, Software, and Firmware Platforms

It is to be understood that the various implementations above are not limited in its application to the details of construction and the arrangement of components set forth above and in the accompanying drawings. The disclosure is intended to cover other embodiments that may be practiced or carried out in various ways following the underlying principles disclosed herein.

It should also be noted that a plurality of hardware and software based devices, as well as a plurality of different structural components may be used to implement the various embodiments of the disclosure. In addition, it should be understood that embodiments of this disclosure may include hardware, software, and electronic components or modules that, for purposes of discussion ay be illustrated and described as if the majority of the components are implemented solely in hardware. However, one of ordinary skill in the art, and based on a reading of this disclosure, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. These controllers may be implemented as dedicated processing circuitry or in general-purpose processors, in combination of various software and/or firmware, and in combination of other wired or wireless communication interfaces.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead allow for the existence of additional factors not necessarily expressly described, again, depending at least in part on context.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed:

1. A method for automatically controlling a vehicle, comprising:
determining current states of a plurality of control metrics relative to a planned path based on measurements from sensors installed on the vehicle;
generating at least two control commands using a fuzzy logic controller with a hierarchically reduced rule-base; and
converting the at least two control commands into one or more control signals for actuating one or more path-control actuators of the vehicle.

2. The method of claim 1, wherein each of the plurality of control metrics is associated with a plurality of input member linguistic variables relating to the corresponding control metrics by input fuzzy membership functions.

3. The method of claim 2, wherein generating the at least two control commands using the fuzzy logic controller comprises:
automatically converting the current state of each of the plurality of control metrics into input linguistic values of the plurality of input member linguistic variables based on the input fuzzy membership functions;
automatically mapping the input member linguistic variables to linguistic control variables associated with at least two path-control actions of the vehicle based on the hierarchically reduced rule-base in the fuzzy logic controller;
generating output linguistic values of the linguistic control variables for each of the at least two path-control actions based on the mapping and output fuzzy membership functions associated with the linguistic control variables; and
defuzzificating the output linguistic values corresponding to the at least two path-control actions to generate the at least two control commands.

4. The method of claim 3, wherein each of the input fuzzy membership functions specifies a trapezoidal relationship between a corresponding input member linguistic variable and corresponding control metrics.

5. The method of claim 4, wherein the hierarchically reduced rule-base of the fuzzy logic controller is left-right symmetric.

6. The method of claim 3, wherein the hierarchically reduced rule-base comprises a set of if-then rules linking the plurality of input member linguistic variables to the linguistic control variables covering fewer than all possible combinations of the input member linguistic variables and the linguistic control variables.

7. The method of claim 6, wherein:
the planned path comprises at least a current path segment and a next path segment joint by a target point; and
the plurality of control metrics comprise a waypoint line distance from the vehicle to a waypoint between the target point and a projection point of the vehicle on the current path segment.

8. The method of claim 7, wherein the plurality of control metrics further comprises:
a target distance from the vehicle to the target point;
a waypoint heading angle between a current heading direction of the vehicle relative to a line from the vehicle to the waypoint;
a current path-alignment angle between the current heading direction of the vehicle and the current path segment; and
a lookahead path-alignment angle between the current heading direction of the vehicle and the next path segment.

9. The method of claim 8, wherein the hierarchically reduced rule-base comprises rule branches and sub-branches based on hierarchically prioritizing within the control metrics according to the input member linguistic variables.

10. The method of claim 9, wherein:
the control metrics of the target distance comprises a first input linguistic variable representing whether the vehicle is near the target point and a second input linguistic variable representing whether the vehicle is far from the target point; and
top branches of the hierarchically reduced rule-base comprises a first sub-rule-set and a second sub-rule-set corresponding to the first and second input linguistic variables of the target distance, respectively.

11. The method of claim 10, wherein the first sub-rule-set is reduced from addressing all possible combinations of the input member linguistic variables of the waypoint line distance, the waypoint heading angle, the current path-alignment angle, and the lookahead path-alignment angle by ignoring at least one of the waypoint line distance, the waypoint heading angle, and the current path-alignment angle.

12. The method of claim 11, wherein the second sub-rule-set is configured to ignore at least the lookahead path-alignment angle.

13. The method of claim 12, wherein at least one of sub-branches of the second sub-rule-set further ignores the waypoint heading angle.

14. The method of claim 13, wherein at least one other of the sub-branches of the second sub-rule-set further ignores the current path-alignment angle.

15. The method of claim 7, wherein the waypoint is determined by achieving a quickest approach to the planned path assuming a constant speed.

16. The method of claim 3, wherein the at least two path-control actions comprise an angular steering control and a linear speed control, and wherein the linguistic control variables corresponding to the angular steering control represent a plurality of angular steering levels and the linguistic control variables corresponding to the linear speed control represent a plurality of linear speed levels.

17. The method of claim 3, wherein defuzzificating the output linguistic values is based on a center-of-mass methodology.

18. The method of claim 3, wherein each of the output fuzzy membership functions associated with the linguistic control variables is a triangular function.

19. The method of claim 1, wherein the vehicle comprises a skid-steer vehicle.

20. A control circuitry comprising the fuzzy logic controller of claim 1, configured to perform the method of claim 1.
